(19) United States
(12) Patent Application Publication
(10) Pub. No.: US 2014/0137844 A1
(43) Pub. Date: May 22, 2014

(54) EXHAUST GAS RECIRCULATION APPARATUS FOR AN ENGINE

(71) Applicant: AISAN KOGYO KABUSHIKI KAISHA, Obu-shi (JP)

(72) Inventors: Mamoru YOSHIOKA, Nagoya-shi (JP); Minoru AKITA, Ama-shi (JP); Kazufumi ISHII, Kariya-shi (JP); Takehide NAKAMURA, Handa-shi (JP)

(73) Assignee: AISAN KOGYO KABUSHIKI KAISHA, Obu-shi (JP)

(21) Appl. No.: 14/074,254

(22) Filed: Nov. 7, 2013

(30) Foreign Application Priority Data
Nov. 21, 2012 (JP) 2012-255282
May 21, 2013 (JP) 2013-107003

(51) Int. Cl. F02M 25/07

(52) U.S. Cl. CPC F02M 25/0704
USPC 123/568.19

(57) ABSTRACT

An EGR apparatus for an engine includes an EGR passage, an EGR valve, an accelerator sensor, and an ECU. The ECU compares a change amount (accelerator operating speed) per unit of time of an accelerator opening degree to a predetermined first determination value. When it is determined that a request for deceleration operation or acceleration operation is made to an engine, the ECU issues a fully closing command to the EGR valve. When it is determined that the deceleration or acceleration operation request is continued, the ECU continues to issue the fully closing command. When the deceleration or acceleration operation request is removed and the accelerator opening degree is larger or smaller than a predetermined second determination value, the ECU releases the fully closing command.

### CROSS-REFERENCE TO RELATED APPLICATIONS

This application is based upon and claims the benefit of priority from the prior Japanese Patent Application No. 2012-255282 filed on Nov. 21, 2012, and No. 2013-107003 filed on May 21, 2013, the entire contents of which are incorporated herein by reference.

### BACKGROUND OF THE INVENTION

1. Field of the Invention

The present invention relates to an exhaust gas recirculation (EGR) apparatus for an engine to allow part of exhaust gas discharged from an engine to an exhaust passage to flow in an intake passage to recirculate back to the engine.

2. Related Art

Conventionally, a technique of the above type is employed in a vehicle engine, for example. An exhaust gas recirculation (EGR) apparatus is arranged to introduce part of exhaust gas after combustion, which is discharged from a combustion chamber of an engine to an exhaust passage, into an intake passage through an EGR passage so that the exhaust gas is mixed with intake air flowing in the intake passage and flows back to the combustion chamber. EGR gas flowing in the EGR passage is regulated by an EGR valve provided in the EGR passage. This EGR can reduce mainly nitrogen oxide (NOx) in the exhaust gas and improve fuel consumption during a partial load operation of the engine.

Exhaust gas from the engine contains no oxygen or is in an oxygen lean state. Thus, when part of the exhaust gas is mixed with the intake air by EGR, the oxygen concentration of the intake air decreases. In a combustion chamber, therefore, fuel burns in a low oxygen concentration. Thus, a peak temperature during combustion decreases, thereby restraining the occurrence of NOx. In a gasoline engine, even when the content of oxygen in intake air is not increased by EGR and a throttle valve is closed to some degree, it is possible to reduce pumping loss of the engine.

Recently, it is conceivable to perform EGR in the entire operating region of the engine in order to further improve fuel consumption. Realization of high EGR is thus demanded. To realize the high EGR, it is necessary for conventional arts to increase the internal diameter of an EGR passage or increase the opening area of a flow passage provided by a valve element and a valve seat of an EGR valve.

Meanwhile, JP 2011-111951A discloses one example of an EGR apparatus for an engine. This EGR apparatus is directed to stabilize an operating state of an engine. In this apparatus, while the engine is running with an EGR valve opened, when a power change amount requested to the engine becomes lower than a predetermined negative threshold, an EGR valve is closed and held in this closed state until a predetermined release condition is established. This can promptly close the EGR valve and also hold the EGR valve in the closed state, thereby achieving a stable operating condition of the engine.

### SUMMARY OF INVENTION

### Problems to be Solved by the Invention

Meanwhile, the EGR apparatus disclosed in JP 2011-111951A may be adapted for high EGR. For this purpose, it is conceivable to widen the passage diameter of the EGR passage or increase the size of a valve element and a valve seat of the EGR valve. In the EGR apparatus disclosed in JP 2011-111951A, however, it is necessary to more early start full closing of the EGR valve in order to cut EGR in order to restrain misfire due to EGR gas during deceleration operation of the engine. If the EGR apparatus is adapted for high EGR, such a demand is further increased. When a requested power change amount of the engine is simply compared to the negative threshold, during engine deceleration operation, the EGR valve is caused to more rapidly start fully closing and thus the EGR valve could not be appropriately controlled according to changes in subsequent operation request. For instance, after a fully closing command is issued to the EGR valve so as to be controlled to fully close once, it is sometimes necessary to release the command or return the EGR valve to valve opening control. Thus, the EGR valve could not respond rapidly to changes in operation request by a driver.

In the EGR apparatus disclosed in JP 2011-111951A, it is necessary to start the full closing operation of the EGR valve more early even during acceleration operation in order to prevent deterioration in acceleration property due to EGR gas flowing in a combustion chamber. Herein, similarly, when the request power change amount of the engine is merely compared to the positive threshold, the EGR valve could not be appropriately controlled according to changes in subsequent operation request to prompt early starting of full closing of the EGR valve during acceleration operation of the engine.

The present invention has been made in view of the circumstances and has a purpose to provide an exhaust gas recirculation apparatus capable of rapidly fully close an exhaust gas recirculation (EGR) valve in response to a request for deceleration operation or acceleration operation of an engine to avoid misfire during deceleration of the engine or prevent deterioration in accelerating property of the engine, and capable of promptly interrupting a fully closing operation of the EGR valve when the request for deceleration operation or acceleration operation is returned to a request for another operation. Another object of the invention is to provide an exhaust gas recirculation apparatus capable of rapidly fully close an EGR valve in response to a request for deceleration operation of an engine to avoid misfire during deceleration of the engine and also capable of promptly interrupting a full closing operation of the EGR valve when the request for deceleration operation is returned to a request for another operation. Still another object of the invention is to provide an exhaust gas recirculation apparatus capable of rapidly fully close an EGR valve in response to a request for acceleration operation of an engine to prevent deterioration in acceleration property of the engine and also capable of promptly interrupting a fully closing operation of the EGR valve when the request for acceleration operation is returned to a request for another operation.

### Means of Solving the Problems

To achieve the above purpose, one aspect of the invention provides an exhaust gas recirculation apparatus for an engine, the apparatus including: an exhaust gas recirculation (EGR) passage to allow part of exhaust gas discharged from a combustion chamber of an engine to an exhaust passage to flow as exhaust recirculation gas in an intake passage to recirculate back to the combustion chamber; an exhaust gas recirculation valve to regulate a flow of the exhaust recirculation gas in the EGR passage; an operating condition detecting unit to detect an operating condition of the engine; a control unit to control the EGR valve based on the operating condition detected by the operating condition detecting unit, wherein the operating condition detecting unit includes an output request amount detecting unit to detect an amount of an output request of the engine made by a driver, and the control unit issues a fully closing command to the EGR valve based on a change amount per unit of time of the detected output request amount and releases the fully closing command to the EGR valve based on the change amount per unit of time of the detected output request amount and the output request amount.

### Effects of the Invention

According to the invention, it is possible to rapidly fully close an EGR valve in response to a request for deceleration operation or acceleration operation of an engine to avoid misfire during deceleration of the engine or prevent deterioration in acceleration property of the engine, and also capable of rapidly interrupting a fully closing operation of the EGR valve when the request for deceleration operation or acceleration operation is returned to a request for another operation.

### BRIEF DESCRIPTION OF THE DRAWINGS

FIG. 1 is a schematic configuration view showing an engine system including an exhaust gas recirculation (EGR) apparatus for engine in a first embodiment;

FIG. 2 is an enlarged cross sectional view of a part of an EGR passage in which an EGR valve is provided in the first embodiment;

FIG. 3 is a flowchart showing one example of processing details of EGR control in the first embodiment;

FIG. 4 is a time chart showing one example of behaviors of various parameters related to EGR control in the first embodiment, including (a) accelerator opening and throttle opening, (b) accelerator operating speed, (c) EGR valve opening degree, (d) engine rotation speed and engine load, (e) EGR cut flag, and (f) EGR rate;

FIG. 5 is a time chart showing another example of behaviors of various parameters related to EGR control in the first embodiment, including (a) accelerator opening and throttle opening, (b) accelerator operating speed, (c) EGR valve opening degree, (d) engine rotation speed and engine load, (e) EGR cut flag, and (f) EGR rate;

FIG. 6 is a flowchart showing one example of processing details of EGR control in a second embodiment;

FIG. 7 is a graph showing one example of a deceleration determination value map in the second embodiment;

FIG. 8 is a graph showing one example of an acceleration determination value map in the second embodiment;

FIG. 9 is a flowchart showing one example of processing details of EGR control in a third embodiment;

FIG. 10 is a graph showing one example of a valve closing speed map in the third embodiment;

FIG. 11 is a time chart showing one example of behaviors of various parameters related to EGR control in the third embodiment, including (a) accelerator opening and throttle opening, (b) accelerator operating speed, (c) EGR valve opening degree, (d) engine rotation speed and engine load, (e) EGR cut flag, and (f) EGR rate;

FIG. 12 is a flowchart showing one example of processing details of EGR control in a fourth embodiment;

FIG. 13 is a flowchart showing processing details continued from FIG. 12 in the fourth embodiment;

FIG. 14 is a time chart showing one example of behaviors of various parameters related to EGR control in the fourth embodiment, including (a) accelerator opening and throttle opening, (b) accelerator operating speed, (c) EGR valve opening degree, (d) engine rotation speed and engine load, (e) EGR cut flag, (f) initial setting flag, and (g) EGR rate;

FIG. 15 is an enlarged time chart showing behaviors of the EGR valve opening degree in FIG. 14 (c) in the fourth embodiment;

FIG. 16 is a flowchart showing one example of processing details of EGR control in a fifth embodiment;

FIG. 17 is a flowchart showing one example of processing details of EGR control in a sixth embodiment;

FIG. 18 is a graph showing one example of a valve closing speed map in the sixth embodiment;

FIG. 19 is a time chart showing one example of behaviors of various parameters related to EGR control in the sixth embodiment, including (a) accelerator opening and throttle opening, (b) accelerator operating speed, (c) EGR valve opening degree, (d) engine rotation speed and engine load, (e) EGR cut flag, and (f) EGR rate;

FIG. 20 is a flowchart showing one example of processing details of EGR control in a seventh embodiment;

FIG. 21 is a graph showing one example of a target attenuation value map in the seventh embodiment;

FIG. 22 is a time chart showing one example of behaviors of various parameters related to EGR control in the seventh embodiment, including (a) accelerator opening and throttle opening, (b) accelerator operating speed, (c) EGR valve opening degree, (d) engine rotation speed and engine load, (e) EGR cut flag, and (f) EGR rate;

FIG. 23 is a flowchart showing one example of processing details of EGR control in an eighth embodiment;

FIG. 24 is a graph showing one example of a target attenuation value map in the eighth embodiment;

FIG. 25 is a flowchart showing one example of processing details of EGR control in a ninth embodiment;

FIG. 26 is a graph showing one example of a delay time map in the ninth embodiment;

FIG. 27 is a time chart showing one example of behaviors of various parameters related to EGR control in the ninth embodiment, including (a) accelerator opening and throttle opening, (b) accelerator operating speed, (c) EGR valve opening degree, (d) engine rotation speed and engine load, (e) EGR cut flag, (f) time after establishment of ΔTAACC≦C1, and (g) EGR rate;

FIG. 28 is a flowchart showing one example of processing details of EGR control in a tenth embodiment;

FIG. 29 is a graph showing one example of an acceleration determination value map in the tenth embodiment;

FIG. 30 is a time chart showing one example of behaviors of various parameters related to EGR control in the tenth embodiment, including (a) accelerator opening and throttle opening, (b) accelerator operating speed, (c) EGR valve opening degree, (d) engine rotation speed and engine load, (e) EGR cut flag, and (f) EGR rate;

FIG. 31 is a flowchart showing one example of processing details of EGR control in an eleventh embodiment;

FIG. 32 is a graph showing one example of a rapid acceleration determination value map in the eleventh embodiment;

FIG. 33 is a graph showing one example of a slow acceleration determination value map in the eleventh embodiment;

FIG. 34 is a flowchart showing one example of processing details of EGR control in a twentieth embodiment;

FIG. 35 is a graph showing one example of a valve closing speed map in the twentieth embodiment;

FIG. 36 is a time chart showing one example of behaviors of various parameters related to EGR control in the twentieth embodiment, including (a) accelerator opening and throttle opening, (b) accelerator operating speed, (c) EGR valve opening degree, (d) engine rotation speed and engine load, (e) EGR cut flag, and (f) EGR rate;

FIG. 37 is a flowchart showing one example of processing details of EGR control in a thirteenth embodiment;

FIG. 38 is a graph showing one example of a target attenuation value map in the thirteenth embodiment; and

FIG. 39 is a time chart showing one example of behaviors of various parameters related to EGR control in the thirteenth embodiment, including (a) accelerator opening and throttle opening, (b) accelerator operating speed, (c) EGR valve opening degree, (d) engine rotation speed and engine load, (e) EGR cut flag, and (f) EGR rate.

### DESCRIPTION OF EMBODIMENTS

### First Embodiment

A detailed description of a first embodiment of a supercharger-equipped engine embodying an exhaust gas recirculation apparatus for an engine according to the present invention will now be given referring to the accompanying drawings.

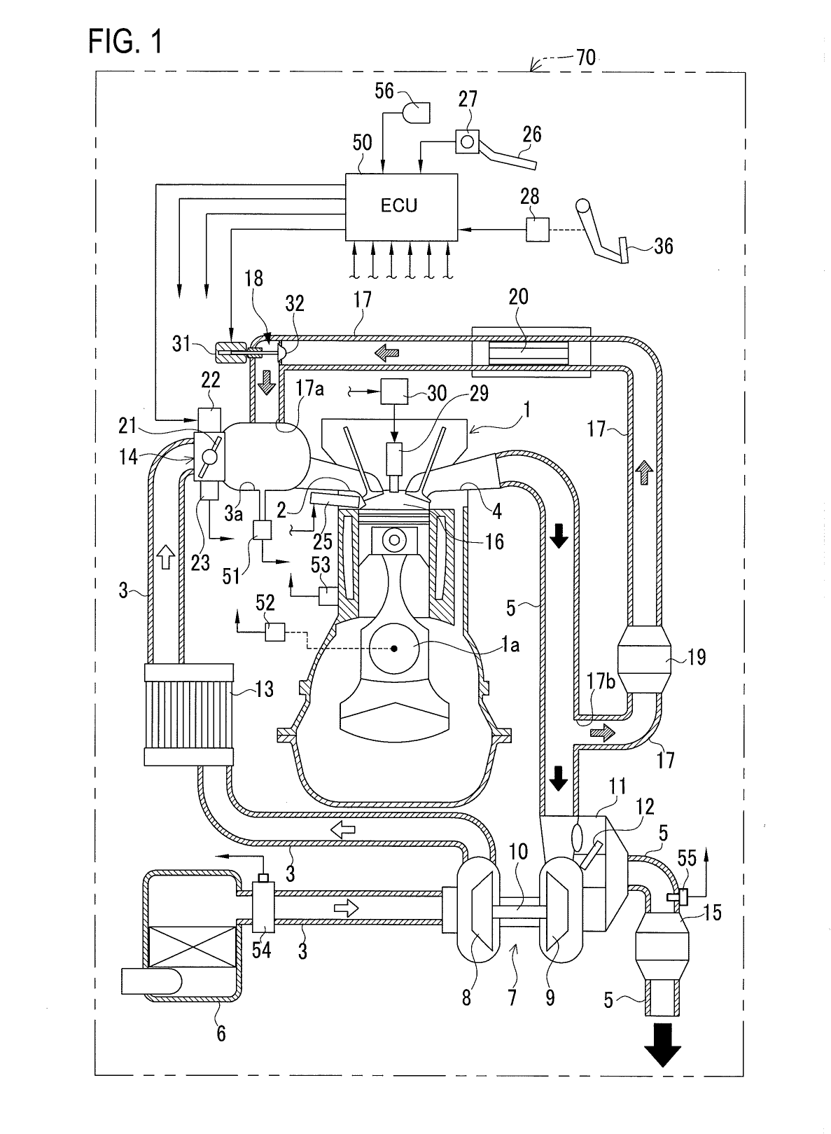

FIG. 1 is a schematic configuration view showing an engine system including an exhaust gas recirculation (EGR) apparatus for engine in this embodiment. This engine system is provided with a reciprocating type engine 1. In the engine 1, an intake port 2 is connected to an intake passage 3 and an exhaust port 4 is connected to an exhaust passage 5. At an inlet of the intake passage 3, an air cleaner 6 is provided. In the intake passage 3 downstream of the air cleaner 6, a supercharge 7 is provided between the intake passage 3 and the exhaust passage 5 to increase the pressure of intake air in the intake passage 3.

The supercharger 7 includes a compressor 8 placed in the intake passage 3, a turbine 9 placed in the exhaust passage 5, and a rotary shaft 10 connecting the compressor 8 and the turbine 9 so that they are integrally rotatable. The supercharger 7 is configured to rotate the turbine 9 by exhaust gas flowing in the exhaust passage 5 to integrally rotate the compressor 8 via the rotary shaft 10, thereby increasing the pressure of intake air in the intake passage 3, that is, making supercharging.

In the exhaust passage 5 adjacent to the supercharger 7, an exhaust bypass passage 11 is provided to bypass the turbine 9. In this exhaust bypass passage 11, a waste gate valve 12 is provided. This waste gate valve 12 is arranged to regulate exhaust gas allowed to flow in the exhaust bypass passage 11 to regulate an exhaust gas flow rate to be supplied to the turbine 9, thereby adjusting the rotation speeds of the turbine 9 and the compressor 8 to control supercharging pressure achieved by the supercharger 7.

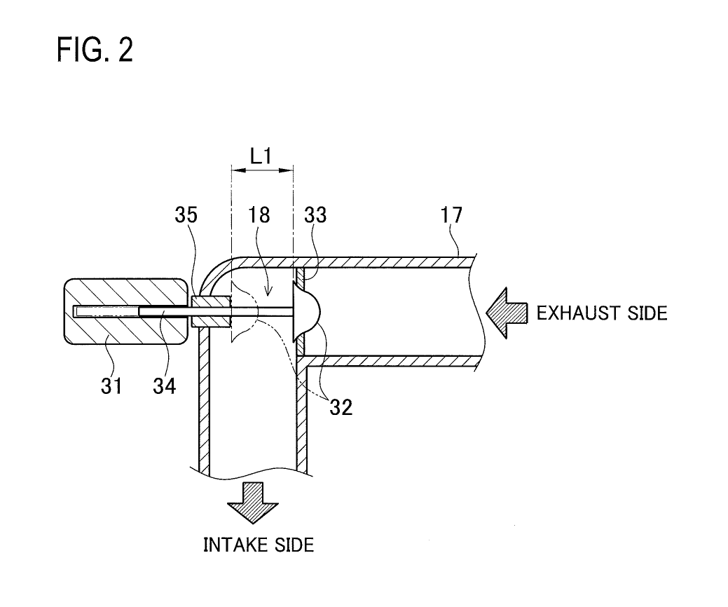

In the intake passage 3, an intercooler 13 is provided between the compressor 8 of the supercharger 7 and the engine 1. This intercooler 13 is used to cool the intake air increased in pressure and heated by the compressor 8 to an appropriate temperature. In the intake passage 13, a surge tank 3a is provided between the intercooler 13 and the engine 1. In the intake passage 3 downstream of the intercooler 13 and upstream of the surge tank 3a, an electronic throttle device 14 which is an electrical throttle valve is provided. The electronic throttle device 14 corresponding to one example of an intake amount regulation valve of the invention includes a butterfly-shaped throttle valve 21 placed in the intake passage 3, a step motor 22 to drive the throttle valve 21 to open and close, and a throttle sensor 23 corresponding to one example of an intake amount regulation valve opening degree detecting unit of the invention to detect an opening degree (a throttle opening degree) TA of the throttle valve 21. The electronic throttle device 14 is configured such that the throttle valve 21 is driven by the step motor 22 to open and close according to operation of an accelerator pedal 26 by a driver, to regulate the opening degree of the throttle valve 21. The configuration of the electronic throttle device 14 can adopt a basic structure of a “throttle device” disclosed in, for example, FIGS. 1 and 2 of JP 2011-252482A. Furthermore, in the exhaust passage 5 downstream of the turbine 9, a catalytic convertor 15 is provided as an exhaust catalyst to clean exhaust gas.

In the engine 1, there is provided an injector 25 to inject and supply fuel to a combustion chamber 16. The injector 25 is supplied with fuel from a fuel tank (not shown). The engine 1 is also provided with an ignition plug 29 corresponding to each cylinder. Each ignition plug 29 ignites in response to a high voltage outputted from an igniter 30. Ignition timing of each ignition plug 29 depends on output timing of the high voltage by the igniter 30.

In the present embodiment, the EGR apparatus to achieve high EGR includes an exhaust gas recirculation (EGR) passage 17 allowing part of exhaust gas discharged from the combustion chamber 16 of the engine 1 to the exhaust passage 5 to flow as EGR gas in the intake passage 3 and recirculate back to the combustion chamber 16, and an exhaust gas recirculation (EGR) valve 18 arranged in the EGR passage 17 to regulate an exhaust flow rate in the EGR passage 17. The EGR passage 17 is provided to extend between the exhaust passage 5 upstream from the turbine 9 and the surge tank 3a. Specifically, an outlet 17a of the EGR passage 17 is connected to the surge tank 3a on a downstream side from the throttle valve 14 in order to allow a part of exhaust gas flowing in the exhaust passage 5 to flow as EGR gas into the intake passage 3 and recirculate to the combustion chamber 16. An inlet 17b of the EGR passage 17 is connected to the exhaust passage 5 upstream from the turbine 9.

In the EGR passage 17, near the inlet 17b, an EGR catalytic converter 19 is provided to clean EGR gas. In the EGR passage 17 downstream from this EGR catalytic converter 19, an EGR cooler 20 is provided to cool EGR gas flowing in the EGR passage 17. In the present embodiment, the EGR valve 18 is located in the EGR passage 17 downstream from the EGR cooler 20.

FIG. 2 is an enlarged cross sectional view of a part of the EGR passage 17, in which the EGR valve 18 is provided. As shown in FIGS. 1 and 2, the EGR valve 18 is configured as a poppet valve and a motor-operated valve. To be concrete, the EGR valve 18 is provided with a valve element 32 to be driven by a step motor 31. The valve element 32 has an almost conical shape and is configured to seat on a valve seat 33 provided in the EGR passage 17. The step motor 31 includes an output shaft 34 arranged to reciprocate in a straight line (stroke movement). The valve element 32 is fixed at a leading end of the output shaft 34. This output shaft 34 is supported in the EGR passage 17 through a bearing 35. The stroke movement of the output shaft 34 of the step motor 31 is performed to adjust the opening degree or position of the valve element 32 with respect to the valve seat 33. The output shaft 34 of the EGR valve 18 is provided to allow stroke movement by a predetermined stroke L1 between a fully closed position in which the valve element 32 seats on the valve seat 33 and a fully opened position in which the valve element 32 contacts with the bearing 35. In the present embodiment, an opening area of the valve seat 33 is set larger than a conventional one in order to achieve high EGR. Accordingly, the valve element 32 is also designed with large size. The configuration of this EGR valve 18 can adopt a basic structure of an “EGR valve” disclosed in, for example, FIG. 1 of JP 2010-275941A.

In this embodiment, to execute fuel injection control, ignition timing control, air-intake amount control, EGR control, and others according to an operating condition of the engine 1, respectively, the injector 25, the igniter 30, the step motor 22 of the electronic throttle device 14, the step motor 31 of the EGR valve 18 are controlled by an electronic control unit (ECU) 50 according to the operating condition of the engine 1. The ECU 50 includes a central processing unit (CPU), various memories for storing predetermined control programs and others in advance or temporarily storing calculation results of the CPU, and an external input circuit and an external output circuit each connected to the above sections. The ECU 50 corresponds to one example of a control unit and an exhaust gas recirculation valve opening degree detecting unit of the invention. The external output circuit is connected with the igniter 30, injector 25, and step motors 22 and 31. The external input circuit is connected with not only the throttle sensor 23 but also various sensors 23, 27, 28, 51 to 55 corresponding to the operating condition detecting unit of the invention for detecting the operating condition of the engine 1, so that the external input circuit receives various engine signals from the sensors.

Various sensors provided herein are, in addition to the throttle sensor 23, an accelerator sensor 27, a brake sensor 28, an intake pressure sensor 51, a rotation speed sensor 52, a water temperature sensor 53, an air flowmeter 54, and an air-fuel ratio sensor 55. The accelerator sensor 27 detects an accelerator opening degree ACC which is an operation amount of the accelerator pedal 26. The accelerator pedal 26 corresponds to one example of an operating unit to operate an output request amount of the engine 1 by a driver. In this embodiment, therefore, the accelerator sensor 27 corresponds to one example of an output request amount detecting unit of the invention to detect the output request amount of the engine 1 by the driver. The brake sensor 28 corresponds to one example of a brake detecting unit of the invention to detect that the brake pedal 36 has been operated by depression. The engine 1 is mounted as a drive source in a vehicle 70. The brake pedal 36 will be depressed by a driver to stop the vehicle 70. The intake pressure sensor 51 detects intake pressure PM in the surge tank 3a. Specifically, the intake pressure sensor 51 detects the intake pressure PM in the intake passage 3 (surge tank 3a) downstream of a position in which EGR gas flows from the EGR passage 17 into the intake passage 3. The rotation speed sensor 52 corresponding to one example of a rotation speed detecting unit of the invention detects the rotation angle (crank angle) of a crank shaft 1a of the engine 1 and also detects changes of the crank angle as the rotation speed (engine rotation speed) NE of the engine 1. The water temperature sensor 53 detects the cooling water temperature THW of the engine 1. The air flowmeter 54 detects an intake amount Ga of intake air flowing in the intake passage 3 directly downstream of the air cleaner 6. The air-fuel ratio sensor 55 is placed in the exhaust passage 5 directly upstream of the catalytic convertor 15 to detect an air-fuel ratio A/F in the exhaust gas.

In the present embodiment, furthermore, a vehicle speed sensor 56 is provided in the vehicle 70 that mounts the engine 1. This vehicle speed sensor 56 is connected to the external input circuit of the ECU 50 and used to detect the vehicle speed SPD of the vehicle 70.

In the present embodiment, the ECU 50 is arranged to control the EGR valve 18 in order to control EGR according to the operating condition of the engine 1 in the entire operating region of the engine 1. During engine deceleration, the ECU 50 controls the electronic throttle device 14 to close a valve and controls the EGR valve 18 to fully close.

If closing of the EGR valve 18 is delayed during deceleration of the engine 1, the percentage of EGR gas (“EGR rate”) in the intake air flowing in the engine 1 increases. This may cause misfire during deceleration of the engine 1 or deterioration in driveability of the vehicle 70. In the present embodiment, therefore, to achieve early (rapidly) closing of the EGR valve 18 during deceleration of the engine 1 to prevent an increase in EGR rate, the ECU 50 executes the following EGR control.

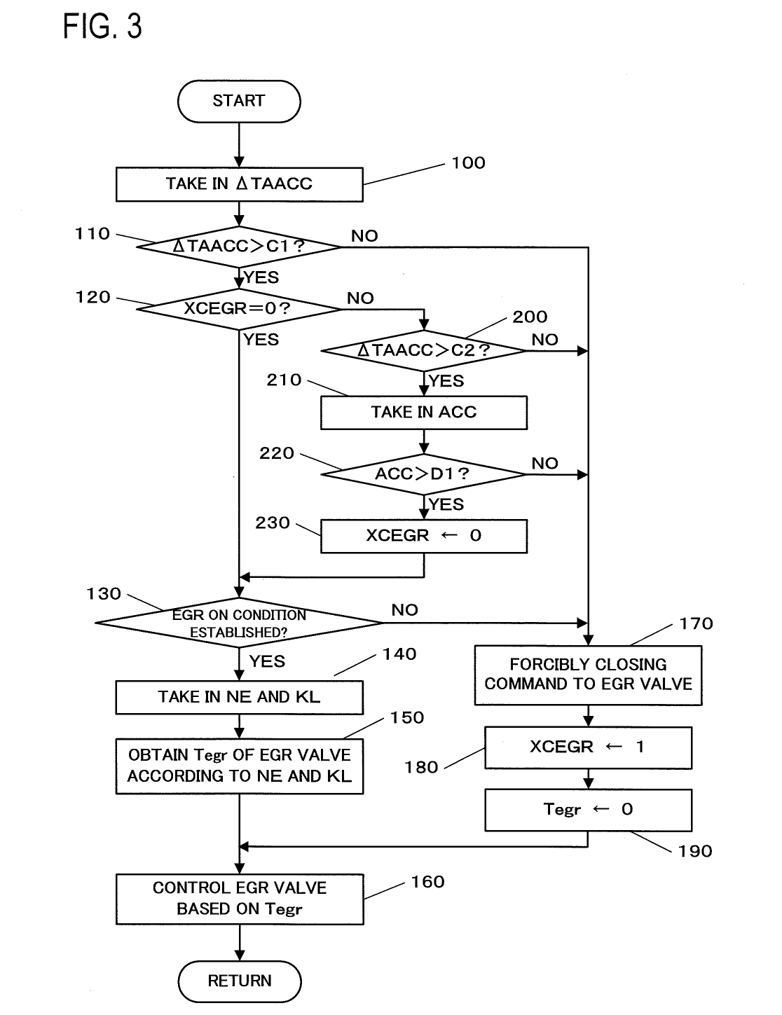

FIG. 3 is a flowchart showing one example of processing details of this EGR control. When the processing shifts to this routine, the ECU 50 first takes in an accelerator operating speed ΔTAACC in Step 100. Herein, the accelerator operating speed ΔTAACC represents the speed of operating the accelerator pedal 26 to move to a depressed state or operating the same to return from a depressed state (the speed of opening or the speed of closing) and is separately calculated by the ECU 50 based on a detection value of the accelerator sensor 27. Specifically, the ECU 50 can determine this accelerator operating speed ΔTAACC from a difference between a current detection value and a previous detection value detected by the accelerator sensor 27 when the accelerator pedal 26 is operated. Herein, the accelerator operating speed ΔTAACC when the accelerator pedal 26 is depressed to accelerate the engine 1 can be calculated as a positive value. The accelerator operating speed ΔTAACC when the accelerator pedal 26 is returned to decelerate the engine 1 can be calculated as a negative value.

In Step 110, the ECU 50 then determines whether or not the accelerator operating speed ΔTAACC is larger than a predetermined first deceleration determination value C1 (a negative value). This first deceleration determination value C1 is a threshold to judge that a request for deceleration operation (including rapid deceleration operation) is being made to the engine 1, and this value C1 corresponds to one example of a first determination value during deceleration operation of the present invention. If YES in Step 110, it is determined that the engine 1 is not requested for deceleration operation, the ECU 50 shifts the processing to Step 120.

In Step 120, the ECU 50 determines whether or not an EGR cut flag XCEGR is “0”. This EGR cut flag ECEGR is set to “1” when the EGR valve 18 is fully closed to cut EGR or set to “0” in other cases. If YES in Step 120, the ECU 50 shifts the processing to Step 130.

In Step 130, the ECU 50 determines whether or not an EGR ON condition is established. Specifically, it is determined whether or not the condition to open the EGR valve 18 is established. If YES in Step 130, the ECU 50 shifts the processing to Step 140.

In Step 140, the ECU 50 takes in an engine rotation speed NE and an engine load KL respectively based on detection values of the rotation speed sensor 52 and the intake pressure sensor 51. Herein, the ECU 50 can determine the engine load KL based on the engine rotation speed NE and the intake pressure PM.

In Step 150, the ECU 50 then obtains a target opening degree Tegr of the EGR valve 18 according to the engine rotation speed NE and the engine load KL. The ECU 50 can obtain this target opening degree Tegr by referring to a predetermined target opening degree map (not shown). The target opening degree map represents data of the target opening degree Tegr previously set from a relationship between the engine rotation speed NE and the engine load KL.

In Step 160, the ECU 50 controls the EGR valve 18 based on the target opening degree Tegr and then returns the processing to Step 100. In this case, the ECU 50 commands the EGR valve 18 to open or close to the target opening degree Tegr.

On the other hand, if NO in Step 130, determining that the EGR ON condition is not established, the ECU 50 shifts the processing to Step 170. In Step 170, the ECU 50 issues a forcibly closing command to the EGR valve 18, that is, commands the EGR valve 18 to forcibly close.

Successively, the ECU 50 sets the EGR cut flag XCEGR to “1” in Step 180 and sets the target opening degree Tegr to “0”, i.e., full closing, in Step 190.

In Step 160, the ECU 50 then controls the EGR valve 18 based on the target opening degree Tegr set to “0” and then returns the processing to Step 100. In this case, the ECU 50 causes the EGR valve 18 to fully close.

On the other hand, if NO in Step 110, determining that the request for deceleration operation is being made to the engine 1, the ECU 50 shifts the processing to Step 170 and executes the processings in Step 170 to 190 and 160 in a similar manner to the above. Specifically, the ECU 50 issues the forcibly closing command and a fully closing command to the EGR valve 18.

On the other hand, even if a determination result in Step 110 is negative (a request for deceleration operation) once, the accelerator operating speed ΔTAACC may change just after that, thus changing the determination result in Step 110 to affirmative. In this case, since the EGR cut flag XCEGR has been set to “1” just before, the determination result in Step 120 is negative and the ECU 50 shifts the processing to Step 200.

In Step 200, the ECU 50 determines whether or not the accelerator operating speed ΔTAACC is larger than a predetermined second deceleration determination value C2 (a negative value: C1<C2). This second deceleration determination value C2 is a threshold to determine that the deceleration operation request is being made to the engine 1 as with the first deceleration determination value C1. If NO in Step 200, it is determined that the deceleration operation request to the engine 1 is slightly weakened than just before but is still continued, the ECU 50 shifts the processing to Step 170 and, similar to the above, executes the processings in Steps 170 to 190 and 160.

On the other hand, if YES in Step 200, determining that the deceleration operation request to the engine 1 is removed, or stopped, the ECU 50 takes in an accelerator opening degree ACC based on the detection value of the accelerator sensor 27 in Step 210.

In Step 220, the ECU 50 then determines whether or not the accelerator opening degree ACC is larger than a predetermined first acceleration determination value D1. This first acceleration determination value D1 is a threshold to determine that the engine 1 is not requested for deceleration operation but is requested for another operation (including slow deceleration operation, steady operation, or acceleration operation) other than deceleration operation. This first acceleration determination value D1 corresponds to one example of a second determination value during deceleration operation of the invention. If NO in Step 220, determining that the deceleration operation request to the engine 1 is weakened than immediately before but is still continued, and thus the ECU 50 shifts the processing to Step 170 and, similar to the above, executes the processings in Step 170 to 190 and 160.

If YES in Step 220, on the other hand, it is determined that the deceleration operation request made by the driver is stopped and the deceleration operation (including rapid deceleration operation) is changed to another operation (including slow deceleration operation, steady operation, or acceleration operation), the ECU 50 sets the EGR cut flag XCEGR to “0” in Step 230 and then executes the above processings in Steps 130 to 160. Specifically, the ECU 50 releases the fully closing command to the EGR valve 18 and causes the EGR valve 18 to open to the target opening degree Tegr according to the engine rotation speed NE and the engine load KL.

According to the above controls of the present embodiment, the ECU 50 issues the fully closing command to the EGR valve 18 based on the accelerator operating speed ΔTAACC which is a change amount per unit of time of the accelerator opening degree ACC detected by the accelerator sensor 27, and releases the fully closing command to the EGR valve 18 based on the accelerator operating speed ΔTAACC and the accelerator opening degree ACC. To be concrete, the ECU 50 compares the accelerator operating speed ΔTAACC with the predetermined first deceleration determination value C1. Based on the comparison result, when it is determined that the deceleration operation request is being made to the engine 1, the ECU 50 issues the fully closing command to the EGR valve 18. When it is determined that the deceleration operation request is continued, the ECU 50 continues to issue the fully closing command. When it is determined the deceleration operation request is removed and the accelerator opening degree ACC is larger than the first acceleration determination value D1, the ECU 50 releases the fully closing command. After the fully closing command is released, the ECU 50 causes the EGR valve 18 to open to the target opening degree Tegr demanded at that time as needed.

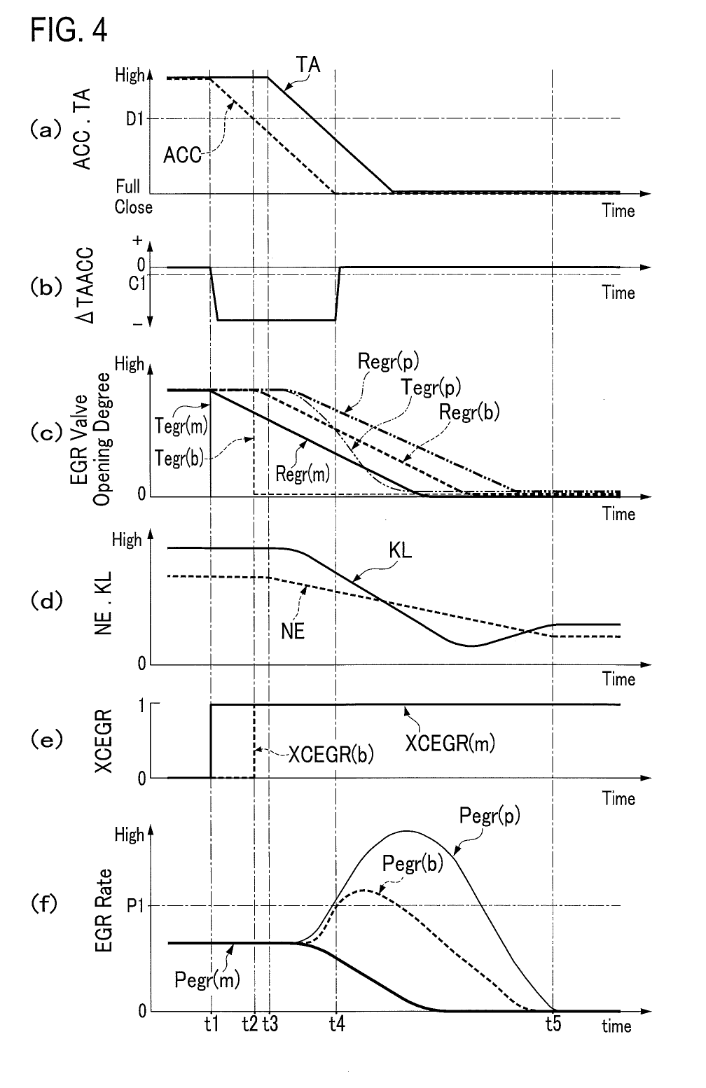

Herein, FIG. 4 is a time chart showing one example of behaviors of various parameters related to the above control, including (a) accelerator opening degree ACC and throttle opening degree TA, (b) accelerator operating speed ΔTAACC, (c) EGR valve opening degree, (d) engine rotation speed NE and engine load KL, (e) EGR cut flag XCEGR, and (f) EGR rate. In FIG. 4, during steady operation of the engine 1 before time t1, the percentage of EGR gas (“EGR rate”) supplied to the engine 1 is below an allowable EGR rate P1 during deceleration as indicated by a thick solid line (Pegr(m)) in FIG. 4(f). As indicated by a thick broken line in FIG. 4(a), the accelerator opening degree ACC decreases from a high opening degree to full close from t1 toward t4. At that time, the accelerator opening degree ACC starts to decrease at time t1 as indicated by the thick broken line in FIG. 4(a). When the accelerator operating speed ΔTAACC sharply decreases to a negative value as indicated in FIG. 4(b), the EGR cut flag XCEGR(m) is changed to “1” as indicated by a thick solid line in FIG. 4(e), the target opening degree Tegr(m) of the EGR valve 18 instantly becomes “0” as indicated by a solid line in FIG. 4(c), and the actual opening degree Regr(m) of the EGR valve 18 immediately starts to decrease as indicated by a thick solid line in FIG. 4(c).

Thereafter, when the throttle opening degree TA starts to decrease at time t3 later than time t1 as indicated by a thick solid line in FIG. 4(a), the engine rotation speed NE kept constant ever starts to decrease and also the engine load KL starts to decrease a little later as indicated in FIG. 4(d). In the present embodiment, at the same time when the accelerator operating speed ΔTAACC is changed to a negative value at time t1, the target opening degree Tegr(m) instantly becomes “0” and the actual opening degree Regr(m) immediately starts to decrease. Accordingly, as indicated by the thick solid line in FIG. 4(f), the EGR rate after time t3 continues to be below the allowable EGR rate P1 and gradually decreases to reach “0” before time t5.

In a previous example provided by the present applicant, at time t2 until which the accelerator operating speed ΔTAACC changed to a negative value at time t1′ remains unchanged for a certain period as shown in FIG. 4(b), the EGR cut flag XCEGR(b) is changed to “1” as indicated by a thick broken line in FIG. 4(e), the target opening degree Tegr(b) of the EGR valve 18 becomes “0” as indicated by a broken line in FIG. 4(c), and the actual opening degree Regr(b) starts to decrease as indicated by a thick broken line in FIG. 4(c). The EGR rate Pegr(b) starts to rise once after time t3 as indicated by a thick broken line in FIG. 4(f), exceeds the allowable rate P1 during deceleration at time t4, and finally gradually decreases toward “0” until t5.

In the conventional example, on the other hand, from when the throttle opening degree TA starts to decrease at time t3 as indicated in FIG. 4 (a), the target opening degree Tegr(p) of the EGR valve 18 is late decreasing as indicated by a double-dashed broken line in FIG. 4(c), and the actual opening degree Regr(p) starts to decrease later as indicated by a thick double-dashed line in FIG. 4(c). Accordingly, as indicated by a solid line in FIG. 4(f), the EGR rate Pegr(p) starts to increase once after time t3, exceeds the allowable EGR rate P1 during deceleration at time t4 and sharply rises, and abruptly decreases toward “0” until right after time t5.

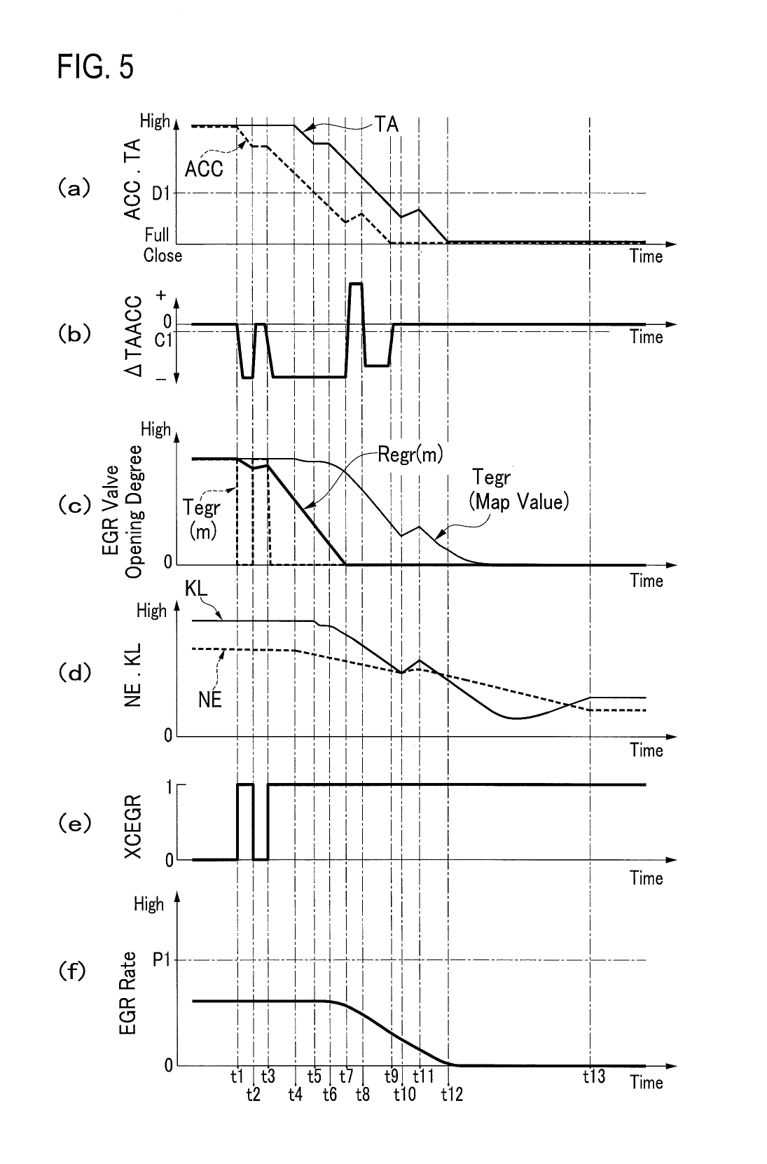

FIG. 5 is a time chart showing another example of the behaviors of various parameters related to the above control, including (a) accelerator opening degree ACC and throttle opening degree TA, (b) accelerator operating speed ΔTAACC, (c) EGR valve opening degree, (d) engine rotation speed NE and engine load KL, (e) EGR cut flag XCEGR, and (f) EGR rate. As indicated by a thick broken line in FIG. 5(a), the accelerator opening degree ACC decreases while slightly varying from a certain high opening degree to full close from time t1 to time t9. At that time, as shown in FIG. 5(a), the accelerator opening degree ACC starts to decrease at time t1. As shown in FIG. 5(b), the accelerator operating speed ΔTAACC sharply decreases to a negative value. Accordingly, the EGR cut flag XCEGR is changed to “1” as indicated in FIG. 5(e), the target opening degree Tegr(m) of the EGR valve 18 instantly becomes “0” as indicated by a thick broken line in FIG. 5(c), and the actual opening degree Regr(m) of the EGR valve 18 immediately starts to decrease as indicated by a thick solid line in FIG. 5(c). In FIG. 5(c), the target opening degree Tegr(m) indicated by the thick broken line represents a value determined during deceleration operation, and the target opening degree Tegr (a map value) indicated by a solid line represents a map value determined according to the engine rotation speed NE and the engine load KL referring to the target opening degree map.

Thereafter, as shown in FIG. 5(a), between time t2 and t4, when the accelerator opening degree ACC stops decreasing once and changes to decrease again, the accelerator operating speed ΔTAACC rapidly increases to “0” once and returns to a negative value again as shown in FIG. 5(b). The EGR cut flag XCEGR is thus changed to “0” once and returns to “1” again as shown in FIG. 5(e). As indicated by the thick broken line in FIG. 5(c), further, the target opening degree Tegr(m) instantly becomes a predetermined valve opening value once and then returns to “0” again. As indicated by the thick solid line in FIG. 5(c), the actual opening degree Regr(m) increases once and shifts to decreasing again, and becomes “0” at time t7, that is, full close.

Subsequently, from time t4 to t6, later than time t1 to t3, as the throttle opening degree TA decreases while varying as indicated by a thick solid line in FIG. 5(a), the engine rotation speed NE kept nearly constant ever starts to decrease and the engine load KL starts to decrease slightly later as indicated in FIG. 5(d).

Thereafter, from time t7 to t9, when the accelerator opening degree ACC increases once and shifts to decreasing again as shown in FIG. 5(a), the accelerator operating speed ΔTAACC sharply increases to a positive value once and returns to a negative value again as shown in FIG. 5(b). At that time, however, the accelerator opening degree ACC being smaller than the first acceleration determination value D1 as shown in FIG. 5(a), the EGR cut flag XCEGR remains “1” as shown in FIG. 5(e), the target opening degree Tegr(m) of the EGR valve 18 remains “0” as indicated by the thick broken line in FIG. 5(c), and the actual opening degree Regr(m) remains “0” as indicated by the thick solid line in FIG. 5(c).

Then, from time t10 through t12, later than time t7 to t9, when the throttle opening degree TA increases once and then decreases as shown in FIG. 5(a), the engine rotation speed NE and the engine load KL ever continuing to decrease are increased once and then continue to decrease as shown in FIG. 5(d).

Herein, as shown in FIG. 5(a), from time t1 to t2, even when the accelerator opening degree ACC somewhat changes in the course of decreasing toward full close and the accelerator operating speed ΔTAACC becomes a negative value once and then becomes “0” or somewhat changes to a positive value, unless it continues to be “0” or positive value, the target opening degree Tegr(m) of the EGR valve 18 is returned to “0”, and the actual opening degree Regr(m) continues to decrease toward “0”. Accordingly, the EGR rate remains constant below the allowable EGR rate P1 during deceleration and then gradually decreases.

According to the exhaust gas recirculation apparatus for an engine in the present embodiment explained as above, the ECU 50 controls the EGR valve 18 based on the target opening degree Tegr calculated according to the operating condition of the engine 1 in order to regulate a flow of EGR gas in the EGR passage 17. Herein, the ECU 50 compares the accelerator operating speed ΔTAACC representing a negative change amount per unit of time of the accelerator opening degree ACC to the predetermined first deceleration determination value C1. Based on this comparison result, when it is determined that the deceleration operation request is being made to the engine 1 by a driver, the ECU 50 issues the fully closing command to the EGR valve 18. When it is determined that the deceleration operation request is continued, the ECU 50 continues to issue the fully closing command. Furthermore, based on the above comparison result, when it is determined that the deceleration operating request is removed and the accelerator opening degree ACC is larger than the first acceleration determination value D1, the ECU 50 releases the fully closing command issued until now. After releasing the fully closing command, the ECU 50 commands the EGR valve 18 to open to the target opening degree Tegr calculated at that time as needed.

The deceleration operation request to command the EGR valve 18 to fully close is determined based on determining the continuation of the request and determining the discontinuation or removal of the request. Thus, the deceleration operation request can be determined with high response. Accordingly, the fully closing command to the EGR valve 18 is made more rapidly. Furthermore, the fully closing command to the EGR valve 18 is released more rapidly in response to removal of a request from the driver. This makes it possible to quickly fully close the EGR valve 18 to cut EGR when the deceleration operation request is being made to the engine 1, thereby avoiding misfire during deceleration of the engine 1, and also to promptly interrupt a fully closing operation of the EGR valve 18 when the deceleration operation request is returned to another operation request. Specifically, the EGR rate Pegr(m) in intake air to be supplied to the engine 1 can be reduced rapidly without increasing inadvertently. Thus, it is possible to prevent misfire from occurring in the engine 1 due to excessive EGR during deceleration operation. When the deceleration operation is returned to another operation, the EGR valve 18 is rapidly opened to supply an adequate amount of EGR gas to the combustion chamber 16. This can rapidly interrupt the fully closing operation of the EGR valve 18 when the deceleration operation request is returned to another operation request, ensuring opening of the EGR valve 18 to perform appropriate EGR. This can improve fuel consumption and exhaust emission of the engine 1.

The above rapid determination on the deceleration operation request can be achieved because the accelerator operating speed ΔTAACC is simply compared to the predetermined first deceleration determination value C1. This can be made because the continuation of deceleration operation request and the removal of deceleration operation request are judged together after the deceleration operation request is determined. To judge those request continuation and the request removal, the accelerator operating speed ΔTAACC is further compared to the predetermined second deceleration determination value C2 and the corresponding accelerator opening degree ACC is compared to the first acceleration determination value D1 to monitor changes in request for deceleration operation.

In the present embodiment, it is possible to prevent misfire from occurring in the engine 1 due to excessive EGR during deceleration operation and hence avoid deterioration in driveability of the vehicle 70.

### Second Embodiment

A second embodiment of a supercharger-equipped engine embodying an exhaust gas recirculation apparatus for an engine according to the present invention will now be given referring to the accompanying drawings.

In each of the following embodiments, similar or identical parts to those in the first embodiment are given the same reference signs and their details are omitted, so that the following explanation is given with a focus on differences from the first embodiment.

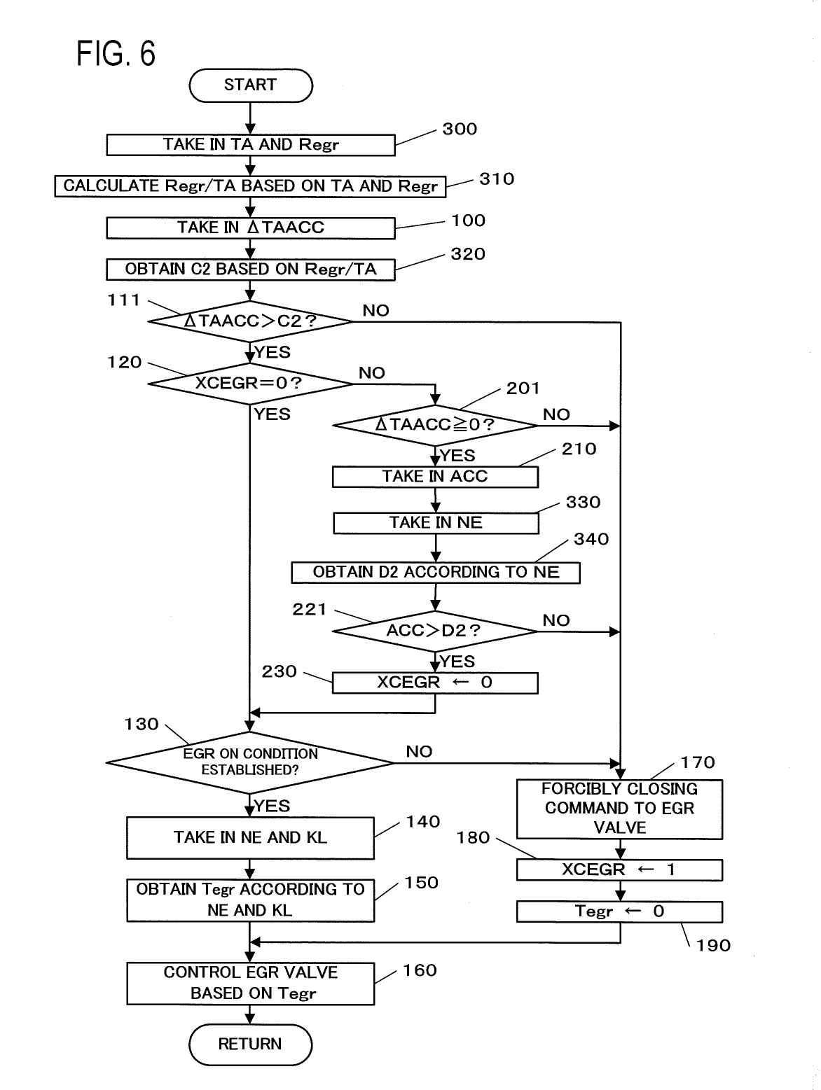

The second embodiment differs from the first embodiment in the processing details of EGR control. FIG. 6 is a flowchart showing one example of the processing details of the EGR control of the present embodiment. In the flowchart of FIG. 6, differently from the flowchart of FIG. 3, the processings in Steps 111, 201, and 221 are provided instead of the processings in Steps 110, 200, and 220 of the flowchart of FIG. 3, the processings in Steps 300, 310, and 320 are added before and after Step 100, and the processings in Steps 330 and 340 are added between Steps 210 and 221.

Specifically, when the processing is shifted to this routine, in Step 300, the ECU 50 takes in a throttle opening degree TA based on a detection value of the throttle sensor 23 and takes in an actual opening degree Regr of the EGR valve 18 from the current number of steps commanded to the step motor 31. Herein, both the throttle opening degree TA and the actual opening degree Regr are represented by a percentage under the condition that full opening is assumed as “100(%)”.

In Step 310, based on the throttle opening degree TA and the actual opening degree Regr, the ECU 50 calculates a ratio of the actual opening degree Regr to the throttle opening degree TA, i.e., an opening ratio: Regr/TA.

In Step 100, the ECU 50 then takes in an accelerator operating speed ΔTAACC.

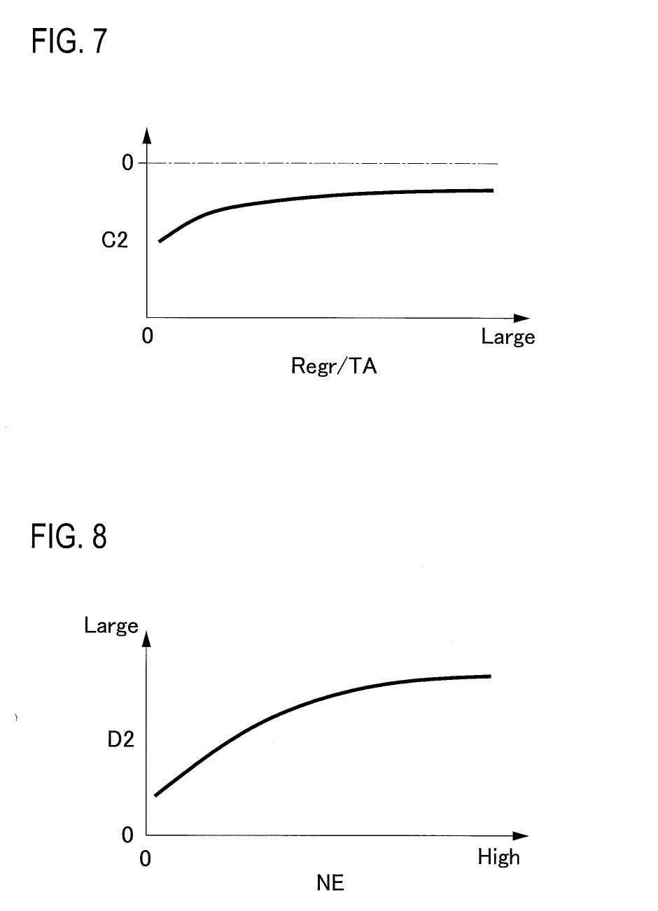

In Step 320, successively, the ECU 50 obtains a second deceleration determination value C2 based on the opening ratio: Regr/TA. The ECU 50 can obtain this second deceleration determination value C2 by referring to a deceleration determination value map as shown in FIG. 7 for example. The map in FIG. 7 is set so that the second deceleration determination value C2 is decreased to a certain level as the opening ration Regr/TA is smaller. Herein, since the second deceleration determination value C2 is a negative value, a decrease in this value represents an increase in a negative change amount of the accelerator opening degree ACC.

In Step 111, the ECU 50 determines whether or not the accelerator operating speed ΔTAACC is larger than the second deceleration determination value C2 (a negative value) currently obtained. This second deceleration determination value C2 is a threshold to judge that a request for deceleration operation (including rapid deceleration operation) is being made to the engine 1, and corresponds to one example of the first determination value during deceleration operation of the invention. If YES in Step 111, determining that the engine 1 is not requested for deceleration operation, the ECU 50 shifts the processing to Step 120. On the other hand, if NO in Step 111, determining that the engine 1 is being requested for deceleration operation, the ECU 50 shifts the processing to Step 170 and executes the processings in Steps 170 to 190 and 160. Specifically, the ECU 50 gives a forcibly closing command and a fully closing command to the EGR valve 18.

Calculating the opening ratio Regr/TA as above is because misfire during deceleration of the engine 1 is more likely to occur as this opening ratio Regr/TA is larger. In this embodiment, therefore, the second deceleration determination value C2 is obtained according to the opening ratio Regr/TA, and the accelerator operating speed ΔTAACC is compared to that second deceleration determination value C2.

On the other hand, if NO in Step 120 while the EGR valve 18 is under the fully closing command, the ECU 50 determines whether or not the accelerator operating speed ΔTAACC is equal to or larger than “0” in Step 201. The accelerator operating speed ΔTAACC when the accelerator pedal 26 is operated to return from a depressed state during deceleration operation is inherently a negative value. Thus, the accelerator operating speed ΔTAACC being “0” or “a positive value” means that the operation of the accelerator pedal 26 is stopped or the accelerator pedal 26 is depressed (opening operation). If NO in Step 201, it is determined that the deceleration operation request to the engine 1 is slightly weakened than immediately before but is still continued, the ECU 50 shifts the processing to Step 170 and, similar to the above, executes the processings in Steps 170 to 190 and 160.

On the other hand, if YES in Step 201, determining that the deceleration operation request to the engine 1 is removed, the ECU 50 takes in an accelerator opening degree ACC based on the detection value of the accelerator sensor 27 in Step 210.

In Step 330, successively, the ECU 50 takes in an engine rotation speed NE based on a detection value of the rotation speed sensor 52.

In Step 340, the ECU 50 obtains a second acceleration determination value D2 according to the engine rotation speed NE. The ECU 50 calculates this second acceleration determination value D2 by referring to an acceleration determination value map as shown in FIG. 8 for example. The map in FIG. 8 is set so that the second acceleration determination value D2 is increased to a certain level as the engine rotation speed NE is higher. Herein, the reason why the second acceleration determination value D2 is obtained according to the engine rotation speed NE is because the accelerator opening degree ACC during steady operation is higher as the engine rotation speed NE is higher, thereby enabling more accurate determination on the steady condition. In the second embodiment, the second acceleration determination value D2 corresponds to one example of the second determination value during deceleration operation of the present invention.

In Step 221, the ECU 50 then determines whether or not the accelerator opening degree ACC is larger than the second acceleration determination value D2 currently obtained. This second acceleration determination value D2 is a threshold to determine that the deceleration operation request to the engine 1 is removed and another operation (including slow deceleration operation, steady operation, or acceleration operation) other than the deceleration operation is requested. In NO in Step 221, it is determined that the deceleration operation request to the engine 1 is weakened than immediately before but is still continued, the ECU 50 shifts the processing to Step 170 and, similarly to the above, executes the processings in Steps 170 to 190 and 160.

If YES in Step 221, on the other hand, it is determined that the deceleration operation request made by the driver is stopped and the deceleration operation (including rapid deceleration operation) is changed to another operation (including slow deceleration operation, steady operation, or acceleration operation), the ECU 50 sets the EGR cut flag XCEGR to “0” in Step 230 and executes the above processings in Steps 130 to 160. Specifically, the ECU 50 releases the fully closing command to the EGR valve 18 and causes the EGR valve 18 to open to the target opening degree Tegr according to the engine rotation speed NE and the engine load KL.

According to the above control of the second embodiment, differently from the first embodiment, the ECU 50 sets the ratio of the actual opening degree Regr of the EGR valve 18 detected by the ECU 50 with respect to the throttle opening degree TA of the electronic throttle device 14 (the throttle valve 21) detected by the throttle sensor 23, i.e., sets the second deceleration determination value C2 according to the opening ratio, Regr/TA. The ECU 50 further sets, according to the engine rotation speed NE detected by the rotation speed sensor 52, the second acceleration determination value D2 for defining the range of the accelerator opening ACC to release the fully closing command to the EGR valve 18.

According to the exhaust gas recirculation apparatus for an engine in the second embodiment explained above, it can provide the following operations and advantages in addition to the operations and advantages in the first embodiment. In general, specifically, the misfire during deceleration of the engine 1 resulting from EGR gas tends to become stricter as the opening ratio Rger/TA which is a ratio of the actual opening degree Regr of the EGR valve 18 with respect to the throttle opening degree TA of the electronic throttle device 14 is larger. Herein, to determine whether or not the deceleration operation request is being made to the engine 1, the second deceleration determination value C2 to be compared to the accelerator operating speed ΔTAACC is set according to the opening ratio Regr/TA by the ECU 50. The deceleration operation request is properly judged according to the tendency to cause misfire during deceleration. In such a situation that misfire during deceleration is apt to occur in the engine 1, therefore, it is possible to accurately determine the deceleration operation request, rapidly bring the EGR valve 18 to a fully closed position to cut EGR, and reliably prevent the misfire during deceleration.

According to the present embodiment, in general, the accelerator opening degree ACC by the driver during deceleration operation of the engine 1 tends to be larger as the engine rotation speed NE is higher. Herein, the second acceleration determination value D2 to be compared to the accelerator opening AC is set by the ECU 50 according to the engine rotation speed NE in order to determine whether or not the deceleration operation request is removed. Thus, the removal of the deceleration operation request can be judged appropriately according to the engine rotation speed NE. Therefore, even after the deceleration operation request is determined once and the EGR valve 18 is commanded to fully close, the removal of the deceleration operation request can be judged more accurately, thereby enabling rapidly releasing the full closing of the EGR valve 18.

### Third Embodiment

A third embodiment of a supercharger-equipped engine embodying an exhaust gas recirculation apparatus for an engine according to the present invention will now be given referring to the accompanying drawings.

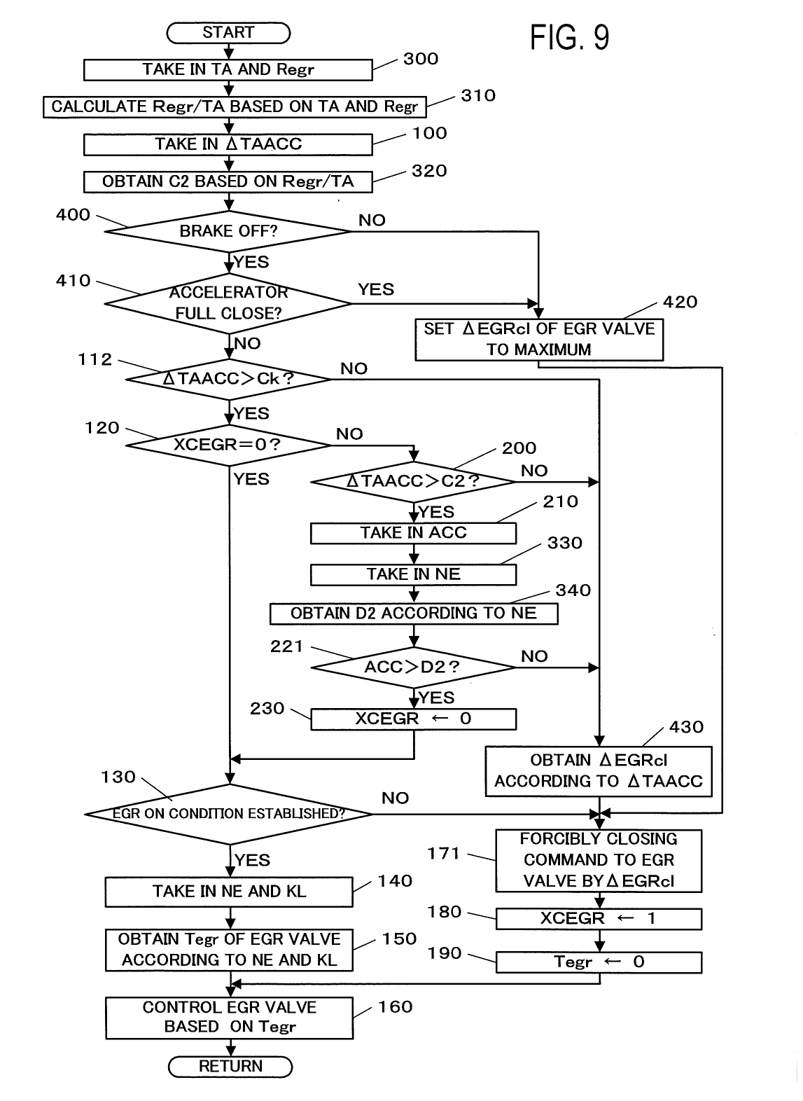

The third embodiment differs from the first and second embodiments in the processing details of EGR control. FIG. 9 is a flowchart showing one example of the processing details of the EGR control of the present embodiment. In the flowchart of FIG. 9, differently from the flowchart of FIG. 6, the processings in Steps 112, 171, and 200 are provided instead of the processings n Steps 111, 170, and 201 of the flowchart of FIG. 6, the processings in Steps 400 and 410 are added between Steps 320 and 112, the processing in Step 420 is added between Steps 410 and 171, and the processing in Step 430 is added between Steps 112 and the 171.

Specifically, after obtaining the second deceleration determination value C2 based on the opening ratio Regr/TA in Step 320, the ECU 50 determines in Step 400 whether or not the brake is OFF based on detection of the brake sensor 28. If NO in Step 400, that is, if the brake is ON, meaning that the brake pedal 36 is being depressed to request stop of the vehicle 70, it is considered that the deceleration operation request to the engine 1 is strongest, and the ECU 50 sets, in Step 420, a valve closing speed ΔEGRcl of the EGR valve 18 to a maximum value.

In Step 171, successively, the ECU 50 issues a forcibly closing command to the EGR valve 18 at the maximum valve closing speed ΔEGRcl. In other words, the ECU 50 commands the EGR valve 18 to forcibly close at the maximum valve closing speed ΔEGRcl. The ECU 50 then sets the EGR cut flag XCEGR to “1” in Step 180, and sets the target opening degree Tegr to “0”, i.e., sets fully closing, in Step 190. In Step 160, the ECU 50 controls the EGR valve 18 based on the target opening degree Tegr set to “0” and then returns the processing to Step 100.

If YES in Step 400, on the other hand, the brake pedal 36 being not depressed, the ECU 50 determines in Step 410 whether or not the accelerator is fully closed based on detection of the accelerator sensor 27. Specifically, it is determined whether or not the accelerator pedal 26 is operated to return from depression. When the accelerator operating speed ΔTAACC is equal to or smaller than a predetermined value in negative value (i.e., equal to or larger than the predetermined value in absolute value) or when the accelerator opening degree ACC is zero, the ECU 50 can judge that the accelerator is in a fully closed state. If YES in Step 410, the deceleration operation request to the engine 1 is considered as continuing, the ECU 50 executes the processings in Steps 420, 171, 180, 190, and 160 in a similar manner to the above. Specifically, the ECU 50 gives a forcibly closing command with the maximum valve closing speed ΔEGRcl and a fully closing command to the EGR valve 18.

If NO in Step 410, on the other hand, the ECU 50 determines in Step 112 whether or not the accelerator operating speed ΔTAACC is larger than a third deceleration determination value Ck (a negative value). This third deceleration determination value Ck is a threshold to determine that the request for deceleration operation (including rapid deceleration operation) is being made to the engine 1. This value Ck is a smaller value than the second deceleration determination value C2. If NO in Step 112, it is determined that the engine 1 is being requested for deceleration operation, the ECU 50 shifts the processing to Step 430.

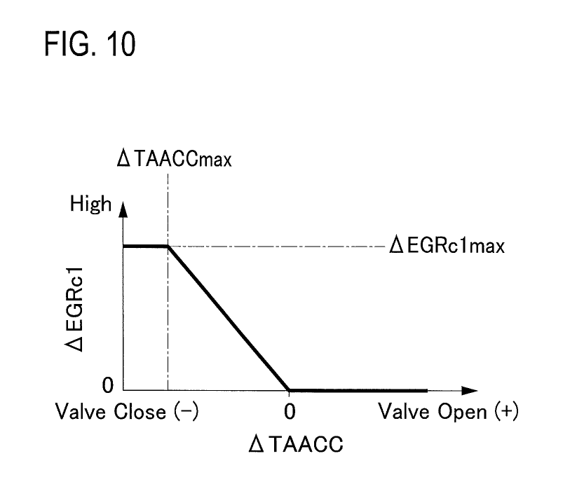

In Step 430, the ECU 50 obtains a valve closing speed ΔEGRcl of the EGR valve 18 according to the accelerator operating speed ΔTAACC. For instance, the ECU 50 can obtain the valve closing speed ΔEGRcl by referring to a valve closing speed map as shown in FIG. 10. The map in FIG. 10 is set such that the valve closing speed ΔEGRcl of the EGR valve 18 is higher toward a maximum value ΔEGRclmax as the accelerator operating speed ΔTAACC is decreased (becomes smaller to a negative value), i.e., as the accelerator pedal 26 is returned more rapidly from depression.

Thereafter, in Step 171, the ECU 50 issues a forcibly closing command to the EGR valve 18 with the obtained valve closing speed ΔEGRcl and, similarly to the above, executes the processings in Steps 180, 190, and 160. Specifically, the ECU 50 commands the EGR valve 18 to forcibly close at a certain valve closing speed ΔEGRcl and to fully close.

If YES in Step 112, on the other hand, it is determined that the deceleration operation request is not made to the engine 1, the ECU 50 determines in Step 120 whether or not the EGR cut flag XCEGR is “0”. Even if the determination result in Step 112 is negative (a deceleration operation request) once, the accelerator operating speed ΔTAACC may be changed immediately after that, thus changing the determination result in Step 112 to affirmative. In this case, since the EGR cut flag XCEGR has been set to “1” just before, the determination result in Step 120 is negative. Thus, the ECU 50 shifts the processing to Step 200, and then executes the processings in Steps 200, 210, 330, 340, 221, and 230, and further the processings in Steps 130 to 160.

If YES in Step 120, furthermore, it is determined that the deceleration operation request is not made to the engine 1, the ECU 50 directly executes the processings in Steps 130 to 160.

According to the above controls of the third embodiment, differently from the second embodiment, the ECU 50 sets a fully closing command condition for commanding the EGR valve 18 to fully close, according to the accelerator operating speed ΔTAACC. More specifically, when commanding the EGR valve 18 to fully close, the ECU 50 causes the EGR valve 18 to close based on the valve closing speed ΔEGRcl and also sets this valve closing speed ΔEGRcl according to the accelerator operating speed ΔTAACC. When the accelerator operating speed ΔTAACC is equal to or lower than the predetermined value or when the accelerator opening degree ACC is zero, the ECU 50 determines the deceleration operation request is continued and sets the valve closing speed ΔEGRcl to the maximum value to cause the EGR valve 18 to close at the maximum valve closing speed ΔEGRcl. When it is determined that the brake pedal 36 is operated based on a detection result of the brake sensor 28, the ECU 50 also sets the valve closing speed ΔEGRcl to the maximum value and causes the EGR valve 18 to close at the maximum valve closing speed ΔEGRcl.

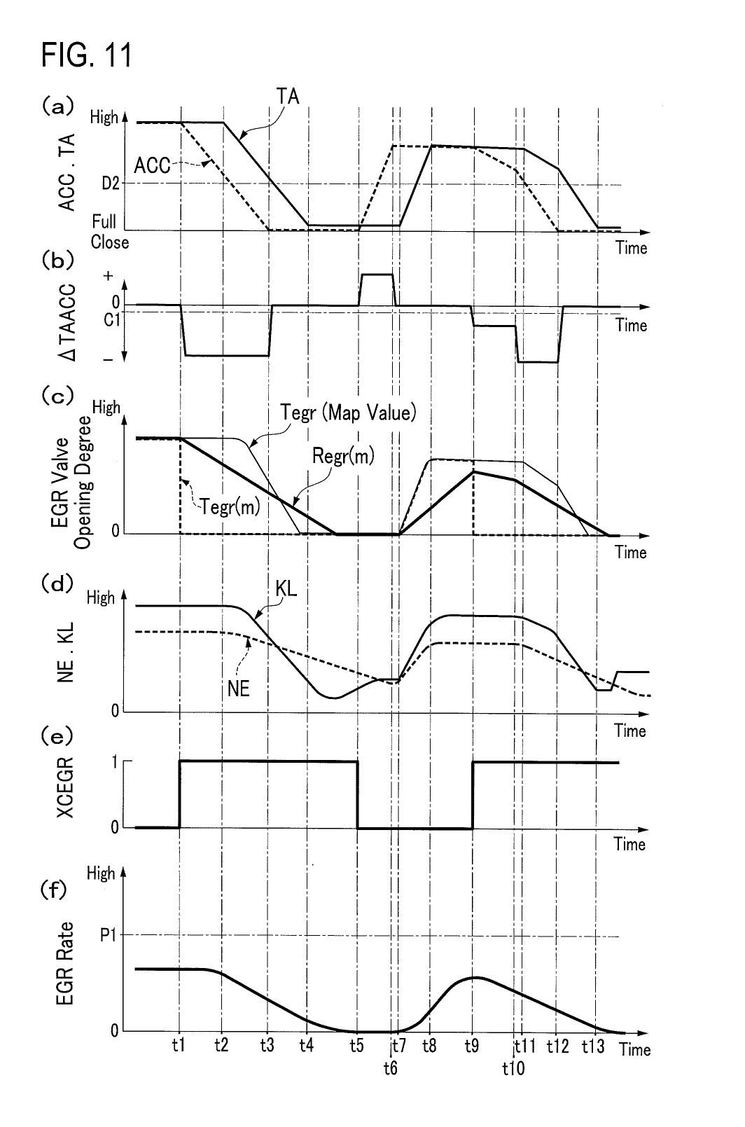

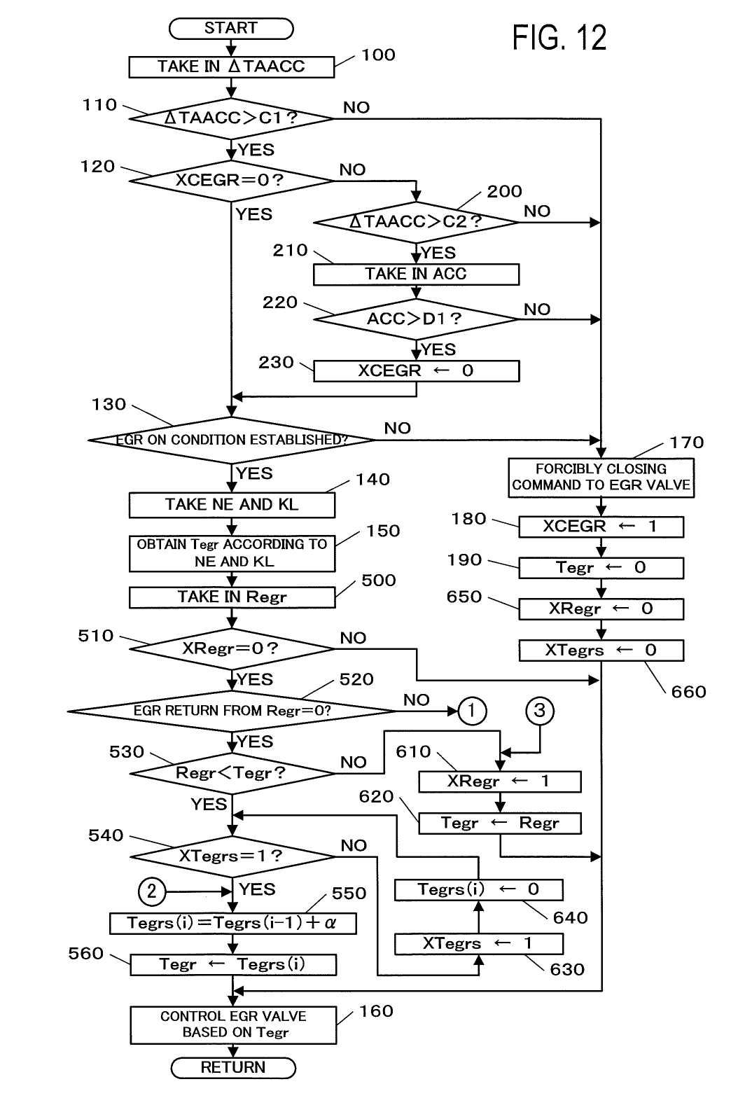

Herein, FIG. 11 is a time chart showing one example of behaviors of various parameters related to the above control, including (a) accelerator opening degree ACC and throttle opening degree TA, (b) accelerator operating speed ΔTAACC, (c) EGR valve opening degree, (d) engine rotation speed NE and engine load KL, (e) EGR cut flag XCEGR, and (f) EGR rate. The characteristics of this time chart are in that the accelerator opening degree ACC and the throttle opening degree TA greatly vary from time t1 to t3. Specifically, as indicated by a thick broken line in FIG. 11(a), the accelerator opening degree ACC decreases from a certain high opening degree to full close from time t1 to t4, increases from full close up to a certain opening degree from time t4 to t8, and decreases from the certain opening degree to full close from time t8 through t13. In this period, the throttle opening degree TA changes slightly later than a change in the accelerator opening degree ACC and with a tendency almost similar to that of the accelerator opening degree ACC as shown in FIG. 11(a). According to the above accelerator opening degree ACC and throttle opening degree TA, furthermore, the accelerator operating speed ΔTAACC, the EGR valve opening degree, the engine rotation speed NE, the engine load KL, the EGR cut flag XCEGR, and the EGR rate vary as shown in FIG. 11(b) to (f). The characteristics of this time chart are in that the accelerator operating speed ΔTAACC changes and accordingly a change rate (inclination) of the actual opening degree Regr(m) changes between time t9 and t10 and between time t10 and t12.

According to the exhaust gas recirculation apparatus for an engine in the third embodiment explained above, it can provide the following operations and advantages in addition to the operations and advantages in the second embodiment. Specifically, in general, the deceleration operation request to the engine 1 tends to be stronger as the accelerator operating speed ΔTAACC is smaller in negative value (larger in absolute value). When it is determined that the deceleration operation is being requested, the ECU 50 sets the valve closing speed ΔEGRcl according to the accelerator operating speed ΔTAACC. The EGR valve 18 is closed toward full close at the set valve closing speed ΔEGRcl. Accordingly, when the deceleration operation is requested and the ECU 50 issues the fully closing command to the EGR valve 18, the EGR valve 18 is caused to close toward a fully closed position based on the valve closing speed ΔEGRcl set according to the strength or degree of operation request. During deceleration operation of the engine 1, therefore, the EGR valve 18 can be closed toward the fully closed position at an appropriate speed according to the strength of the deceleration operation request, thereby enabling cutting of EGR as promptly as possible.

According the present embodiment, generally, the deceleration operation request to the engine 1 tends to be stronger as the accelerator operating speed ΔTAACC is smaller in negative value (larger in absolute value) or when the accelerator opening degree ACC is zero. Herein, when the accelerator operating speed ΔTAACC is equal to or lower than the predetermined value or when the accelerator opening degree ACC is zero, the ECU 50 determines that the deceleration operation request is continued and thus commands the EGR valve 18 to fully close at the maximum valve closing speed ΔEGRcl. Accordingly, when the deceleration operation request is continued, the EGR valve 18 is caused to close toward the fully closed position at a maximum speed. During the deceleration operation of the engine 1, when the accelerator operating speed ΔTAACC is small or when the accelerator opening degree ACC is zero, it is considered that the deceleration operation request is strongest, the EGR valve 18 can be fully closed most rapidly, thereby most quickly cutting EGR.

According to the present embodiment, furthermore, the deceleration operation request to the engine 1 is determinately made strongest when the brake pedal 36 is depressed. Herein, the ECU 50 judges from the detection result of the brake sensor 28 that the brake pedal 36 has been depressed, the EGR valve 18 is caused to close toward the fully closed position at the maximum valve closing speed ΔEGRcl. Thus, when the deceleration operation request is determinately strongest, the EGR valve 18 is closed toward the fully closed position at the maximum speed. When the brake pedal 36 is depressed, it is considered that the deceleration operation request is determinately strongest, the EGR valve 18 can be fully closed most rapidly, thereby most quickly cutting EGR.

### Fourth Embodiment

A fourth embodiment of a supercharger-equipped engine embodying an exhaust gas recirculation apparatus for an engine according to the present invention will now be given referring to the accompanying drawings.

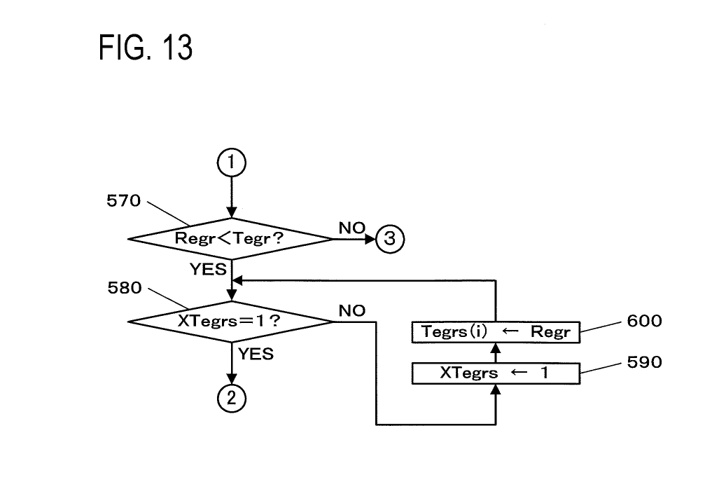

The fourth embodiment differs from the first embodiment in the processing details of EGR control. FIGS. 12 and 13 are flowcharts showing one example of the processing details of EGR control of the present embodiment. In the flowcharts of FIGS. 12 and 13, differently from the flowchart of FIG. 3, the processings in Steps 500 to 640 are added between Steps 150 and 160, and the processings in Steps 650 and 660 are added after Step 190 of the flowchart of FIG. 3.

Specifically, when the processing shifts to this routine and the determination results in Steps 110, 120, and 130 are all affirmative and further the processing shifts from Step 150 to Step 500, the ECU 50 takes in an actual opening degree Regr of the EGR valve 18.

In Step 510, the ECU 50 then determines whether or not a slow valve opening control determination flag XRegr is “0” at the time of EGR return. This flag XRegr is set to “0” to subject the EGR valve 18 to slow valve opening control and set to “1” not to subject the EGR valve 18 to the slow valve opening control. This slow valve opening control of the EGR valve 18 means controlling the EGR valve 18 to slowly open toward a target opening degree Tegr which will be explained later. When the EGR valve 18 is subjected to the slow valve opening control, a determination result in Step 510 is affirmative and the ECU 50 shifts the processing to Step 520.

In Step 520, the ECU 50 determines whether or not EGR is returned from the state where the actual opening degree Regr is “0”. Herein, if the EGR valve 18 is to be opened from the fully closed state after start of the engine 1, the determination result in Step 520 is affirmative and the ECU 50 shifts the processing to Step 530.

In Step 530, the ECU 50 determines whether or not the actual opening degree Regr is smaller than the target opening degree Tegr. When the EGR valve 18 is to be opened from the fully closed state to the target opening degree Tegr, the determination result in Step 530 is affirmative and the ECU 50 shifts the processing to Step 540.

In Step 540, the ECU 50 determines whether or not an initial setting flag XTegrs is “1” at the time of EGR return. This initial setting flag XTegrs is set to “0” when an initial target opening degree Tegrs(i) of the EGR valve 18 is to be initialized or the flag XTegrs is set to “1” when the initializing is completed and the initial target opening degree Tegrs(i) is no longer initialized. The initial target opening degree Tegrs(i) of the EGR valve 18 means the target opening degree of the EGR valve 18 to be set when the EGR valve 18 is in a fully closed state as will be mentioned later.

If NO in Step 540, that is, if the initial target opening degree Tegrs(i) is initialized, the ECU 50 sets the initial setting flag XTegrs to “1” in Step 630 and sets the initial target opening degree Tegrs(i) to “0” in Step 640, and returns to the processing in Step 540. In this case, the determination result in Step 540 is affirmative and thus the ECU 50 shifts the processing to Step 550.

In Step 550, the ECU 50 calculates the initial target opening degree Tegrs(i), that is, calculates a current initial target opening degree Tegrs(i) by adding a predetermined value α to a previous initial target opening degree Tegrs(i−1). Herein, the predetermined value α can be set different in size between the EGR return from a small opening degree and the EGR return from a large opening degree.

In Step 560, the ECU 50 then sets the initial target opening degree Tegrs(i) as the target opening degree Tegr. In Step 160, the ECU 50 controls the EGR valve 18 based on the initial target opening degree Tegrs(i) replacing the target opening degree Tegr, and returns the processing to Step 100. Specifically, the ECU 50 executes the slow valve opening control of the EGR valve 18 from the fully closed state.

If NO in Step 510, on the other hand, that is, if the slow valve opening control is not executed, the ECU 50 directly shifts the processing to Step 160 and controls the EGR valve 18 based on the target opening degree Tegr calculated in Step 150. In this case, the EGR valve 18 is not subjected to the slow valve opening control and is caused to rapidly open toward the target opening degree Tegr.

If No in Step 520, the ECU 50 shifts the processing to Step 570 and determines whether or not the actual opening degree Regr is smaller than the target opening degree Tegr. When the EGR valve 18 is to be opened from the fully closed state to the target opening degree Tegr, the determination result in Step 570 is affirmative, and the ECU 50 shifts the processing to Step 580.

In Step 580, the ECU 50 determines whether or not the initial setting flag XTegrs is “1” at the time of EGR return. If NO in Step 580, that is, if the initial target opening degree Tegrs(i) is initialized, the ECU 50 sets the initial setting flag XTegrs to “1” in Step 590, sets the actual opening degree Regr as the initial target opening degree Tegrs(i) in Step 600, and returns to the processing in Step 580. In this case, the determination result in Step 580 is affirmative, the ECU 50 shifts the processing to Step 550.

If NO in Step 570, on the other hand, the ECU 50 shifts the processing to Step 610. Moreover, if NO in Step 530, that is, if the actual opening degree Regr reaches the target opening degree Tegr, it means that the slow valve opening control is completed and this control will not be executed thereafter, the ECU 50 shifts the processing to Step 610. The ECU 50 sets the slow valve opening control flag XRegr to “1” in Step 610, sets the actual opening degree Regr as the target opening degree Tegr in Step 620, and then executes the processing in Step 160.

In Step 170 following Step 110, 200, 220, or 130, on the other hand, the ECU 50 issues a forcibly opening command to the EGR valve 18. Then, the ECU 50 sets the EGR cut flag XCEGR to “1” in Step 180 and sets the target opening degree Tegr to “0” in Step 190.

Successively, the ECU 50 sets the slow valve opening control flag XRegr to “0” in Step 650 and sets the initial setting flag XTegrs to “0” in Step 660, and then executes the processing in Step 160.

According to the above controls in the present embodiment, differently from the first embodiment, when the EGR valve 18 is to be opened from the fully closed state toward the target opening degree Tegr, the ECU 50 causes the EGR valve 18 to gradually more slowly open than when the EGR valve 18 is to be opened from a middle opening degree larger than a small opening degree.

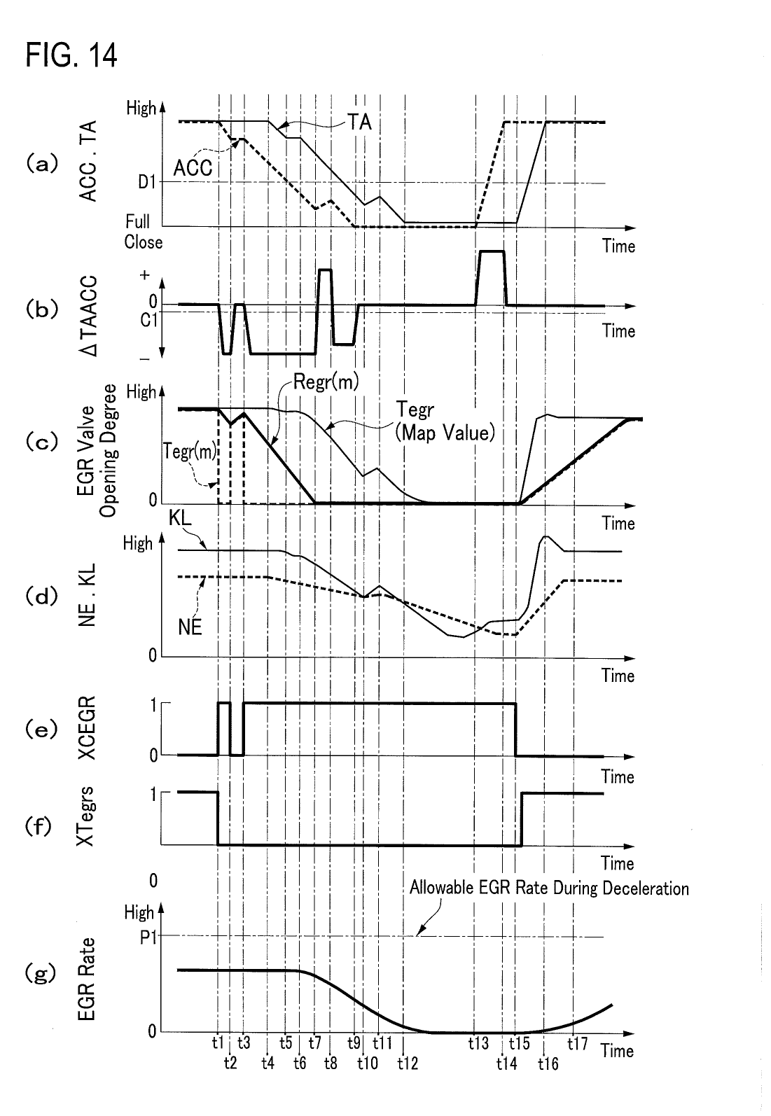

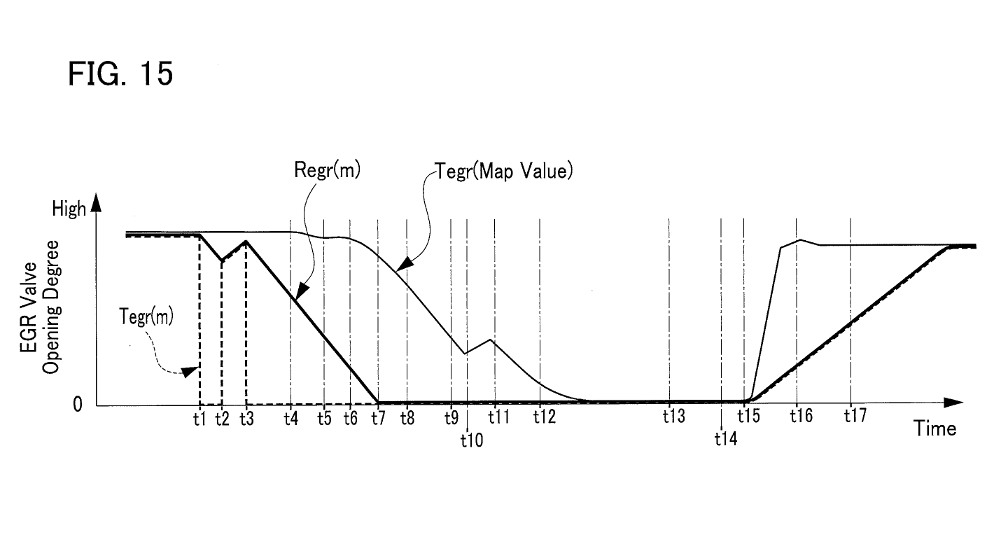

Herein, FIG. 14 is a time chart showing one example of behaviors of various parameters related to the above control, including (a) accelerator opening degree ACC and throttle opening degree TA, (b) accelerator operating speed ΔTAACC, (c) EGR valve opening degree, (d) engine rotation speed NE and engine load KL, (e) EGR cut flag XCEGR, and (f) initial setting flag XTegrs, and (g) EGR rate. FIG. 15 is an enlarged time chart showing behaviors of the EGR valve opening degree in FIG. 14(c). In this time chart, the behaviors of various parameters excepting the initial setting flag XTegrs between time t1 and t2 and between time t4 and t12 are the same as those in FIG. 5. The characteristics in this time chart are in the behaviors of various parameters between time t2 and t3 and between time t13 and t17. When the accelerator opening degree ACC increases between time t13 and t14 as indicated by a thick broken line in FIG. 14(a), the accelerator operating speed ΔTAACC increases up to a positive value once between time t13 and t14 as shown in FIG. 14(b).

Subsequently, when the throttle opening degree TA increases between time t15 and t16 as indicated by a solid line in FIG. 14(a), the engine rotation speed NE and the engine load KL increase as shown in FIG. 14(d). In association with this, the EGR cut flag XCEGR returns to “0” at time t15 as shown in FIG. 14(e), and immediately afterwards, the initial setting flag XTegrs becomes “1”. As shown in FIG. 14(c) and FIG. 15, the target opening degree Tegr (a map value) of the EGR valve 18 sharply increases, whereas the actual opening degree Regr(m) gradually slowly increases. This results from that when the EGR valve 18 is to be opened from the fully closed state toward the target opening degree Tegr, the ECU 50 sets the initial target opening degree Tegrs(i) to command the EGR valve 18 to gradually slowly open. As a result, as shown in FIG. 14(g), the EGR rate slowly increases from time t15 through t17.

When the accelerator opening degree ACC becomes constant between time t2 and t3 as indicated by the thick broken line in FIG. 14(a), the accelerator operating speed ΔTAACC increases to “0” once between time t2 and t3 as shown in FIG. 14(b), and the EGR cut flag XCEGR returns to “0” as shown in FIG. 14(e). Further, as shown in FIGS. 14(c) and 15, the target opening degree Tegr (a map value) of the EGR valve 18 is constant, but the actual opening degree Regr(m) starts to gradually slowly increase. This results from that, when the request is returned to a steady operation request while the EGR valve 18 is being closed toward the fully closed position, the ECU 50 sets the initial target opening degree Tegrs(i) to command the EGR valve 18 to slowly gradually open.

According to the exhaust gas recirculation apparatus for an engine in the present embodiment explained above, it can provide the following operations and advantages in addition to the operations and advantages in the first embodiment. Specifically, in general, when the EGR is to be restarted from an EGR cut state, it is preferable to gradually increase an amount of EGR gas to be supplied to the combustion chamber 16 without abruptly increasing EGR gas. Herein, when the ECU 50 causes the EGR valve 18 to open from the fully closed position toward the target opening degree Tegr, the EGR valve 18 is allowed to more slowly gradually open from a middle open position larger than a small opening degree, thus slowly gradually increasing an amount of EGR gas to be supplied to the combustion chamber 16. Therefore, the EGR gas can be made to slowly act on combustion in the engine 1. This can prevent deterioration in exhaust emission of the engine 1 and driveability of the vehicle 70.

### Fifth Embodiment

A fifth embodiment of a supercharger-equipped engine embodying an exhaust gas recirculation apparatus for an engine according to the present invention will now be given referring to the accompanying drawings.

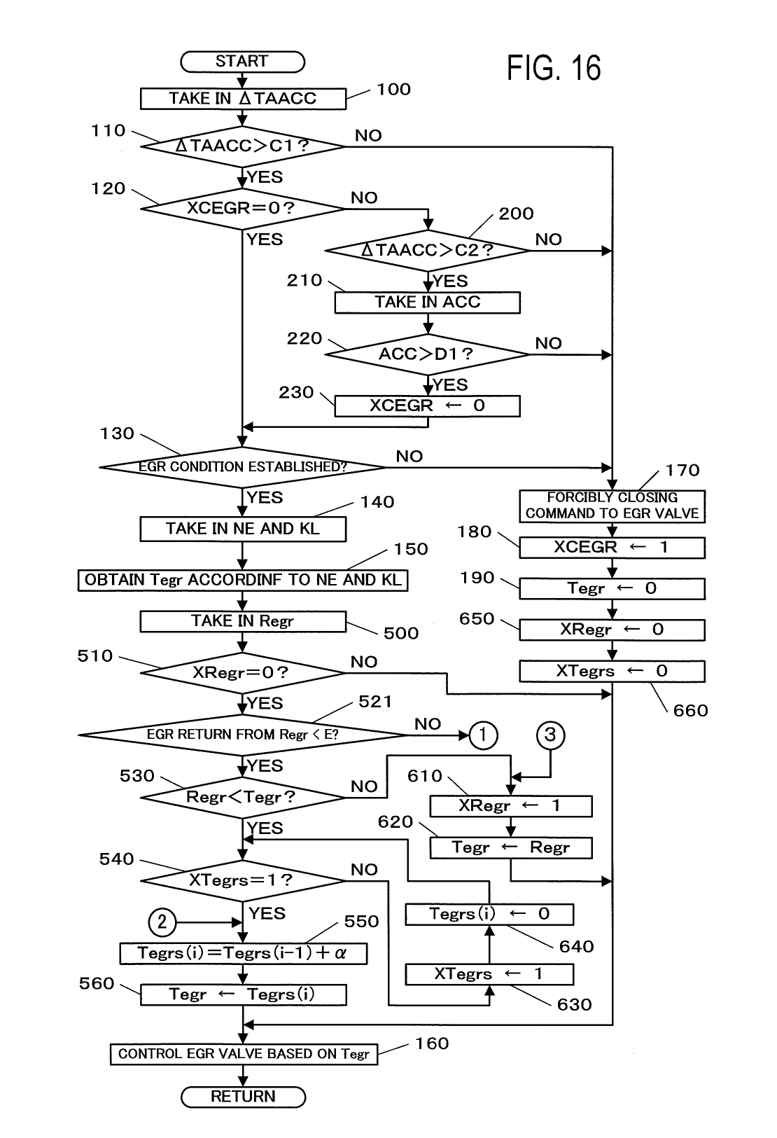

The fifth embodiment differs from the fourth embodiment in the processing details of EGR control. FIG. 16 is a flowchart showing one example of the processing details of the EGR control of the present embodiment. In the fourth embodiment, in Step 520 of the flowchart shown in FIG. 12, it is determined whether or not the EGR return is made from the state where the actual opening degree Regr is “0”. In the fifth embodiment, on the other hand, as shown in Step 521 of the flowchart shown in FIG. 16, it is determined whether or not EGR return is made from a state where the actual opening degree Regr is smaller than a predetermined small opening degree E (which is smaller than the “middle opening degree” of the invention”). In this case, the same operations and advantages as those in the fourth embodiment can be obtained.

### Sixth Embodiment

A sixth embodiment of a supercharger-equipped engine embodying an exhaust gas recirculation apparatus for an engine according to the present invention will now be given referring to the accompanying drawings.

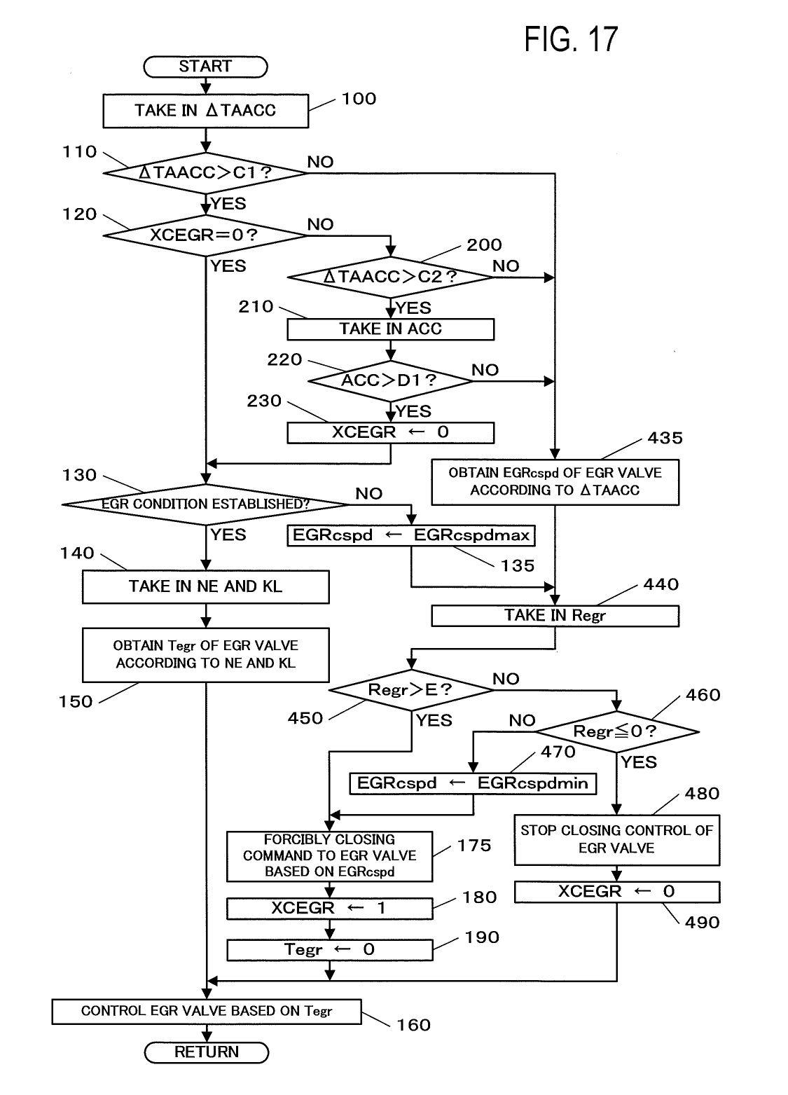

The sixth embodiment differs from the first embodiment in the processing details of EGR control. FIG. 17 is a flowchart showing one example of the processing details of the EGR control of the present embodiment. The flowchart of FIG. 17 differs from the flowchart of FIG. 3 in that the processings in Steps 135, 175, 435 to 490 are added to the flowchart of FIG. 3.

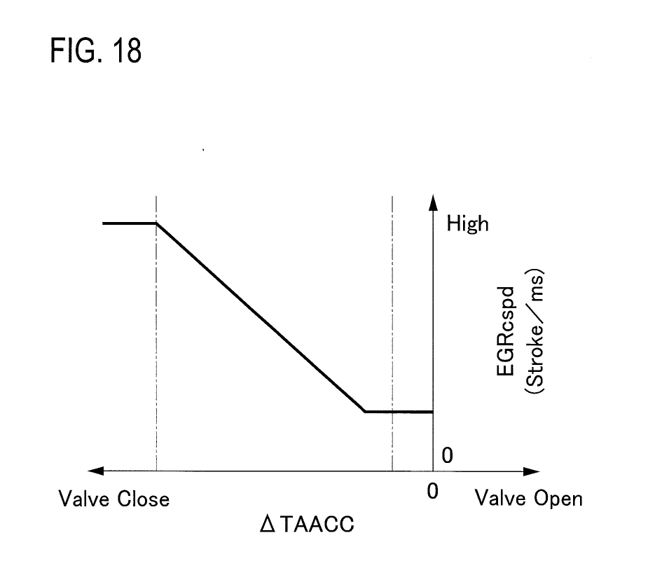

Specifically, in this routine, if NO in Step 110, 200, or 220, the ECU 50 calculates, in Step 435, a valve closing speed EGRcspd of the EGR valve 18 according to the accelerator operating speed ΔTAACC. The ECU 50 can obtains this valve closing speed EGRcspd by referring to a valve closing speed map as shown in FIG. 18 for example. The map in FIG. 18 is set such that, as the accelerator operating speed ΔTAACC is smaller in negative value, i.e., larger in absolute value, the valve closing speed EGRcspd of the EGR valve 18 is higher between a lower limit and an upper limit.

In Step 440, the ECU 50 takes in an actual opening degree Regr of the EGR valve 18. The ECU 50 then determines in Step 450 whether or not the actual opening degree Regr is larger than a predetermined small opening degree E. Herein, this predetermined small opening degree E can be assumed as an opening degree just close to a fully closed position of the EGR valve 18 for example. If YES in Step 450, the ECU 50 shifts the processing to Step 175. If NO in Step 450, the ECU 50 shifts the processing to Step 460.

In Step 175, the ECU 50 commands forcible closing to the EGR valve 18 based on the valve closing speed EGRcspd. Thereafter, the processings in Steps 180, 190, and 160 are executed.

In Step 460, on the other hand, the ECU 50 determines whether or not the actual opening degree Regr is equal to or less than “0”. If NO in Step 460, that is, if the EGR valve 18 is in an open state, the ECU 50 shifts the processing to Step 470. If YES in Step 460, that is, if the EGR valve 18 is in a closed state, the ECU 50 shifts the processing to Step 480.

In Step 470, the ECU 50 sets a predetermined minimum valve closing speed EGRcspdmin as the valve closing speed EGRcspd and shifts the processing to Step 175.

In Step 480, on the other hand, the ECU 50 stops the valve closing control of the EGR valve 18. In Step 490, the ECU 50 then sets the EGR cut flag XCEGR to “0” and shifts the processing to Step 160.

If the EGR ON condition is not established in Step 130, the ECU 50 sets, in Step 135, a predetermined maximum valve closing speed EGRcspdmax as the valve closing speed EGRcspd. The ECU 50 then shifts the processing to Step 440.

According to the above control in the present embodiment, differently from the first embodiment, the ECU 50 sets a fully closing command condition for commanding the EGR valve 18 to fully close, according to the accelerator operating speed ΔTAACC. To be concrete, when the ECU 50 issues the fully closing command to the EGR valve 18, the ECU 50 causes the EGR valve 18 to close based on the valve closing speed EGRcspd and also sets the valve closing speed EGRcspd according to the accelerator operating speed ΔTAACC. The ECU 50 further sets the valve closing speed EGRcspd to the predetermined minimum value EGRcspdmin when the actual opening degree Regr of the EGR valve 18 detected in the course of bringing the EGR valve 18 to a fully closed position becomes equal to or less than the predetermined value E.

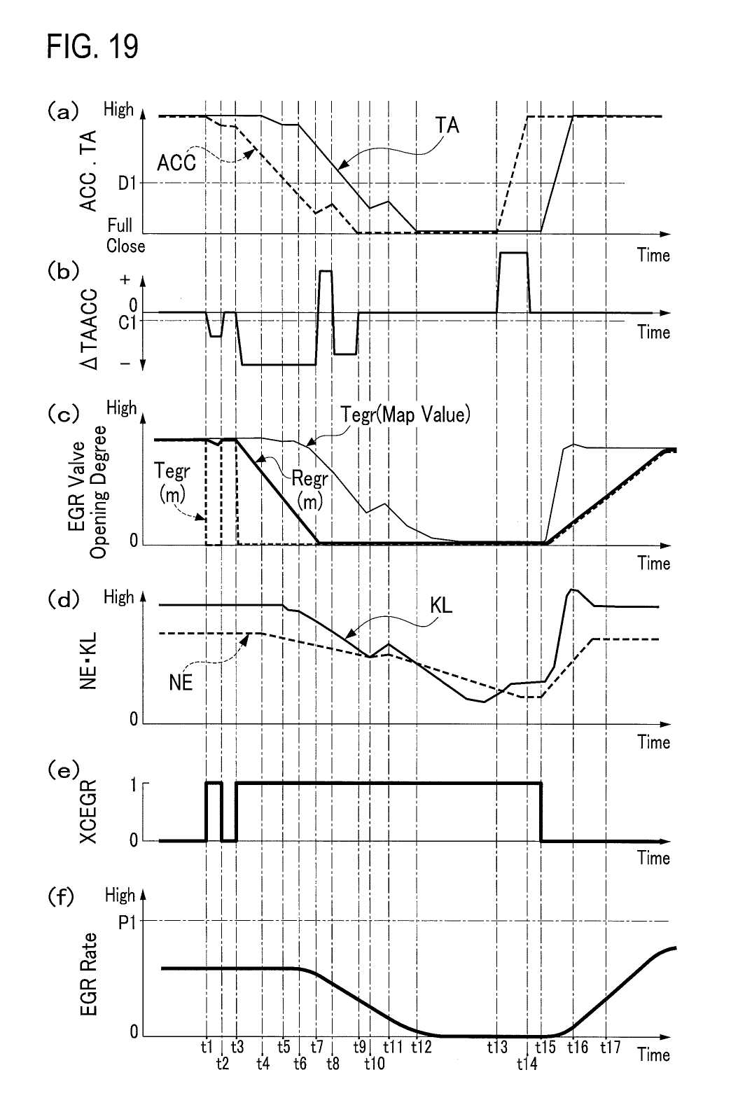

Herein, FIG. 19 is a time chart showing one example of behaviors of various parameters related to the above control, including (a) accelerator opening degree ACC and throttle opening degree TA, (b) accelerator operating speed ΔTAACC, (c) EGR valve opening degree, (d) engine rotation speed NE and engine load KL, (e) EGR cut flag XCEGR, and (f) EGR rate. In this time chart, the behaviors of various parameters excepting the initial setting flag XTegrs are nearly the same as those in FIG. 14. The characteristics of this time chart different from the time chart of FIG. 14 are in that the behaviors of various parameters between time t1 and t4. Specifically, when the accelerator opening degree ACC starts to slightly decrease at time t1 as indicated by a thick broken line in FIG. 19(a), the accelerator operating speed ΔTAACC decreases to a negative value smaller than the first deceleration determination value C1 as shown in FIG. 19(b). Thus, as shown in FIG. 19(e), the EGR cut flag XCEGR is changed from “0” to “1”, and the target opening degree Tegr(m) of the EGR valve 18 instantly becomes “0” as indicated by a thick broken line in FIG. 19(c), and the actual opening degree Regr(m) of the EGR valve 18 starts to decrease as indicated by a thick solid line in FIG. 19(c). In FIG. 19(c), the target opening degree Tegr(m) indicated by the thick broken line represents a value calculated during deceleration operation, and the target opening degree Tegr (a map value) indicated by a solid line represents the map value obtainable by referring to a target opening degree map.

Subsequently, as shown in FIG. 19(a), between time t2 and t4, when the accelerator opening degree ACC stops decreasing once and changes to decrease again, the accelerator operating speed ΔTAACC rises to “0” once and returns again to a negative value smaller than the first deceleration determination value C1 as shown in FIG. 19(b). Thus, as shown in FIG. 19(e), the EGR cut flag XCEGR changes to “0” once and then returns to “1” again. Further, as shown in FIG. 19(c), the target opening degree Tegr(m) instantly becomes a predetermined valve opening value and returns to “0” again. Furthermore, as indicated by the thick solid line in FIG. 19(c), the actual opening degree Regr(m) increases once and then changes to decrease again and becomes “0” at time t7, i.e., reaches full close.

Herein, as shown in FIG. 19(a), between time t1 and t2, even if the accelerator opening degree ACC somewhat varies in the course of decreasing toward full close and the accelerator operating speed ΔTAACC becomes a negative value once and then becomes “0” or somewhat changes to a positive value, unless it continues to be “0” or the positive value, the target opening degree Tegr(m) of the EGR valve 18 is returned to “0”, and the actual opening degree Regr(m) continues to decrease toward “0”. Accordingly, the EGR rate remains constant below the allowable EGR rate P1 during deceleration and then gradually decreases.

Furthermore, when the accelerator operating speed ΔTAACC between time t1 and t2 is relatively slow as shown in FIG. 19(b), the actual opening degree Regr(m) of the EGR valve 18 relatively slowly changes, that is, the valve closing speed EGRcspd of the EGR valve 18 becomes relatively slow as shown in FIG. 19(c). On the other hand, when the accelerator operating speed ΔTAACC between time t3 and t7 is relatively rapid as shown in FIG. 19(b), the actual opening degree Regr(m) of the EGR valve 18 relatively sharply changes, that is, the valve closing speed EGRcspd of the EGR valve 18 becomes relatively rapid as shown in FIG. 19(c).

According to the exhaust gas recirculation apparatus for an engine in the fifth embodiment explained above, it can provide the following operations and advantages in addition to the operations and advantages in the first embodiment. In general, specifically, the deceleration operation request to the engine 1 tends to become stronger as the accelerator operating speed ΔTAACC is smaller in negative value (larger in absolute value). Herein, when the ECU 50 determines that the deceleration operation is being requested, the ECU 50 sets the valve closing speed EGRcspd according to the accelerator operating speed ΔTAACC. At the set valve closing speed EGRcspd, the EGR valve 18 is caused to close toward the fully closed position. Accordingly, when the deceleration operation is requested and the ECU 50 issues the fully closing command the EGR valve 18, the EGR valve 18 is caused to close toward the fully closed position based on the valve closing speed EGRcspd set according to the strength of the operation request. In other words, for slow deceleration, the EGR valve 18 is closed toward the fully closed position at a slow valve closing speed EGRcspd. For rapid deceleration, the EGR valve 18 is closed toward the fully closed position at a rapid valve closing speed EGRcspd. During deceleration operation of the engine 1, therefore, the EGR valve 18 can be closed toward the fully closed position at appropriate speed according to the strength of deceleration operation, thereby cutting EGR as promptly as possible. In the case where the EGR valve 18 mechanistically having a fast valve closing speed is used, for instance, the EGR valve 18 can be closed at a slow valve closing speed during slow deceleration, so that the EGR valve 18 is not closed more than necessary.

According to the present embodiment, when the actual opening degree Regr becomes the predetermined small opening degree E or lower in the course of bringing the EGR valve 18 toward the fully closed position, the ECU 50 sets the valve closing speed EGRcspd to the minimum valve closing speed EGRcspdmin. Thus, the EGR valve 18 is slowly closed into the fully closed position. This can prevent the valve element 32 from swiftly seating on the valve seat 33 when the EGR valve 18 is fully closed and hence restrain impact and hammering resulting from seating of the valve element 32 on the valve seat 33.

According to the present embodiment, furthermore, if the EGR ON condition is not established, the valve closing speed EGRscpd is set to a maximum valve closing speed EGRcspdmax and the EGR valve 18 is caused to close toward the fully closed position at the maximum valve closing speed EGRcspdmax. If the EGR ON condition is not established, therefore, the EGR valve 18 can be fully closed at a maximum speed to promptly cut EGR.

### Seventh Embodiment

A seventh embodiment of a supercharger-equipped engine embodying an exhaust gas recirculation apparatus for an engine according to the present invention will now be given referring to the accompanying drawings.

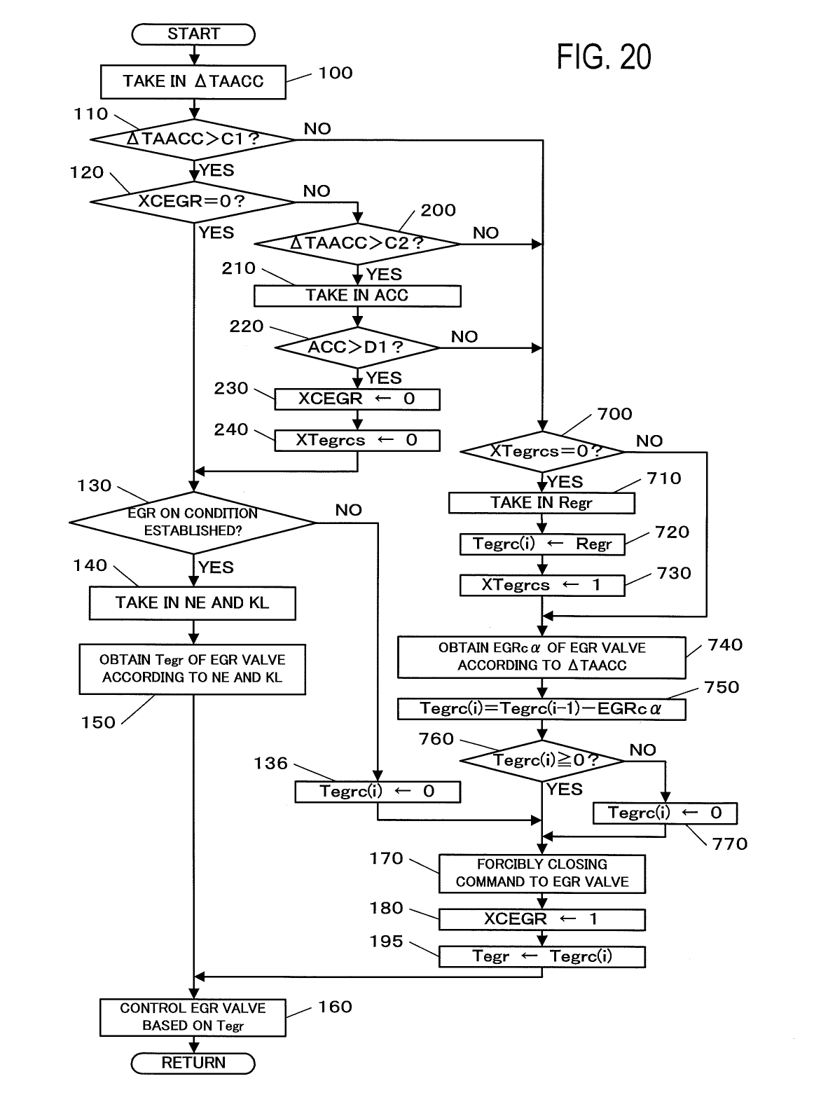

The seventh embodiment differs from the first embodiment in the processing details of EGR control. FIG. 20 is a flowchart showing one example of the processing details of the EGR control of the present embodiment. The flowchart of FIG. 20 differs from the flowchart of FIG. 3 in that the processings in Steps 136, 240, and 700 to 770 are added to the flowchart of FIG. 3.

In this routine, specifically, if NO in Step 110, 200, or 220, the ECU 50 determines in Step 700 whether or not an initial setting flag XTegrcs is “0”, that is, whether or not an initial target opening degree Tegrs(i) of the EGR valve 18 is initialized. If YES in Step 700, the ECU 50 shifts the processing to Step 710. If NO in Step 700, the ECU 50 skips to the processing in Step 740.

In Step 710, the ECU 50 takes in an actual opening degree Regr of the EGR valve 18. In Step 720, the ECU 50 then sets the taken actual opening degree Regr as a target valve-closing opening degree Tegrc(i). In Step 730, the ECU 50 sets the initial setting flag XTegrcs to “1”.

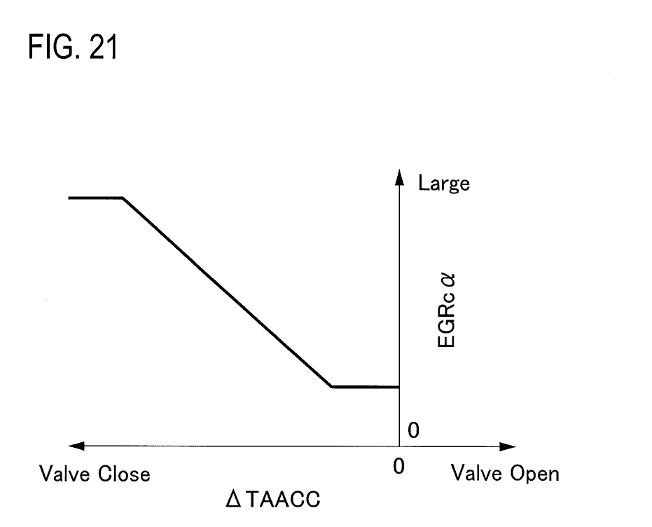

In Step 740 following Step 700 or 730, the ECU 50 obtains a target attenuation value EGRcα of the EGR valve 18 according to the accelerator operating speed ΔTAACC. The ECU 50 can obtain this target attenuation value EGRcα by referring to a target attenuation value map as shown in FIG. 21, for example. The map in FIG. 21 is set such that, as the accelerator operating speed ΔTAACC is smaller, that is, as an absolute value of the accelerator operating speed ΔTAACC is larger, the target attenuation value EGRcα is larger between a lower limit and an upper limit.

In Step 750, successively, the ECU 50 calculates a target valve-closing opening degree Tegrc(i) of the EGR valve 18. Specifically, the ECU 50 subtracts the target attenuation value EGRcα from a previously calculated target valve-closing opening degree Tegrc(i−1) to calculate a current target valve-closing opening degree Tegrc(i).

In Step 760, the ECU 50 determines whether or not the currently calculated target valve-closing opening degree Tegrc(i) is “0” or larger. If YES in Step 760, the ECU 50 shifts the processing to Step 170 and executes the processings in Steps 170, 180, 195, and 160. If NO in Step 760, the ECU 50 shifts the processing to Step 770.

In Step 770, the ECU 50 sets the target valve-closing opening degree Tegrc(i) to “0” and shifts the processing to Step 170, and executes the processings in Steps 170, 180, 195, and 160.

Herein, in Step 195, the ECU 50 sets the currently calculated target valve-closing opening degree Tegrc(i) as the target opening degree Tegr.

In Step 230, the ECU 50 sets the EGR cut flag XCEGR to “0”. In Step 240, subsequently, the ECU 50 sets the initial setting flag XTegrcs to “0” and shifts the processing to Step 130.

If the EGR ON condition is not established in Step 130, the ECU 50 sets the target valve-closing opening degree Tegrc(i) to “0” in Step 136. The ECU 50 then shifts the processing to Step 170 and executes the processings in Steps 170, 180, 195, and 160.

According to the above control of the seventh embodiment, differently from the first embodiment, the ECU 50 sets a fully closing command condition for commanding the EGR valve 18 to fully close, according to the accelerator operating speed ΔTAACC. To be concrete, when the ECU 50 issues a fully closing command to the EGR valve 18, the ECU 50 causes the EGR valve 18 to close based on the target valve-closing opening degree Tegrc(i) and also attenuates the target valve-closing opening degree Tegrc(i) according to transition of the accelerator operating speed ΔTAACC.

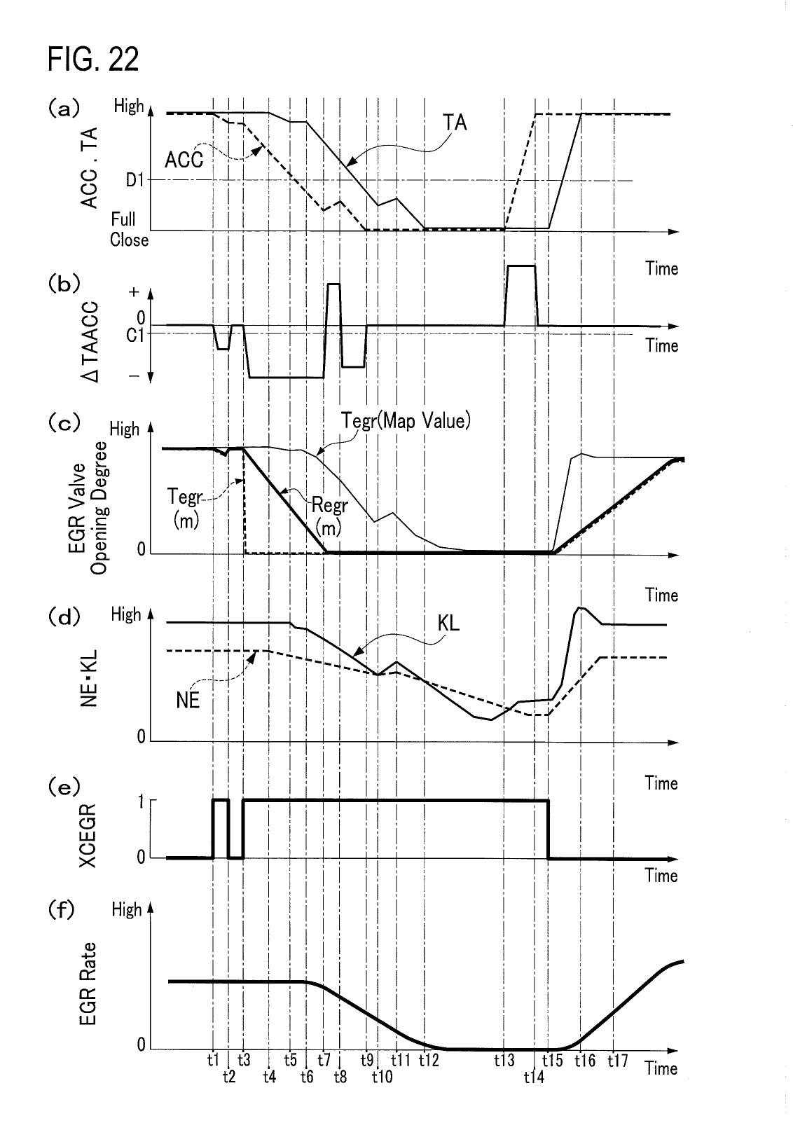

Herein, FIG. 22 is a time chart showing one example of behaviors of various parameters related to the above control, including (a) accelerator opening degree ACC and throttle opening degree TA, (b) accelerator operating speed ΔTAACC, (c) EGR valve opening degree, (d) engine rotation speed NE and engine load KL, (e) EGR cut flag XCEGR, and (f) EGR rate. This time chart is different from the time chart of FIG. 19 in the following points. To be specific, when the accelerator opening degree ACC starts to slightly decrease at time t1 as indicated by a thick broken line in FIG. 22(a), the accelerator operating speed ΔTAACC decreases to a smaller negative value than a first deceleration determination value C1 as shown in FIG. 22(b). Accordingly, the EGR cut flag XCEGR is changed from “0” to “1” as shown in FIG. 22(e), the target valve-closing opening degree Tegrc(i) of the EGR valve 18 starts to decrease as indicated by a thick broken line in FIG. 22(c) and the actual opening degree Regr(m) starts to decrease as indicated by a thick solid line in FIG. 22(c).

Thereafter, between time t2 and t4, when the accelerator opening degree ACC stops decreasing once and then changes to decrease again as shown in FIG. 22(a), the accelerator operating speed ΔTAACC rises to “0” once and then returns to a smaller negative value than the first deceleration determination value C1 again as shown in FIG. 22(b). Accordingly, as shown in FIG. 22(e), the EGR cut flag XCEGR is changed to “0” once and then returns to “1” again. The target valve-closing opening degree Tegrc(i) becomes a predetermined value once and then “0” as indicated by the thick broken line in FIG. 22(c). Furthermore, the actual opening degree Regr(m) increases once and changes to decrease down to “0” at time t7, i.e., full close, as indicated by the thick solid line in FIG. 22(c).

Herein, when the accelerator operating speed ΔTAACC between time t1 and t2 is relatively slow as shown in FIG. 22(b), the target valve-closing opening degree Tegrc(i) is relatively less attenuated as indicated by the thick broken line in FIG. 22(c). When the accelerator operating speed ΔTAACC between time t3 and t4 is relatively rapid as shown in FIG. 22(b), the target valve-closing opening degree Tegrc(i) is relatively more attenuated as indicated by a thick broken line in FIG. 22(c)

According to the exhaust gas recirculation apparatus for an engine in the seventh embodiment explained above, it can provide the following operations and advantages in addition to the operations and advantages in the first embodiment. In general, the transition of the accelerator operating speed ΔTAACC is initially large and becomes smaller with time. When the ECU 50 issues the fully closing command to the EGR valve 18, therefore, the target valve-closing opening degree Tegrc(i) is largely attenuated first and then less attenuated with time. Thus, when the EGR valve 18 is to be closed toward the fully closed position, the EGR valve 18 is caused to close more slowly with time. This makes it possible to close the EGR valve 18 toward the fully closed position at an appropriate speed according to the transition of strength of the deceleration operation request to the engine 1, and thereby cut EGR.

### Eighth Embodiment

An eighth embodiment of a supercharger-equipped engine embodying an exhaust gas recirculation apparatus for an engine according to the present invention will now be given referring to the accompanying drawings.

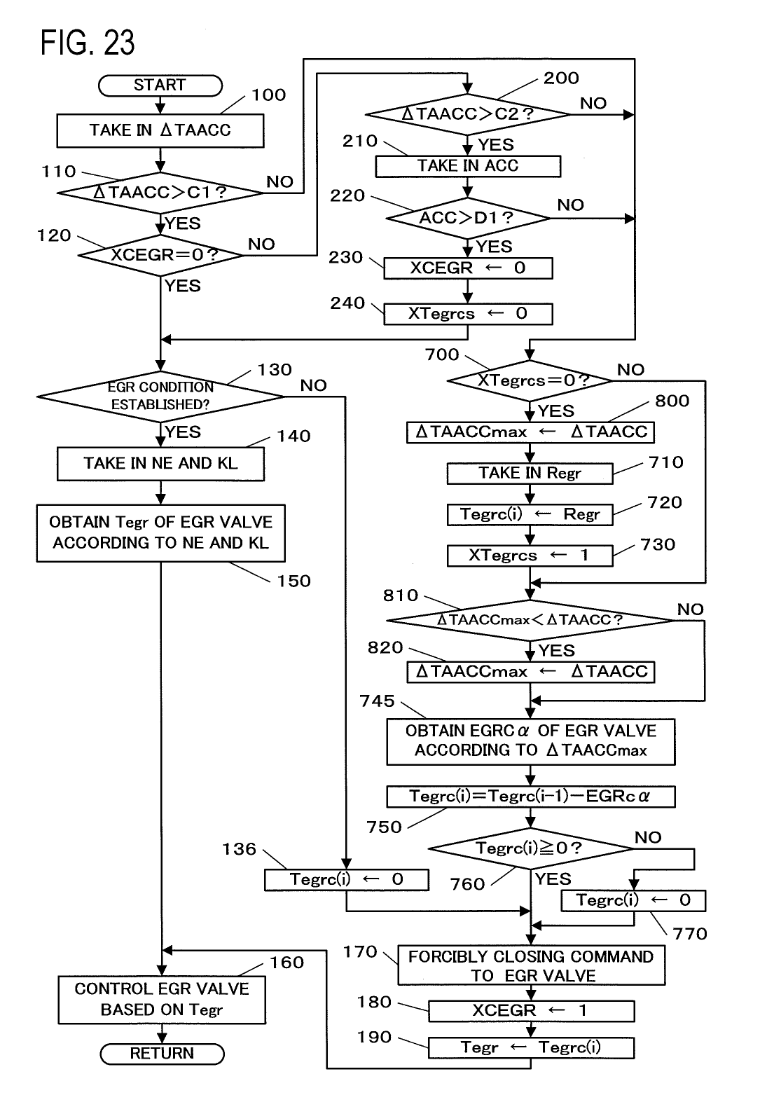

The eighth embodiment differs from the seventh embodiment in the processing details of EGR control. FIG. 23 is a flowchart showing one example of the processing details of the EGR control of the present embodiment. The flowchart of FIG. 23 differs from the flowchart of FIG. 20 in that the processings in Steps 745, and 800 to 820 are added to the flowchart of FIG. 20.

In this routine, specifically, if NO in Step 700, the ECU 50 skips to the processing in Step 810. If YES in Step 700, on the other hand, the ECU 50 sets the accelerator operating speed ΔTAACC as a maximum accelerator operating speed ΔTAACCmax in Step 800. The ECU 50 then executes the processings in Steps 710 to 730.

In Step 810 following Step 700 or 730, the ECU 50 determines whether or not the maximum accelerator operating speed ΔTAACCmax is smaller than the accelerator operating speed ΔTAACC, i.e., whether or not ΔTAACCmax is larger in absolute value than ΔTAACC. If NO in Step 810, the ECU 50 skips to the processing in Step 745. If YES in Step 810, the ECU 50 sets the accelerator operating speed ΔTAACC as the maximum accelerator operating speed ΔTAACCmax in Step 820. Thereafter, the ECU 50 shifts the processing to Step 745.

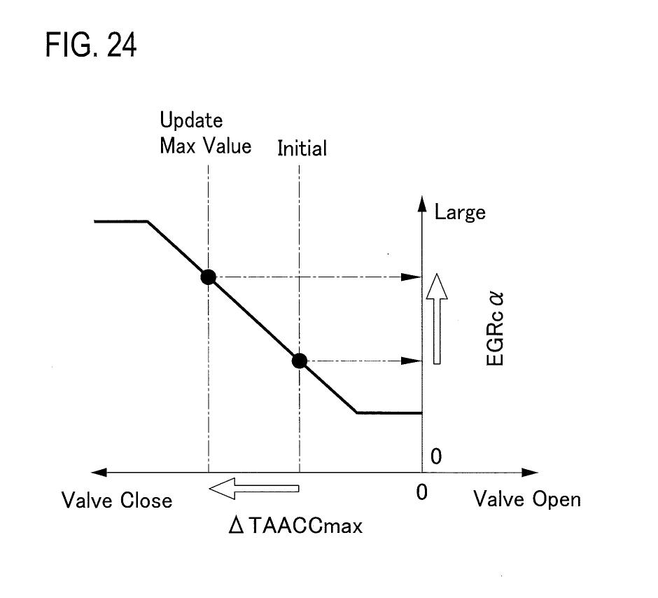

In Step 745 following Step 810 or 820, the ECU 50 obtains the target attenuation value EGRcα of the EGR valve 18 according to the maximum accelerator operating speed ΔTAACCmax. The ECU 50 can this target attenuation value EGRcα by referring to a target attenuation value map as shown in FIG. 24 for example. The map in FIG. 24 is set such that, as the maximum accelerator operating speed ΔTAACCmax is smaller, that is, as the absolute value of the maximum accelerator operating speed ΔTAACCmax is larger, the target attenuation value EGRcα is larger between a lower limit and an upper limit. Herein, the maximum accelerator operating speed ΔTAACCmax is updated at each processing cycle in Step 820, so that the target attenuation value EGRcα obtained from the map in FIG. 24 is also updated. The ECU 50 then shifts the processing to Step 750.

According to the exhaust gas recirculation apparatus for an engine in the present embodiment explained above, it can provide the following operations and advantages different from those in the seventh embodiment. When the ECU 50 issues the fully closing command to the EGR valve 18, the ECU 50 sets the target attenuation value EGRcα according to the maximum accelerator operating speed ΔTAACCmax which is updated as needed, and the target valve-closing opening degree Tegrc(i) is obtained from the set target attenuation value EGRcα. Accordingly, the EGR valve 18 is commanded to forcibly fully close based on the target valve-closing opening degree Tegrc(i). Thus, the EGR valve 18 is caused to close toward the fully closed position at the valve closing speed according to the maximum accelerator operating speed ΔTAACCmax. This makes it possible to close the EGR valve 18 toward the fully closed position at an appropriate speed according to the transition of strength of the deceleration operation request to the engine 1 and cut EGR.

In the present embodiment, furthermore, even when the operation request is changed from rapid deceleration to slow deceleration while the deceleration operation request is being made to the engine 1, the target attenuation value EGRcα obtained at the maximum accelerator operating speed ΔTAACCmax during rapid deceleration is maintained. Thus, the target valve-closing opening degree Tegrc(i) is kept unchanged from that during rapid deceleration. Accordingly, even when the rapid deceleration is changed to the slow deceleration in the course of the rapid deceleration of the engine 1, the EGR valve 18 is caused to close toward the fully closed position at the speed unchanged from that in the rapid deceleration. Consequently, even when the engine 1 is changed from rapid deceleration to slow deceleration, it is possible to promptly cut EGR at the same speed as in rapid deceleration.

### Ninth Embodiment

A ninth embodiment of a supercharger-equipped engine embodying an exhaust gas recirculation apparatus for an engine according to the present invention will now be given referring to the accompanying drawings.

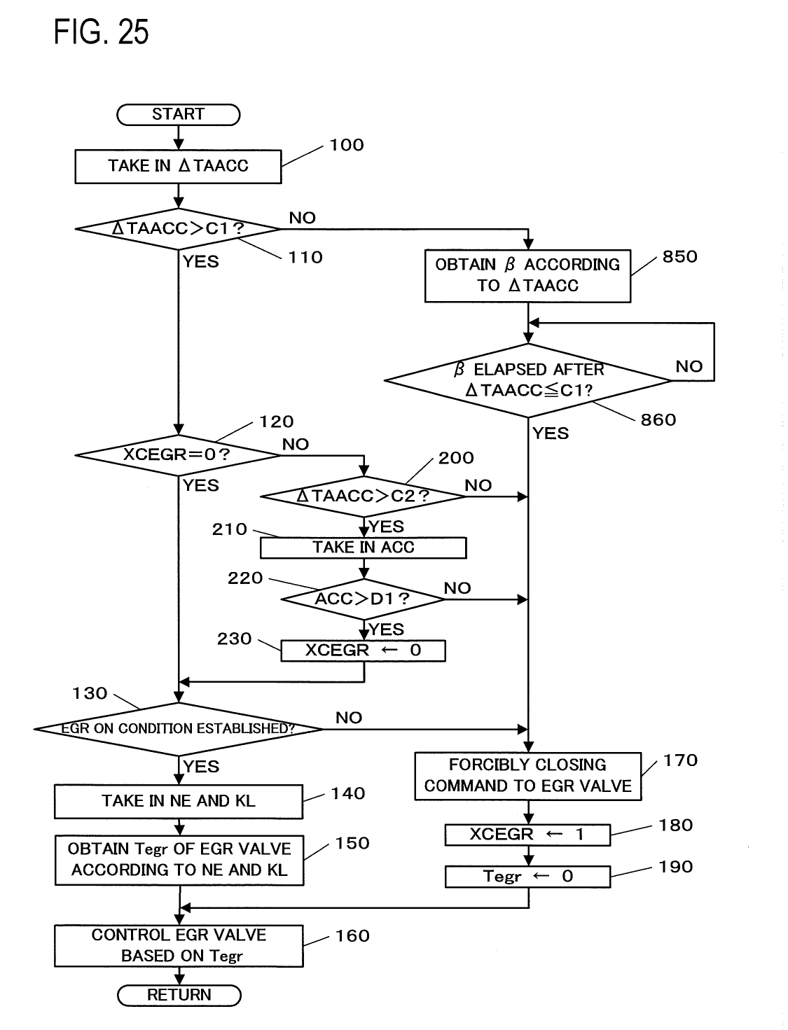

The ninth embodiment differs from the first embodiment in the processing details of EGR control. FIG. 25 is a flowchart showing one example of the processing details of the EGR control of the present embodiment. The flowchart of FIG. 25 differs from the flowchart of FIG. 3 in that the processings in Steps 850 and 860 are added to the flowchart of FIG. 3.

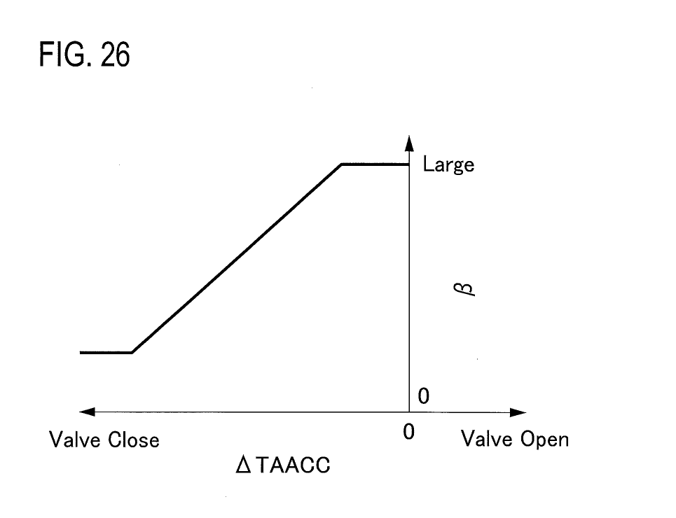

In this routine, specifically, if NO in Step 110, the ECU 50 obtains a delay time β according to the accelerator operating speed ΔTAACC in Step 850. This delay time β means the time to delay the start of closing the EGR valve 18. The ECU 50 can obtain this delay time β by referring to a delay time map as shown in FIG. 26 for example. The map in FIG. 26 is set such that, as the accelerator operating speed ΔTAACC is smaller in negative value, i.e., larger in absolute value, the delay time β is smaller between an upper limit and a lower limit.

In Step 860, the ECU 50 waits for a lapse of the delay time β after the accelerator operating speed ΔTAACC decreases to the first deceleration determination value C1 or lower, and then shifts the processing to Step 170 and executes the processings in Steps 170 to 190 and 160.

According to the above control of the ninth embodiment, different from the first embodiment, the ECU 50 sets a fully closing command condition for commanding the EGR valve 18 to fully close, according to the accelerator operating speed ΔTAACC. To be specific, when the ECU 50 issues the fully closing command to the EGR valve 18, the ECU 50 delays the start of fully closing the EGR valve 18 by the delay time β and also sets the delay time β according to the accelerator operating speed ΔTAACC (a negative change amount).

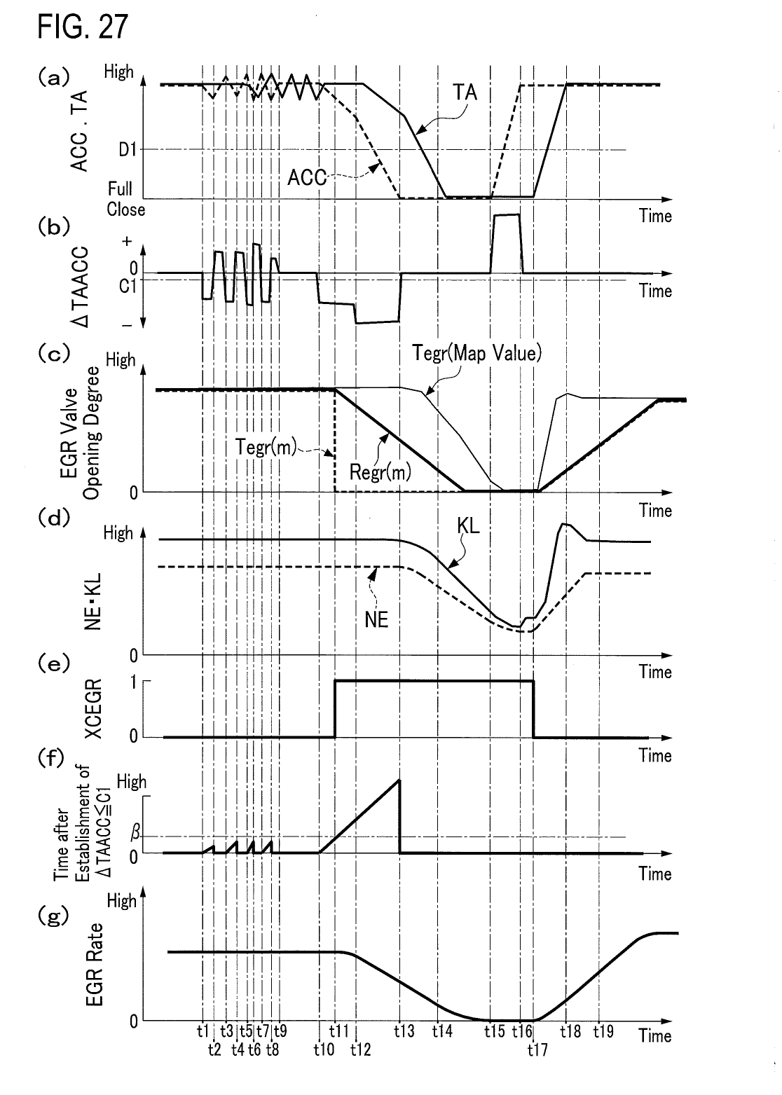

Herein, FIG. 27 is a time chart showing one example of behaviors of various parameters related to the above control, including (a) accelerator opening degree ACC and throttle opening degree TA, (b) accelerator operating speed ΔTAACC, (c) EGR valve opening degree, (d) engine rotation speed NE and engine load KL, (e) EGR cut flag XCEGR, (f) the time after establishment of ΔTAACC≦C1, and (g) EGR rate. When the accelerator opening degree ACC repeatedly slightly increases and decreases between time t1 and t9 as indicated by a thick broken line in FIG. 27(a), the accelerator operating speed ΔTAACC repeatedly varies between negative and positive values as shown in FIG. 27(b). At that time, as shown in FIG. 27(f), “the time after establishment of ΔTAACC≦C1 (hereinafter, referred to as “time after condition establishment”) is counted. However, this time does not exceed the delay time β, so that the EGR cut flag XCEGR remains “0” as shown in FIG. 27(e) and the target opening degree Tegr(m), target opening degree Tegr (a map value), and actual opening degree Regr of the EGR valve 18 are maintained respectively at certain values as shown in FIG. 27(c).

Thereafter, the accelerator opening degree ACC starts to greatly decrease at time t10 as shown in FIG. 27(a). When the accelerator operating speed ΔTAACC decreases below the first deceleration determination value C1 as shown in FIG. 27(b), the time after condition establishment starts to be counted as shown in FIG. 27(f). When the time after condition establishment exceeds the delay time β at time t11 as shown in FIG. 27(f), the EGR cut flag XCEGR is changed from “0” to “1” as shown in FIG. 27(e), and the target opening degree Tegr(m) of the EGR valve 18 drops down to “0” as indicated by a thick broken line in FIG. 27(c).

Thereafter, when the accelerator opening degree ACC becomes a fully closed position at time t13 as shown in FIG. 27(a), the accelerator operating speed ΔTAACC becomes “0” as shown in FIG. 27(b) and the time after condition establishment returns to “0” as shown in FIG. 27(1).

Subsequently, the accelerator opening degree ACC remains at full close between time t13 and t15 as shown in FIG. 27(a), the actual opening degree Regr(m) gradually decreases as indicated by a thick solid like in FIG. 27(c) and the engine rotation speed NE and the engine load KL decrease as shown in FIG. 27(d). Further, in response to a decrease in actual opening degree Regr(m) indicated by the thick solid line in FIG. 27(c), the EGR rate gradually decreases from time t11 as shown in FIG. 27(g).

According to the exhaust gas recirculation apparatus for an engine in the ninth embodiment explained above, it can provide the following operations and advantages in addition to the operations and advantages in the first embodiment. Specifically, when the ECU 50 issues the fully closing command to the EGR valve 18, the ECU 50 delays the start of fully closing the EGR valve 18 by the delay time β and also sets the delay time β according to the strength of the deceleration operation request. Accordingly, even when the deceleration operation request is determined according to unintended operation by a driver and the EGR valve 18 is commanded to fully close, the start of fully closing the EGR valve 18 is delayed by the delay time β according to the strength of the deceleration operation request, so that full closing of the EGR valve 18 is not immediately started incorrectly. For instance, when a vehicle 70 is vibrated due to rough road operation and others, causing unintended accelerator operation by a driver, the accelerator opening degree ACC may vary. In this case, in the present embodiment, the timing to command full closing of the EGR valve 18 is delayed by the delay time β after the deceleration operation request is determined. This can prevent erroneous control of EGR cut due to unintended operation by the driver.

In the present embodiment, the deceleration operation request is determined only when a driver reliably depresses the accelerator pedal 26. Thus, the first deceleration determination value C1 to be compared to the accelerator operating speed ΔTAACC can be set to a relatively small value. Therefore, the sensitivity to determine the deceleration operation request can be enhanced.

In the present embodiment, furthermore, the delay time β according to the accelerator operating speed ΔTAACC is obtained by referring to the map in FIG. 24. Accordingly, as the deceleration operation request is stronger (as the absolute value of the accelerator operating speed ΔTAACC is larger), judging the deceleration operation request can be advanced and starting the EGR cut can be advanced.

### Tenth Embodiment

A tenth embodiment of a supercharger-equipped engine embodying an exhaust gas recirculation apparatus for an engine according to the present invention will now be given referring to the accompanying drawings.

Each of the aforementioned embodiments describe that the EGR valve 18 is forcibly fully closed during deceleration operation of the engine 1 to cut EGR. Herein, during acceleration operation of the engine 1, the back pressure of the engine 1 rises just after acceleration. The EGR valve 18 remaining in the open state may cause the EGR rate to unintentionally rise just after acceleration and hence deteriorate acceleration response of the engine 1. As closing of the EGR valve 18 is delayed just after acceleration, the EGR gas allowed to flow in intake increases and the rate of fresh air is decreased by an amount corresponding to the increase in EGR gas. This may deteriorate acceleration performance of the engine 1. In the tenth to thirteenth embodiments, therefore, the EGR valve 18 is forcibly fully closed to cut EGR in response to the case where the engine 1 is requested for acceleration operation as well as the case where the engine 1 is requested for deceleration operation.

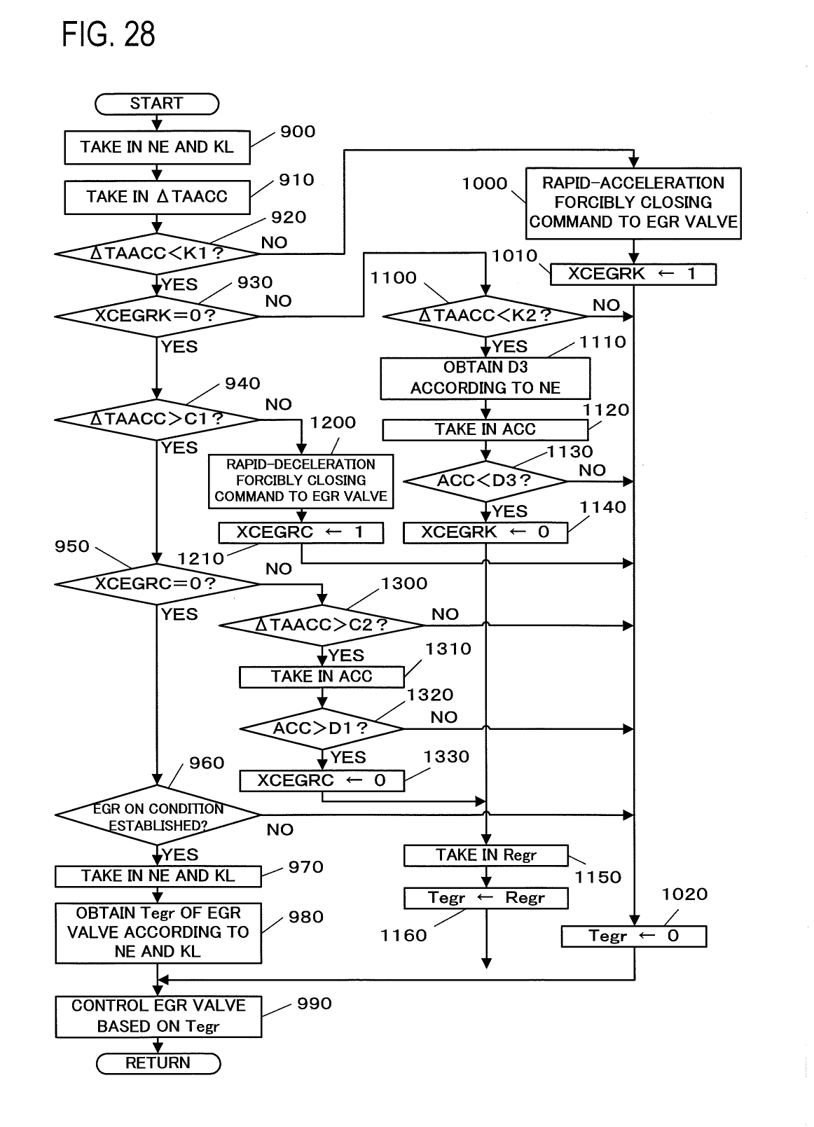

The tenth embodiment differs from the above embodiments in the processing details of EGR control. FIG. 28 is a flowchart showing one example of the processing details of EGR control of the present embodiment.

When the processing shifts to this routine, the ECU 50 first takes in an engine rotation speed NE and an engine load KL in Step 900. In Step 910, the ECU 50 takes in an accelerator operating speed ΔTAACC.

In Step 920, successively, the ECU 50 determines whether or not the accelerator operating speed ΔTAACC is smaller than a predetermined rapid acceleration determination value K1 (a positive value). This rapid acceleration determination value K1 is a threshold to determine that a request for rapid acceleration operation is being made to the engine 1, and this value K1 corresponds to one example of a first determination value during acceleration operation according to the invention. If NO in Step 920, the engine 1 is determined as being requested for rapid acceleration operation, the ECU 50 shifts the processing to Step 1000. If YES in Step 920, the engine 1 is considered as being not requested for rapid acceleration operation, the ECU 50 shifts the processing to Step 930.

In Step 1000, the ECU 50 issues a rapid-acceleration forcibly closing command to the EGR valve 18. Specifically, the ECU 50 commands the EGR valve 18 to forcibly close in response to rapid acceleration operation.

In Step 1010, the ECU 50 then sets an EGR cut flag XCEGRK during acceleration operation to “1”. In Step 1020, the ECU 50 sets a target opening degree Tegr of the EGR valve 18 to “0”.

Thereafter, in Step 990, the ECU 50 controls the EGR valve 18 based on the target opening degree Tegr set to “0”, that is, controls the EGR valve 18 to fully close. Then, the ECU 50 returns the processing to Step 900.

In Step 930, on the other hand, the ECU 50 determines whether or not the EGR cut flag XCEGRK is “0”. This EGR cut flag XCEGRK is set to “1” when the EGR valve 18 is closed during acceleration operation to cut EGR, while it is set to “0” in other cases. If NO in Step 930, determining that EGR is cut, the ECU 50 shifts the processing to Step 1110. If YES in Step 930, the ECU shifts the processing to Step 940.

Even if the determination result in Step 920 is negative (rapid acceleration operation request) once, the accelerator operating speed ΔTAACC may change just after that, thus changing the determination result in Step 920 to affirmative. In this case, since the EGR cut flag XCEGRK has been set to “1” just before, the determination result in Step 930 is negative and the ECU 50 shifts the processing to Step 1100.

In Step 1100, the ECU 50 determines whether or not the accelerator operating speed ΔTAACC is smaller than a predetermined slow acceleration determination value K2 (a positive value: K2<K1). This slow acceleration determination value K2 is a threshold, different from the above rapid acceleration determination value K1, to determine that a request for slow acceleration operation or others is being made to the engine 1. If NO in Step 1100, it is determined that the rapid acceleration operation request to the engine 1 is slightly weakened than just before but the rapid acceleration operation request is still continued, the ECU 50 shifts the processing to Step 1020 and executes the processings in Steps 1020 and 990 as in the above control. Specifically, the ECU 50 continues to issue the rapid-acceleration forcibly closing command and the fully closing command to the EGR valve 18.

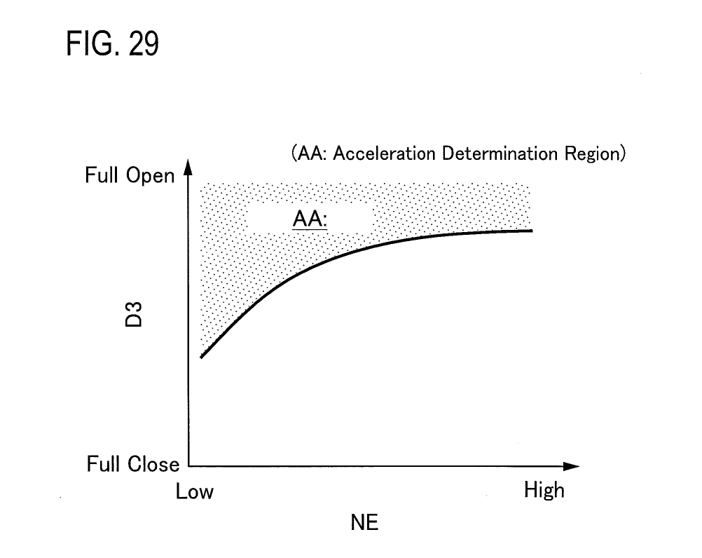

In YES in Step 1100, on the other hand, determining that the slow acceleration operation to the engine 1 is removed, the ECU 50 obtains in Step 1110 an acceleration determination value D3 according to the engine rotation speed NE. The ECU 50 can obtain this acceleration determination value D3 by referring to an acceleration determination value map as shown in FIG. 29, for example. This map is set such that, as the engine rotation speed NE is higher, the acceleration determination value D3 increases in a curve. This acceleration determination value D3 is a threshold to determine that the acceleration operation request to the engine 1 is removed and another operation (including slow acceleration operation, steady operation, or deceleration operation) other than acceleration is requested. This acceleration determination value D3 corresponds to one example of the second determination value during acceleration operation of the invention.

In Step 1120, subsequently, the ECU 50 takes in an accelerator opening degree ACC. In Step 1130, the ECU 50 then determines whether or not the accelerator opening degree ACC is smaller than the acceleration determination value D3. If NO in Step 1130, determining that the acceleration operation request to the engine 1 is slightly weakened than just before but the slow acceleration operation request is still continued, the ECU 50 shifts the processing to Step 1020 and executes the processings in Steps 1020 and 990 as in the above control, and returns the processing to Step 900.

If YES in Step 1130, on the other hand, determining that rapid acceleration operation request by the driver is removed and the rapid acceleration operation is changed to another operation (including steady operation or deceleration operation), the ECU 50 sets the EGR cut flag XCEGRK to “0” in Step 1140.

In Step 1150, successively, the ECU 50 takes in an actual opening degree Regr of the EGR valve 18. In Step 1160, the ECU 50 then sets the actual opening degree Regr as a target opening degree Tegr in Step 1160. In Step 990, further, the ECU 50 controls the EGR valve 18 based on the target opening degree Tegr.

If YES in Step 930, on the other hand, the ECU 50 determines in Step 940 whether or not the accelerator operating speed ΔTAACC is larger than a predetermined first deceleration determination value C1 (a negative value). This first deceleration determination value C1 is a threshold to determine that the deceleration operation request is being made to the engine 1, and this value C1 corresponds to one example of the first determination value during deceleration operation in the invention. If NO in Step 940, determining that the engine 1 is being requested for deceleration operation, the ECU 50 shifts the processing to Step 1200. If YES in Step 940, the ECU 50 shifts the processing to Step 950.

In Step 1200, the ECU 50 issues a rapid-deceleration forcibly closing command to the EGR valve 18. Specifically, the ECU 50 commands the EGR valve 18 to forcibly close in response to rapid deceleration operation.

In Step 1210, the ECU 50 sets an EGR cut flag XCEGRC during deceleration operation to “1”. The ECU 50 then executes the processings in Steps 1020 and 990 and returns the processing to Step 900.

In Step 950, on the other hand, the ECU 50 determines whether or not the EGR cut flag XCEGRC is “0”. This EGR cut flag XCEGRC is set to “1” when the EGR valve 18 is to be closed to cut EGR or set to “0” in other cases. If NO in Step 950, the ECU 50 shifts the processing to Step 1300. If YES in Step 950, the ECU 50 shifts the processing to Step 960.

In Step 1300, the ECU 50 determines whether not the accelerator operating speed ΔTAACC is larger than a predetermined second deceleration determination value C2 (a negative value: C1<C2). This second deceleration determination value C2 is, different from the first deceleration determination value C1, a threshold to determine that a request for slow deceleration operation is being made to the engine 1. If NO in Step 1300, determining that the rapid deceleration operation request to the engine 1 is slightly weakened than just before but the slow deceleration operation request is still continued, the ECU 50 shifts the processing to Step 1020 and executes the processings in Steps 1020 and 990 as in the above control.

If YES in Step 1300, on the other hand, the ECU 50 takes in the accelerator opening degree ACC in Step 1310. Then, the ECU 50 determines in Step 1320 whether or not the accelerator opening degree ACC is larger than a first acceleration determination value D1. This first acceleration determination value D1 is a threshold to determine that a request for acceleration operation or steady operation is being made to the engine 1 and, this value D1 corresponds to one example of the second determination value of the invention. If NO in Step 1320, determining that the deceleration operation request to the engine 1 is slightly weakened than just before but the deceleration operation request is still continued, the ECU 50 shifts the processing to Step 1020 and executes the processings in Steps 1020 and 990 as in the above control.

If YES in Step 1320, on the other hand, determining that the rapid deceleration operation request by the driver is removed and the rapid deceleration operation is changed to another operation (including steady operation or acceleration operation), the ECU 50 sets the EGR cut flag XCEGRC to “0” in Step 1330 and executes the above processings in Steps 1150, 1160, and 990. Specifically, the ECU 50 releases the fully closing command to the EGR valve 18 and controls the EGR valve 18 based on the target opening degree Tegr (the actual opening degree Regr).

In Step 960, the ECU 50 determines whether or not the EGF ON condition is established, specifically, whether or not a condition to open the EGR valve 18 is established. If NO in Step 960, the ECU 50 shifts the processing to Step 1020 and executes the processings in Steps 1020 and 990.

If YES in Step 960, on the other hand, the ECU 50 shifts the processing to Step 970 and takes in the engine rotation speed NE and engine load KL.

In Step 980, the ECU 50 calculates the target opening degree Tegr of the EGR valve 18 according to the engine rotation speed NE and the engine load KL. The ECU 50 can obtain this target opening degree Tegr by referring to a predetermined target opening degree map (not shown).

In Step 990, the ECU 50 controls the EGR valve 18 based on the target opening degree Tegr and returns the processing to Step 900. In this case, the ECU 50 commands the EGR valve 18 to open or close to the target opening degree Tegr.

According to the above control of the present embodiment, the ECU 50 compares the accelerator operating speed ΔTAACC which is a positive change amount per unit of time of the accelerator opening degree ACC to be detected by the accelerator sensor 27 to the first acceleration determination value K1 Based on this comparison result, when it is determined that the acceleration operation request is being made to the engine 1 is being made, the ECU 50 issues the fully closing command to the EGR valve 18. When it is determined that the acceleration operation request is continued, the ECU 50 continues to issue the fully closing command. When it is further determined that the acceleration operation request is removed and that the accelerator opening degree ACC is smaller than the predetermined acceleration determination value D3, the ECU 50 releases the fully closing command. Furthermore, the ECU 50 sets the range of the accelerator opening degree ACC to release the fully closing command to the EGR valve 18, according to the detected engine rotation speed NE. To be concrete, the ECU 50 sets the acceleration determination value D3 according to the detected engine rotation speed NE. In addition, the ECU 50 compares the accelerator operating speed ΔTAACC which is a negative change amount per unit of time of the accelerator opening degree ACC to be detected by the accelerator sensor 27 to the first deceleration determination value C1. Based on the comparison result, when it is determined that the deceleration operation request is being made to the engine 1, the ECU 50 issues the fully closing command to the EGR valve 18. When it is determined that the deceleration operation request is continued, the ECU 50 continues to issue the fully closing command. Further, when it is determined that the deceleration operation request is removed and that the accelerator opening degree ACC is larger than the predetermined first acceleration determination value D1, the ECU 50 releases the fully closing command.

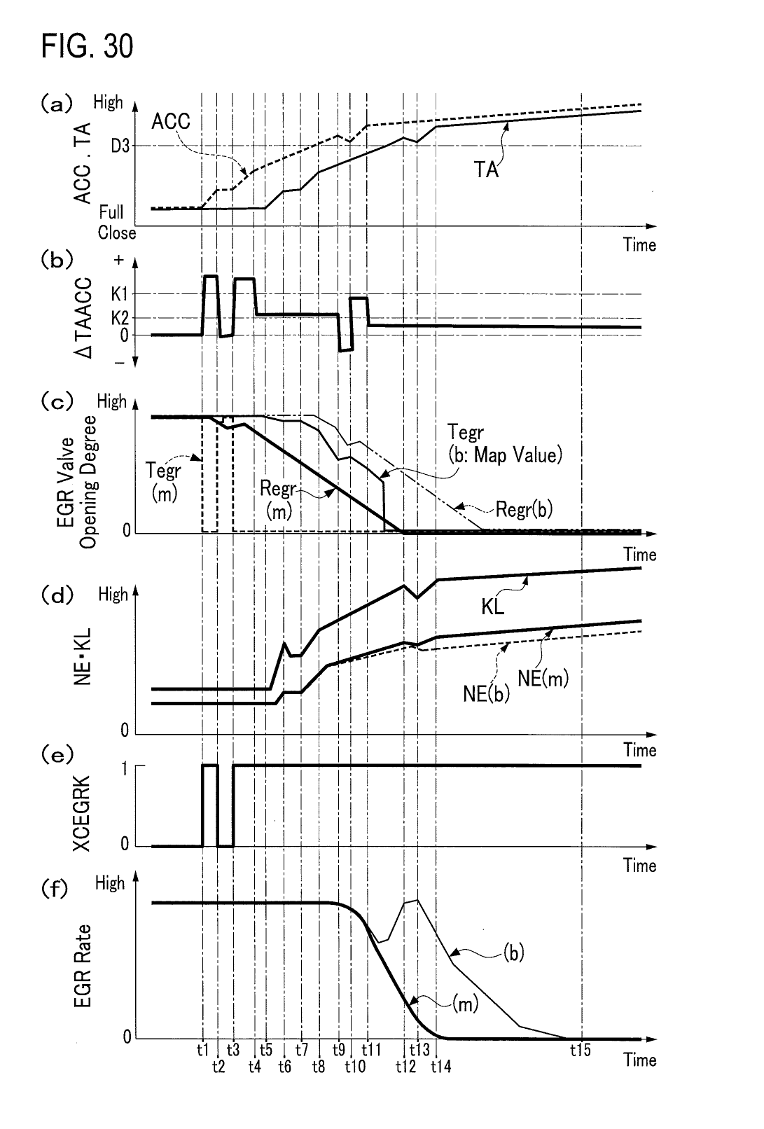

Herein, FIG. 30 is a time chart showing one example of behaviors of various parameters related to the above control, including (a) accelerator opening degree ACC and throttle opening degree TA, (b) accelerator operating speed ΔTAACC, (c) EGR valve opening degree, (d) engine rotation speed NE and engine load KL, (e) EGR cut flag XCEGRK, and (f) EGR rate. In this time chart, as indicated by a thick solid line in FIG. 30(a), the accelerator opening degree ACC relatively rapidly increases while changing between time t1 and t11 and relatively slowly increases between time t11 and t15. As indicated by a solid line in FIG. 30(a), the throttle opening degree TA increases later than the motion of the accelerator opening degree ACC and with almost similar behavior to the accelerator opening degree ACC.

Specifically, when the accelerator opening degree ACC starts to increase from a certain opening degree at time t1 as shown in FIG. 30(a) and the accelerator operating speed ΔTAACC sharply rises to a larger positive value than the rapid acceleration determination value K1 as shown in FIG. 30(b), the EGR cut flag XCEGRK is changed to “1” as shown in FIG. 30(e), the target opening degree Tegr(m) of the EGR valve 18 instantly becomes “0” as indicated by a thick broken line in FIG. 30(c), and the actual opening degree Regr(m) of the EGR valve 18 starts to decrease as indicated by a thick solid line in FIG. 30(c).

Thereafter, when the accelerator opening degree ACC stops increasing at time t2 as shown in FIG. 30(a), the accelerator operating speed ΔTAACC returns to “0” as shown in FIG. 30(b), the EGR cut flag XCEGRK returns to “0” as shown in FIG. 30(e), the target opening degree Tegr(m) becomes coincident with the actual opening degree Regr(m) once, and the actual opening degree Regr(m) of the EGR valve 18 decreases as shown in FIG. 30(c).

Subsequently, when the accelerator opening degree ACC starts to increase again at time t3 as shown in FIG. 30(a) and the accelerator operating speed ΔTAACC sharply rises to a larger positive value than the rapid acceleration determination value K1 again as shown in FIG. 30(b), the EGR cut flag XCEGRK is changed to “1” again as shown in FIG. 30(e), and the target opening degree Tegr(m) instantly becomes “0” as shown in FIG. 30(c). Herein, as shown in FIG. 30(c), between the time t2 to t3, the target opening degree Tegr(m) becomes coincident with the actual opening degree Regr(m) once and then slightly increases, and hence the actual opening degree Regr(m) also increases.

Thereafter, the accelerator opening degree ACC slowly increases from time t4 to t9 as shown in FIG. 30(a), and the accelerator operating speed ΔTAACC decreases once as shown in FIG. 30(b). However, the accelerator operating speed ΔTAACC is smaller than the rapid acceleration determination value K1 but larger than slow acceleration determination value K2, so that the EGR cut flag XCEGRK does not return to “0” as shown in FIG. 30(e), the target opening degree Tegr(m) remains at “0” as shown in FIG. 30(c), and the actual opening degree Regr(m) continues to decrease as shown in FIG. 30(c).

When the accelerator opening degree ACC decreases once and increases again from time t9 through t11 as shown in FIG. 30(a), the accelerator operating speed ΔTAACC decreases to a negative value once and then returns to a value smaller than the rapid acceleration determination value K1 but larger than the slow acceleration determination value K2 as shown in FIG. 30(b). However, since the accelerator opening degree ACC is larger than the acceleration determination value D3 as shown in FIG. 30(a), the EGR cut flag XCEGRK does not return to “0” as shown in FIG. 30(e), the target opening degree Tegr(m) remains at “0” as shown in FIG. 30(c), and the actual opening degree Regr(m) continues to decrease and comes to full close at time t12 as shown in FIG. 30(c). Accordingly, as indicated by a thick solid line in FIG. 30(f), the EGR rate starts to gradually decrease from time t9 and becomes “0” around the time past time t14.

On the other hand, in the previous example provided by the present applicant, even when the accelerator operating speed ΔTAACC increases and decreases from time t1 to t5 as shown in FIG. 30(b), the target opening degree Tegr (b: map value) of the EGR valve 18 is unchanged as indicated by a solid line in FIG. 30(c). Thereafter, from time t5 through t12, the target opening degree Tegr (b: map value) changes with variations in engine rotation speed NE(b) and engine load KL, so that the actual opening degree Regr(b) of the EGR valve 18 decreases after time t7. Furthermore, from time t11 through t15, the EGR rate(b) increases once and decreases with a delay as indicated by a solid line in FIG. 30(f).

According to the exhaust gas recirculation apparatus for an engine in the present embodiment explained above, it can provide the following operations and advantages during acceleration operation in addition to the operations and advantages during deceleration operation in the first embodiment. Specifically, the ECU 50 compares the accelerator operating speed ΔTAACC which is a positive change amount per unit of time of the accelerator opening degree ACC to the predetermined rapid acceleration determination value K1. Based on the comparison result, when it is determined that the acceleration operation request is being made to the engine 1 by a driver, the ECU 50 issues the fully closing command to the EGR valve 18. When it is determined that the acceleration operation request is continued, the ECU 50 continues to issue the fully closing command. When it is determined based on the above comparison result that the acceleration operation request is removed and that the accelerator opening degree ACC is smaller than the predetermined acceleration determination value D3, the ECU 50 releases the fully closing command issued until then. The actual opening degree Regr at that time is assumed as the target opening degree Tegr, and the EGR valve 18 is controlled based on the target opening degree Tegr. Thus, the acceleration operation request to command the EGR valve 18 to fully close is determined based on determining the continuation of the request and determining the removal of the request. Thus, the acceleration operation request can be determined with high response. Accordingly, the fully closing command to the EGR valve 18 is made more rapidly. Furthermore, the fully closing command is released more rapidly in response to the determination on removal of the acceleration operation request. This makes it possible to quickly fully close the EGR valve 18 to cut EGR when the engine 1 is requested for acceleration operation, thereby preventing a deterioration in acceleration property of the engine 1, and rapidly interrupt a fully closing operation of the EGR valve 18 when the acceleration operation request is returned to another operation request.

In the present embodiment, the acceleration operation request can be rapidly determined by simply comparing the accelerator operating speed ΔTAACC to the predetermined rapid acceleration determination value K1. This simple comparison can be made because the acceleration operation request is determined and then the continuation of the acceleration operation request and the removal of the acceleration operation request are both determined. This is because, to determine the continuation of the request and the removal of the request, the accelerator operating speed ΔTAACC is further compared to the predetermined slow acceleration determination value K2 and the accelerator opening degree ACC is further compared to the acceleration determination value D3 to monitor a change in request of acceleration operation.

In general, the output request amount by a driver during acceleration operation tends to become smaller as the engine rotation speed NE becomes higher. In the present embodiment, to determine the removal of the acceleration operation request, the acceleration determination value D3 to be compared to the accelerator opening degree ACC is set by the ECU 50 according to the engine rotation speed NE. Accordingly, the removal of the acceleration operation request is determined more appropriately according to the engine rotation speed NE. Even when the acceleration operation request is determined once and the EGR valve 18 is fully closed, therefore, it is possible to accurately the removal of acceleration operation request and promptly release full closing of the EGR valve 18.

### Eleventh Embodiment

An eleventh embodiment of a supercharger-equipped engine embodying an exhaust gas recirculation apparatus for an engine according to the present invention will now be given referring to the accompanying drawings.

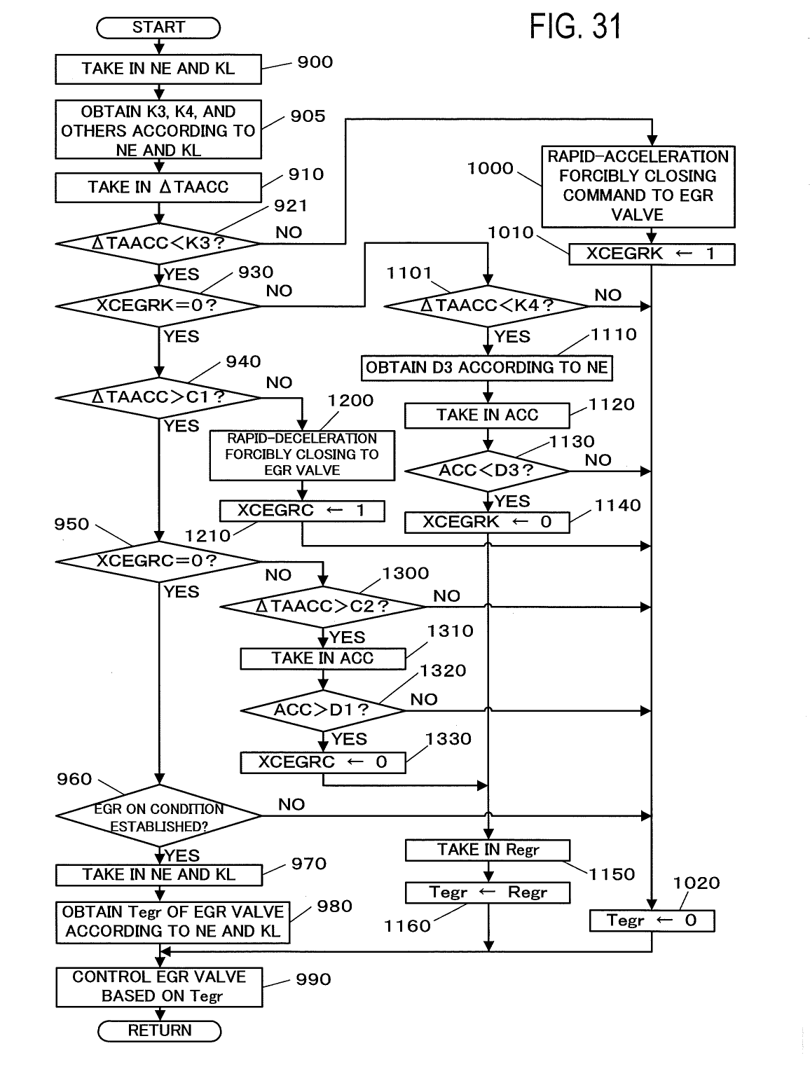

The eleventh embodiment differs from the tenth embodiment in the processing details of EGR control. FIG. 31 is a flowchart showing one example of the processing details of the EGR control of the present embodiment. The flowchart of FIG. 31 differs from the flowchart of FIG. 28 in that the processing in Step 905 is added to the flowchart of FIG. 28 and the processings in Steps 921 and 1101 are provided instead of Steps 920 and 1100 of the flowchart of FIG. 28.

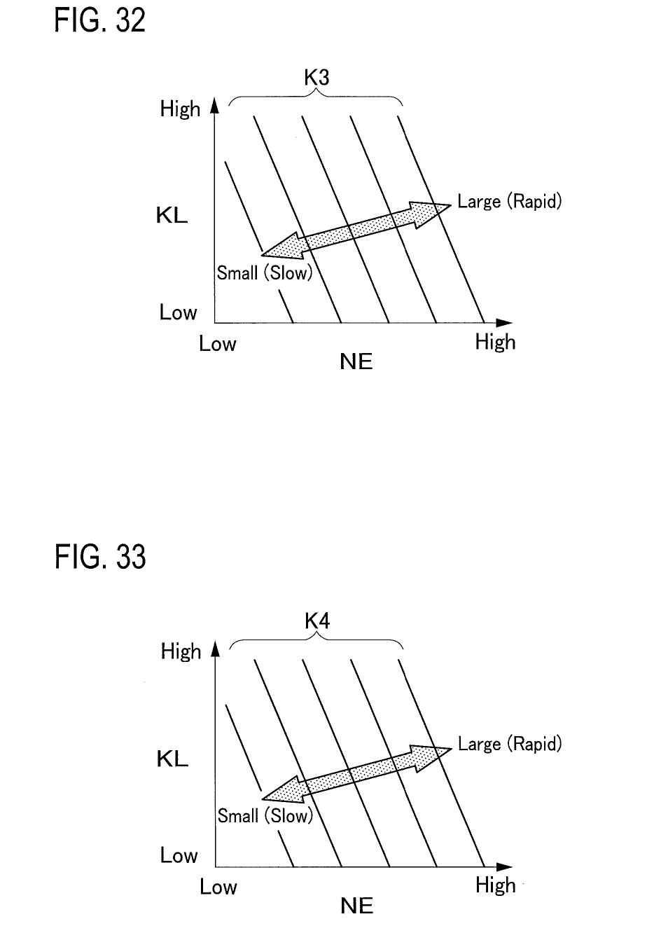

In this routine, specifically, in Step 905 following Step 900, the ECU 50 calculates a rapid acceleration determination value K3 and a slow acceleration determination value K4 according to the engine rotation speed NE and the engine load KL. Herein, the ECU 50 can obtain those rapid acceleration determination value K3 and the slow acceleration determination value K4 according to the engine rotation speed NE and the engine load KL by referring to for example a rapid acceleration determination value map shown in FIG. 32 and a slow acceleration determination value map shown in FIG. 33 respectively. In the maps in FIGS. 32 and 33, the rapid acceleration determination value K3 and the slow acceleration determination value K4 are each set to be smaller as the engine 1 is accelerated from an operating condition having larger influence of acceleration response (a condition in which the engine rotation speed NE is low and the engine load KL is low).

In Step 921 after Step 910, subsequently, the ECU 50 determines whether or not the accelerator operating speed ΔTAACC is smaller than the above obtained rapid acceleration determination value K3 (a positive value). If NO in Step 921, determining that a request for rapid acceleration operation is being made to the engine 1, the ECU 50 shifts the processing to Step 1000. If YES in Step 921, determining that the rapid acceleration operation request to the engine 1 is not made, the ECU 50 shifts the processing to Step 930.

In Step 1101 following Step 930, on the other hand, the ECU 50 determines whether or not the accelerator operating speed ΔTAACC is smaller than the above obtained slow acceleration determination value K4 (a positive value: K4<K3). If NO in Step 1101, it is determined that the rapid acceleration operation request to the engine 1 is slightly weakened than just before but the slow acceleration operation request is still continued, the ECU 50 shifts the processing to Step 1020. In YES in Step 1101, on the other hand, it is determined the rapid acceleration operation request to the engine 1 is removed once, the ECU 50 shifts the processing to Step 1110.

According to the exhaust gas recirculation apparatus for an engine in the eleventh embodiment explained above, it can provide the following operations and advantages in addition to the operations and advantages in the tenth embodiment. Specifically, the ECU 50 sets the rapid acceleration determination value K3 and the slow acceleration determination value K4 for acceleration determination to be compared to a positive change amount of the accelerator operating speed ΔTAACC, according to the engine rotation speed NE and the engine load KL. In the present embodiment, particularly, the rapid acceleration determination value K3 and the slow acceleration determination value K4 are set to be smaller as the engine 1 is accelerated from the operating condition that has a large influence on acceleration response (a condition where the engine rotation speed NE is low and the engine load KL is low). Accordingly, the EGR valve 18 is commanded to fully close with response according to a difference in engine rotation speed NE and engine load KL. During acceleration operation of the engine 1, therefore, it is possible to more promptly reduce the EGR rate of intake air without increasing unintentionally the EGR rate and thus prevent a deterioration in acceleration performance resulting from excessive EGR gas.

### Twelfth Embodiment

A twelfth embodiment of a supercharger-equipped engine embodying an exhaust gas recirculation apparatus for an engine according to the present invention will now be given referring to the accompanying drawings.

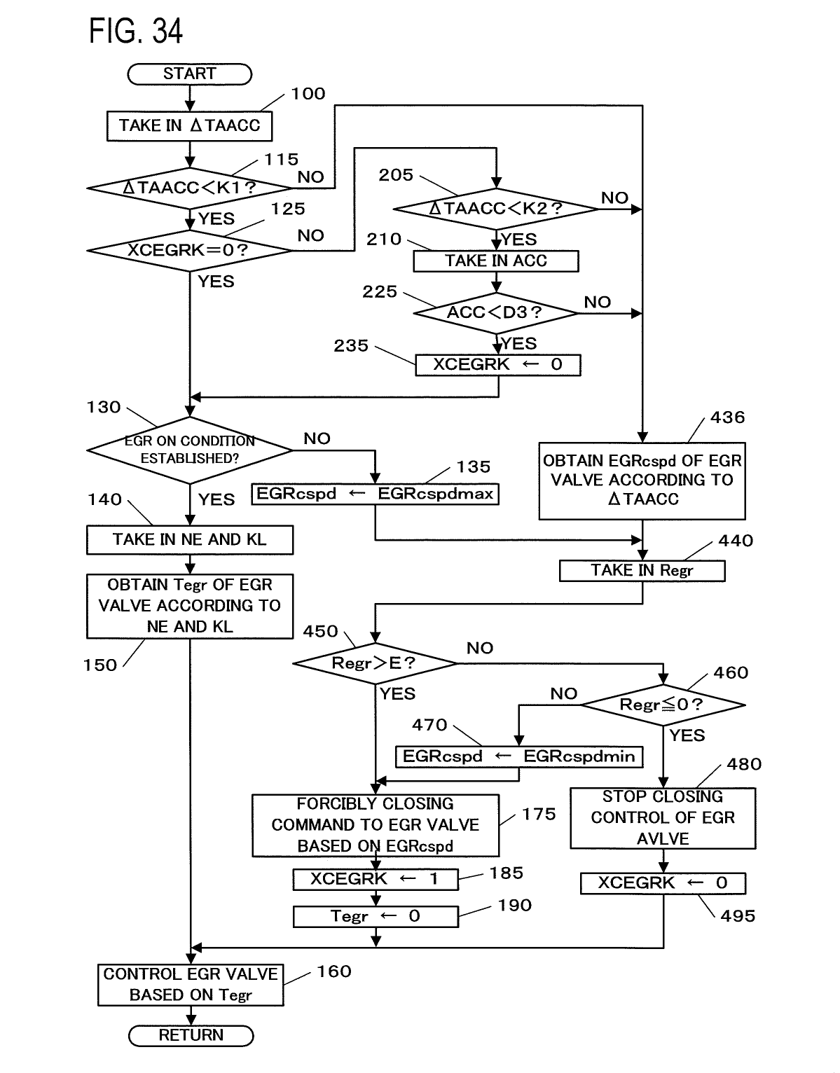

The twelfth embodiment differs from the sixth embodiment in the processing details of EGR control. FIG. 34 is a flowchart showing one example of the processing details of the EGR control of the present embodiment. The flowchart of FIG. 34 differs from the flowchart of FIG. 17 in that the processings in Steps 115, 125, 185, 205, 225, 235, 436, and 495 are provided instead of Steps 110, 120, 180, 200, 220, 230, 435, and 490 of the flowchart of FIG. 17. Accordingly, although the flowchart of FIG. 17 shows determining the deceleration operation request to the engine 1, the flowchart of FIG. 34 shows determining the acceleration operation request to the engine 1.

In this routine, specifically, in Step 115 following Step 100, the ECU 50 determines whether or not the accelerator operating speed ΔTAACC is smaller than a predetermined rapid acceleration determination value K1 (a positive value). If NO in Step 115, determining that a request for rapid acceleration operation is being made to the engine 1, the ECU 50 shifts the processing to Step 436. If YES in Step 115, determining that the rapid acceleration operation request is not made to the engine 1, the ECU 50 shifts the processing to Step 125.

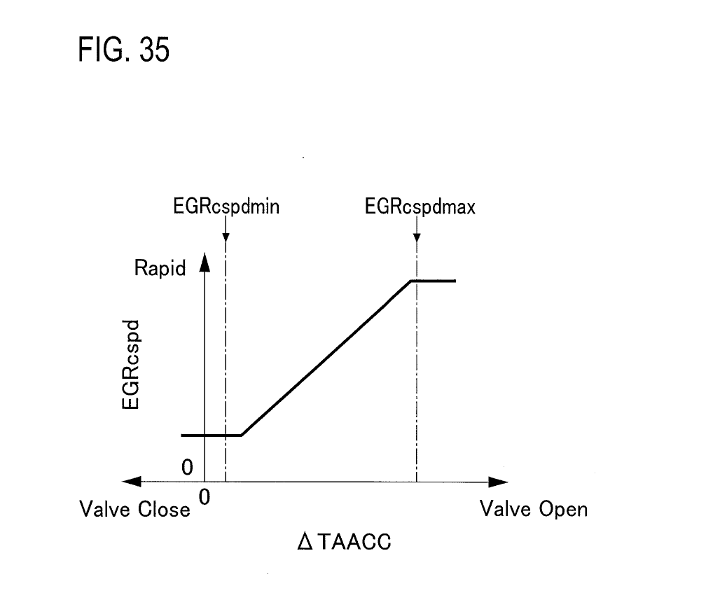

In Step 436, the ECU 50 obtains a valve closing speed EGRcspd of the EGR valve 18 according to the accelerator operating speed ΔTAACC. The ECU 50 can obtain this valve closing speed EGRcspd by referring to a valve closing speed map shown in FIG. 35 for example. The map in FIG. 35 is set such that, as the accelerator operating speed ΔTAACC is larger in positive value, that is, as an absolute value of the accelerator operating speed ΔTAACC is larger, the valve closing speed EGRcspd of the EGR valve 18 is larger between a lower limit and an upper limit.

Subsequently in the processing after Step 440, the ECU 50 sets the EGR cut flag XCEGRK to “1” in Step 185 and sets the EGR cut flag XCEGRK to “0” in Step 495.

On the other hand, in Step 125 following Step 115, the ECU 50 determines whether or not the EGR cut flag XCEGRK is “0”. If NO in Step 125, indicating that EGR is cut, the ECU 50 shifts the processing to Step 205. If YES in Step 125, the ECU 50 shifts the processing to Step 130.

In Step 205, the ECU 50 determines whether or not the accelerator operating speed ΔTAACC is smaller than a predetermined slow acceleration determination value K2 (a positive value: K2<K1). If NO in Step 205, determining that the rapid acceleration operation request to the engine 1 is slightly weakened than just before but the slow acceleration operation request is still continued, the ECU 50 shifts the processing to Step 436 and executes the processings in Step 436 and subsequent steps similarly to the above.

If YES in Step 205, on the other hand, determining that the rapid acceleration operation request to the engine 1 is removed, the ECU 50 takes in the accelerator opening degree ACC in Step 210. In Step 225, successively, the ECU 50 determines whether or not the accelerator opening degree ACC is smaller than the acceleration determination value D3. If NO in Step 225, determining that the acceleration operation request to the engine 1 is weakened than just before but the slow acceleration operation request is still continued, the ECU 50 shifts the processing to Step 436 and executes the processings in Step 436 and subsequent steps similarly to the above.

If YES in Step 225, on the other hand, determining that the rapid acceleration operation request made by a driver is removed (stopped) and the rapid acceleration operation request is changed to another operation (including steady operation or deceleration operation), the ECU 50 sets the EGR cut flag XCEGRK to “0” in Step 235 and shifts the processing to Step 130.

According to the above control in the present embodiment, different from the sixth embodiment, the ECU 50 sets a fully closing command condition for commanding the EGR valve 18 to fully close, which will be issued when the engine 1 is determined as being requested for acceleration operation, according to the accelerator operating speed ΔTAACC. To be concrete, when the ECU 50 issues the fully closing command to the EGR valve 18, the ECU 50 causes the EGR valve 18 to close based on the valve closing speed EGRcspd and sets the valve closing speed EGRcspd according to the accelerator operating speed ΔTAACC. Furthermore, when the actual opening degree Regr of the EGR valve 18 detected in the course of fully closing the EGR valve 18 becomes a predetermined small opening degree E or less, the ECU 50 sets the valve closing speed EGRcspd to a predetermined minimum valve closing speed EGRcspdmin.

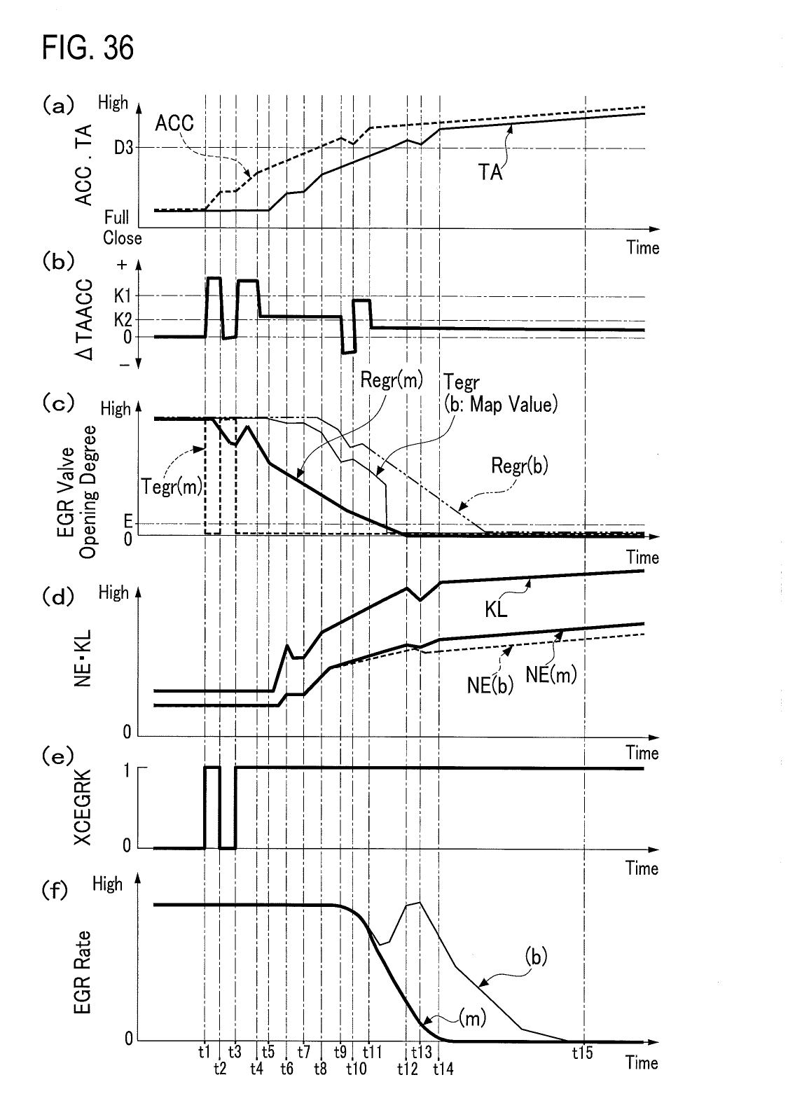

Herein, FIG. 36 is a time chart showing one example of behaviors of various parameters related to the above control, including (a) accelerator opening degree ACC and throttle opening degree TA, (b) accelerator operating speed ΔTAACC, (c) EGR valve opening degree, (d) engine rotation speed NE and engine load KL, (e) EGR cut flag XCEGRK, and (f) EGR rate. In this time chart, the behaviors of various parameters are nearly the same as those in FIG. 30 excepting the “EGR valve opening degree” shown in FIG. 36(c). In this time chart, the characteristics different from the time chart of FIG. 30 are in the behaviors of the actual opening degree Regr(m) between time t1 and t12. Specifically, as indicated by a thick line in FIG. 36(c), between time t1 and t12, the inclination of the actual opening degree Regr(m), that is, the valve closing speed of the EGR valve 18 changes according to the accelerator operating speed ΔTAACC shown in FIG. 36(b).

According to the exhaust gas recirculation apparatus for an engine in the twentieth embodiment explained above, different from the sixth embodiment, it can provide the following operations and advantages when the acceleration operation request to the engine 1 is being made. In general, specifically, the acceleration operation request to the engine 1 tends to be stronger as the accelerator operating speed ΔTAACC is larger in positive value (larger in absolute value). Herein, when it is determined that the acceleration operation is being requested, the ECU 50 sets the valve closing speed EGRcspd according to the accelerator operating speed ΔTAACC. Then, the EGR valve 18 is caused to close toward the fully closed position at the valve closing speed EGRcspd. Accordingly, when the acceleration operation is requested and the ECU 50 issues the fully closing command to the EGR valve 18, the EGR valve 18 is caused to close toward the fully closed position based on the valve closing speed EGRcspd set according to the strength of the operation request. Specifically, the EGR valve 18 is caused to close toward the fully closed position at the slow valve closing speed EGRcspd during slow acceleration, while the EGR valve 18 is caused to close toward the fully closed position at the rapid valve closing speed EGRcspd during rapid acceleration. During acceleration operation of the engine 1, therefore, the EGR valve 18 can be closed toward the fully closed position at an appropriate speed according to the strength of the acceleration operation request, thereby enabling cutting EGR. For instance, furthermore, for the EGR valve 18 mechanistically having a fast valve closing speed, the EGR valve 18 can be closed at a slow valve closing speed for slow deceleration, so that the EGR valve 18 is not excessively closed.

According to the present embodiment, when the actual opening degree Regr of the EGR valve 18 becomes the small opening degree equal to or smaller than the predetermined small opening degree E, the EGR valve 18 is caused to close toward the fully closed position at the minimum valve closing speed EGRcspdmin. This can prevent the valve element 32 from swiftly seating on the valve seat 33 and hence restrain impact and hammering resulting from seating of the valve element 32 on the valve seat 33.

According to the present embodiment, furthermore, if the EGR ON condition is not established, the EGR valve 18 is caused to close toward the fully closed position at the maximum valve closing speed EGRcspdmax. If the EGR ON condition is not established, therefore, EGR can be cut at a maximum speed.

### Thirteenth Embodiment

A thirteenth embodiment of a supercharger-equipped engine embodying an exhaust gas recirculation apparatus for an engine according to the present invention will now be given referring to the accompanying drawings.

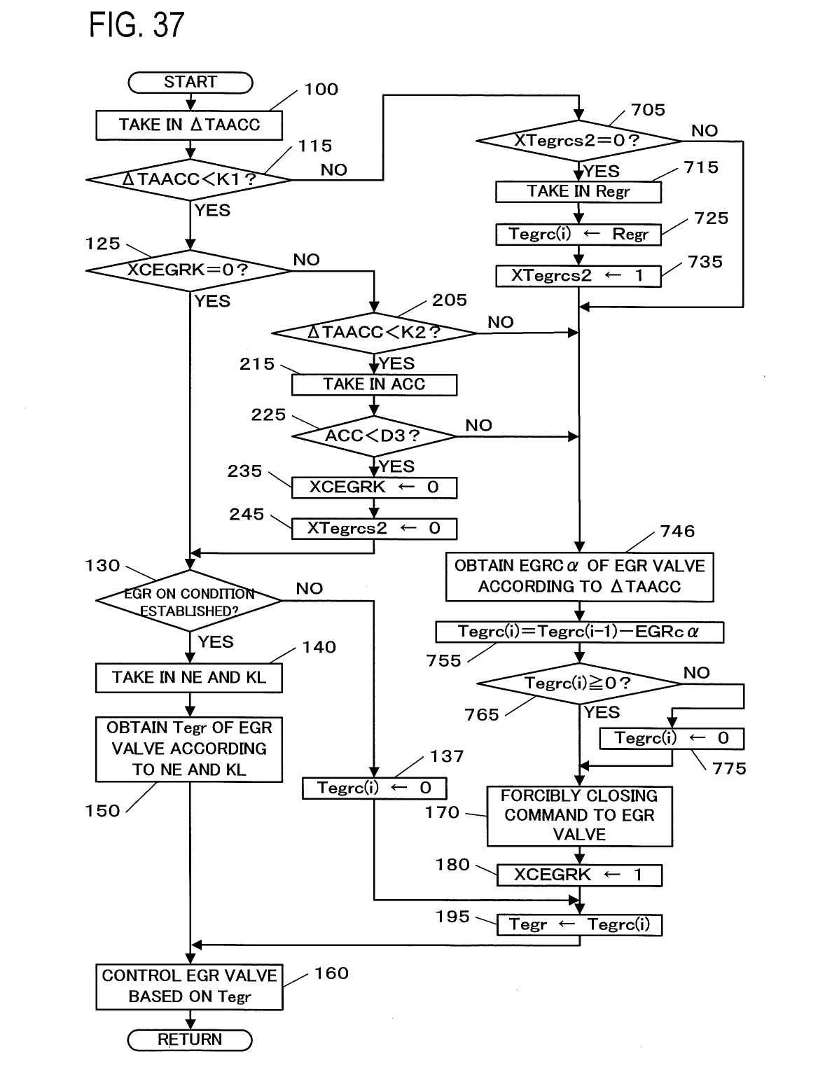

This embodiment differs from the seventh embodiment in the processing details of EGR control. FIG. 37 is a flowchart showing one example of the processing details of EGR control of the present embodiment. The flowchart of FIG. 37 differs from the flowchart of FIG. 20 in Steps 115, 125, 137, 195, 205, 215, 225, 235, 245, 705, 715, 725, 735, 746, 755, 765, and 775. Accordingly, although the flowchart of FIG. 20 shows determining the deceleration operation request to the engine 1, the flowchart of FIG. 37 shows determining the acceleration operation request to the engine 1.

In this routine, specifically, in Step 115 following Step 100, the ECU 50 determines whether or not the accelerator operating speed ΔTAACC is smaller than a predetermined rapid acceleration determination value K1 (a positive value). If NO in Step 115, determining that a request for rapid acceleration operation is being made to the engine 1, the ECU 50 shifts the processing to Step 705. If YES in Step 115, determining that the rapid acceleration operation request to the engine 1 is not made, the ECU 50 shifts the processing to Step 125.

In Step 705 following Step 115, the ECU 50 determines whether or not an initial setting flag Tegrcs2 is “0”. To be concrete, the ECU 50 determines whether or not the target valve-closing opening degree Tegrc(i) of the EGR valve 18 is to be initialized. If YES in Step 705, the ECU 50 shifts the processing to Step 715. If NO in Step 705, the ECU 50 skips to Step 746.

In Step 715, the ECU 50 takes in the actual opening degree Regr of the EGR valve 18. In Step 725, successively, the ECU 50 sets the taken actual opening degree Regr as the target valve-closing opening degree Tegrc(i). In Step 735, the ECU 50 sets the initial setting flag XTegrcs2 to “1”.

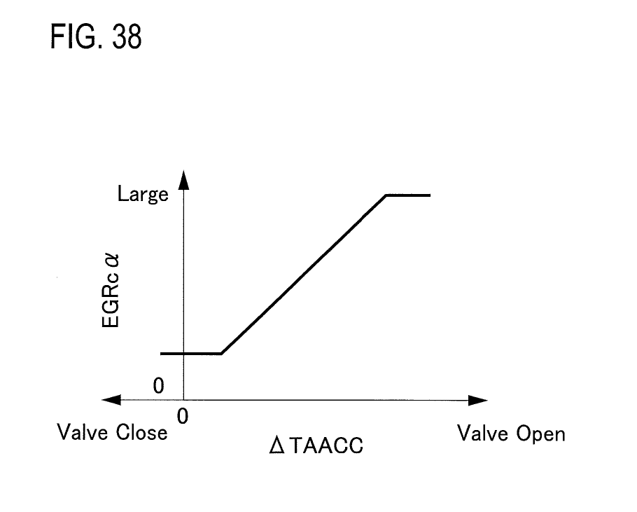

In Step 746 following Step 705 or 735, the ECU 50 obtains a target attenuation value EGRcα of the EGR valve 18 according to the accelerator operating speed ΔTAACC. The ECU 50 can obtain this target attenuation value EGRcα by referring to a target attenuation value map shown in FIG. 38, for example. The map in FIG. 38 is set such that, as the accelerator operating speed ΔTAACC is larger, that is, as an absolute value of the accelerator operating speed ΔTAACC is larger, the target attenuation value EGRcα is larger between a lower limit and an upper limit.

In Step 755, the ECU 50 then obtains the target valve-closing opening degree Tegrc(i) of the EGR valve 18. Specifically, the ECU 50 calculates a current target valve-closing opening degree Tegrc(i) by subtracting the target attenuation value EGRcα from a previously obtained target valve-closing opening degree Tegrc(i−1).

In Step 765, the ECU 50 determines whether or not the currently obtained target valve-closing opening degree Tegrc(i) is equal to or larger than “0”. If YES in Step 765, the ECU 50 shifts the processing to Step 170 and executes the processings in Steps 170, 180, 195, and 160. If NO in Step 765, the ECU 50 shifts the processing to Step 775.

Herein, in Step 195, the ECU 50 sets the currently obtained target valve-closing opening degree Tegrc(i) as the target opening degree Tegr.

In Step 775, the ECU 50 sets the target valve-closing opening degree Tegrc(i) to “0” and shifts the processing to Step 170.

If YES in Step 115, on the other hand, the ECU 50 determines in Step 125 whether or not the EGR cut flag XCEGRK is “0”. If NO in Step 125, indicating that EGR is cut, the ECU 50 shifts the processing to Step 205. If YES in Step 125, the ECU 50 shifts the processing to Step 130.

Even if the determination result in Step 115 is negative (rapid acceleration operation request) once, the accelerator operating speed ΔTAACC may change just after that, thus changing the determination result in Step 115 to affirmative. In this case, since the EGR cut flag XCEGRK has been set to “1” just before, the determination result in Step 125 is negative and the ECU 50 shifts the processing to Step 205.

In Step 205, the ECU 50 determines whether or not the accelerator operating speed ΔTAACC is smaller than a predetermined slow acceleration determination value K2 (a positive value: K1<K2). If NO in Step 205, determining that the rapid acceleration operation request to the engine 1 is slightly weakened than just before but the acceleration operation request is still continued, the ECU 50 shifts the processing to Step 746 and executes the processings in Step 746 and subsequent steps in a similar way to the above.

If YES in Step 205, on the other hand, determining that the rapid acceleration operation request to the engine 1 is removed, the ECU 50 takes in an accelerator opening degree ACC in Step 215. In Step 225, subsequently, the ECU 50 determines whether or not the accelerator opening degree ACC is smaller than the acceleration determination value D3. If NO in Step 225, determining that the acceleration operation request to the engine 1 is weakened than just before but the slow acceleration operation request is still continued, the ECU 50 shifts the processing to Step 746 and executes the processings in Step 746 and subsequent steps similarly to the above.

If YES in Step 225, on the other hand, determining that a driver's request for rapid acceleration operation is removed, the rapid acceleration operation is changed to another operation (including steady operation or deceleration operation), the ECU 50 sets the EGR cut flag XCEGRK to “0” in Step 235.

In Step 245, the ECU 50 sets the initial setting flag XTegrcs2 to “0” and then shifts the processing to Step 130.

If the EGR ON condition is not established in Step 130, the ECU 50 sets the target valve-closing opening degree Tegrc(i) to “0” in Step 137 and shifts the processing to Step 195.

According to the above control of the present embodiment, the ECU 50 sets the fully closing command condition for commanding the EGR valve 18 to fully close, according to the accelerator operating speed ΔTAACC. To be concrete, when the ECU 50 issues the fully closing command to the EGR valve 18, the ECU 50 causes the EGR valve 18 to close toward the fully closed position based on the target valve-closing opening degree Tegrc(i) and also attenuates the target valve-closing opening degree Tegrc(i) according to the transition of the accelerator operating speed ΔTAACC.

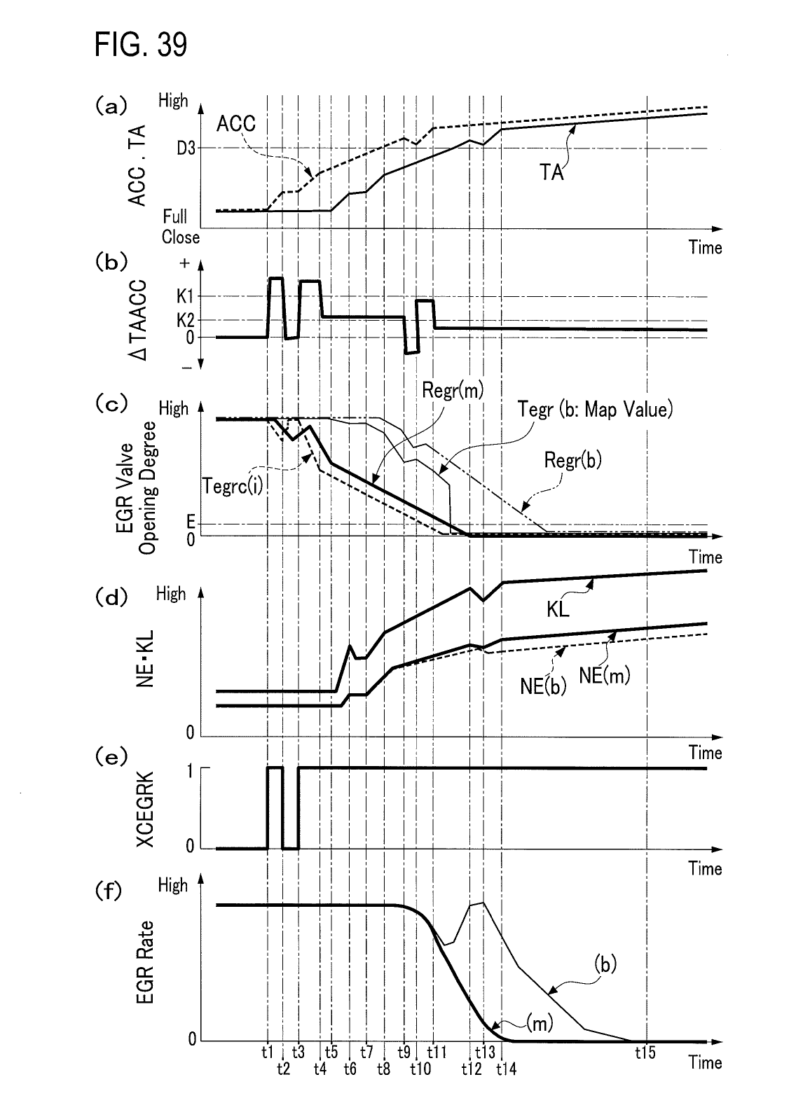

Herein, FIG. 39 is a time chart showing one example of behaviors of various parameters related to the above control, including (a) accelerator opening degree ACC and throttle opening degree TA, (b) accelerator operating speed ΔTAACC, (c) EGR valve opening degree, (d) engine rotation speed NE and engine load KL, (e) EGR cut flag XCEGRK, (f) EGR rate. In this time chart, the behaviors of various parameters are nearly the same as those in FIGS. 30 and 36 excepting the “EGR valve opening degree” shown in FIG. 39(c). In this time chart, the characteristics different from the time chart of FIGS. 30 and 36 are in the behaviors of the target valve-closing opening degree Tegrc(i) and the actual opening degree Regr(m) between time t1 and t12. Specifically, as indicated by a thick broken line in FIG. 39(c), between time t1 and t12, the inclination of the target valve-closing opening degree Tegrc(i), that is, the valve closing speed of the EGR valve 18 changes according to the accelerator operating speed ΔTAACC shown in FIG. 39(b). Furthermore, the actual opening degree Regr(m) changes slightly later than and with a similar inclination to the change in the target valve-closing opening degree Tegrc(i).

According to the exhaust gas recirculation apparatus for an engine in the present embodiment explained above, it can provide the following operations and advantages different from those in the seventh embodiment. Specifically, when it is determined that the acceleration operation is being requested, the ECU 50 obtains the target attenuation value EGRcα according to the accelerator operating speed ΔTAACC, and further obtains the target valve-closing opening degree Tegrc(i) from the target attenuation value EGRcα, and commands the EGR valve 18 to fully close based on the target valve-closing opening degree Tegrc(i). In general, the transition of the accelerator operating speed ΔTAACC is initially large and becomes smaller later with time. Accordingly, when the ECU 50 issues the fully closing command to the EGR valve 18, the target valve-closing opening degree Tegrc(i) is initially largely attenuated and then less and less attenuated with time. When the EGR valve 18 is to be closed toward the fully closed position, therefore, it is caused to close more slowly with time. This makes it possible to close the EGR valve 18 toward the fully closed position at an appropriate speed according to the transition of strength of acceleration operation request and cut EGR.

The present invention is not limited to the above embodiments and may be embodied in other specific forms without departing from the essential characteristics thereof.

In each of the above embodiments, the accelerator opening degree ACC is assumed as the output request amount of the engine 1 made by a driver and the accelerator sensor 27 for detecting the accelerator opening degree ACC is used as an output request amount detecting unit. As an alternative, the throttle opening degree TA of the electronic throttle device 14 to be controlled based on the accelerator opening degree ACC may be assumed as the output request amount of the engine and the throttle sensor 23 for detecting the throttle opening degree TA may be used as the output request amount detecting unit. In a hybrid vehicle, a target torque set based on the accelerator opening degree ACC may be assumed as the output request amount and a controller for setting the target torque may be used as the output detecting unit.

In the fourth embodiment, to slowly and gradually open the EGR valve 18 when the EGR valve 18 is to be opened from the fully closed position toward the target opening degree Tegr, the initial target opening degree Tegrs(i) is increased gradually in steps of a predetermined value α. In the same case, an alternative may be configured to set the opening speed of the EGR valve to a slow speed.

Each of the above embodiments embodies the present invention in the EGR apparatus including the supercharger 7 provided between the intake passage 3 and the exhaust passage 5 of the engine 1 to increase the intake pressure in the intake passage 3, in which the inlet 17b of the EGR passage 17 is connected to the exhaust passage 5 upstream of the turbine 9 of the supercharger 7 and the outlet 17a of the EGR passage 17 is connected to the surge tank 3a downstream of the throttle valve 21. Alternatively, the present invention may be applied to an EGR apparatus including a supercharger, in which an inlet of an EGR passage is connected to an exhaust passage downstream of a turbine of the supercharger and an outlet of the EGR passage is connected to an intake passage upstream of a compressor of the supercharger.

In each of the above embodiments, the EGR apparatus of the invention is embodied as the engine 1 provided with the supercharger 7, but also may be embodied as an engine provided with no supercharger.

While the presently preferred embodiment of the present invention has been shown and described, it is to be understood that this disclosure is for the purpose of illustration and that various changes and modifications may be made without departing from the scope of the invention as set forth in the appended claims.

### INDUSTRIAL APPLICABILITY

The present invention is utilizable to a vehicle engine irrespective of gasoline engine or diesel engine, for example.

### REFERENCE SINGS LIST

1 Engine
3 Intake passage
5 Exhaust passage
14 Electronic throttle device (Intake amount regulation valve)
17 EGR passage (Exhaust gas recirculation passage)
18 EGR valve (Exhaust gas recirculation valve)
21 Throttle valve
23 Throttle sensor (Operating condition detecting unit, Intake amount regulation valve opening degree detecting unit)
27 Accelerator sensor (Operating condition detecting unit, Output request amount detecting unit)
28 Brake sensor (Brake detecting unit)
36 Brake pedal
50 ECU (Control unit, Exhaust recirculation valve opening degree detecting unit)
51 Intake pressure sensor (Operating condition detecting unit)
52 Rotation speed sensor (Operating condition detecting unit, Rotation speed detecting unit)
53 Water temperature sensor (Operating condition detecting unit)
54 Air flow meter (Operating condition detecting unit)
55 Air-fuel ratio sensor (Operating condition detecting unit)
56 Vehicle speed sensor (Operating condition detecting unit)
TA Throttle opening degree (Output request amount)
ACC Accelerator opening degree (Output request amount)
ΔTACC Accelerator operating speed
C1 First deceleration determination value (First determination value)
C2 Second deceleration determination value (First determination value)
D1 First acceleration determination value (Second determination value)
K1 Rapid acceleration determination value (First determination value)
K2 Slow acceleration determination value (First determination value)
K3 Rapid acceleration determination value (First determination value)
K4 Slow acceleration determination value (First determination value)
D3 Acceleration determination value (Second determination value)

1. An exhaust gas recirculation apparatus for an engine, the apparatus including:
an exhaust gas recirculation (EGR) passage to allow part of exhaust gas discharged from a combustion chamber of an engine to an exhaust passage to flow as exhaust recirculation gas in an intake passage to recirculate back to the combustion chamber;
an exhaust gas recirculation valve to regulate a flow of the exhaust recirculation gas in the EGR passage;
an operating condition detecting unit to detect an operating condition of the engine;
a control unit to control the EGR valve based on the operating condition detected by the operating condition detecting unit,
wherein the operating condition detecting unit includes an output request amount detecting unit to detect an amount of an output request of the engine made by a driver, and
the control unit issues a fully closing command to the EGR valve based on a change amount per unit of time of the detected output request amount and releases the fully closing command to the EGR valve based on the change amount per unit of time of the detected output request amount and the output request amount.

2. The exhaust gas recirculation apparatus for an engine according to claim 1, wherein the control unit sets a fully closing command condition to issues the fully closing command to the EGR valve according to the change amount per unit of time of the detected output request amount.

3. The exhaust gas recirculation apparatus for an engine according to claim 2, wherein the fully closing command condition includes a valve closing speed to cause the EGR valve to fully close, and
when the control unit issues the fully closing command to the EGR valve, the control unit causes the EGR valve to close based on the valve closing speed and sets the valve closing speed according to the change amount per unit of time of the detected output request amount.

4. The exhaust gas recirculation apparatus for an engine according to claim 3, wherein the operating condition detecting unit further includes an EGR valve opening-degree detecting unit to detect an opening degree of the EGR valve, and
the control unit sets the valve closing speed to a predetermined minimum value when the opening degree of the EGR valve detected in a course of causing the EGR valve to fully close becomes a predetermined value or less.

5. The exhaust gas recirculation apparatus for an engine according to claim 2, wherein the fully closing command condition includes a delay time to delay start of fully closing the EGR valve, and
when the control unit issues the fully closing command to the EGR valve, the control unit delays the start of fully closing the EGR valve by the delay time and sets the delay time according to the change amount per unit of time of the detected output request amount.

6. The exhaust gas recirculation apparatus for an engine according to claim 2, wherein the fully closing command condition includes a target valve-closing opening degree targeted when the EGR valve is caused to fully close, and
when the control unit issues the fully closing command to the EGR valve, the control unit causes the EGR valve to close based on the target valve-closing opening degree and attenuates the target valve-closing opening degree according to transition of the change amount per unit of time of the detected output request amount.

7. The exhaust gas recirculation apparatus for an engine according to claim 1, wherein the operating condition detecting unit further includes a rotation speed detecting unit to detect a rotation speed of the engine, and
the control unit sets a range of the output request amount to release issues the fully closing command to the EGR valve according to the detected rotation speed.

8. The exhaust gas recirculation apparatus for an engine according to claim 1, wherein the control unit compares a negative change amount per unit of time of the detected output request amount to a predetermined first determination value and, based on a comparison result, the control unit issues the fully closing command to the EGR valve when it is determined that a request for deceleration operation is being made to the engine, the control unit continues to issue the fully closing command when the request for deceleration operation is continued, and the control unit releases the fully closing command when the deceleration operation request is removed and the output request amount is larger than a predetermined second determination value.

9. The exhaust gas recirculation apparatus for an engine according to claim 8, wherein the engine is provided with an intake amount regulation valve to regulate an amount of intake air flowing in the intake passage,
the operating condition detecting unit further includes an intake amount regulation valve opening degree detecting unit to detect an opening degree of the intake amount regulation valve and an EGR valve opening degree detecting unit to detect an opening degree of the EGR valve, and
the control unit sets the first determination value according to a ratio of the detected opening degree of the EGR valve to the detected opening degree of the intake amount regulation valve.

10. The exhaust gas recirculation apparatus for an engine according to claim 8, wherein when a negative change amount per unit of time of the detected output request amount becomes a predetermined value or less or when the detected output request amount becomes zero, the control unit determines that the deceleration operation request is continued and causes the EGR valve to close at a maximum valve closing speed.

11. The exhaust gas recirculation apparatus for an engine according to claim 9, wherein when a negative change amount per unit of time of the detected output request amount becomes a predetermined value or less or when the detected output request amount becomes zero, the control unit determines that the deceleration operation request is continued and causes the EGR valve to close at a maximum valve closing speed.

12. The exhaust gas recirculation apparatus for an engine according to claim 8, wherein
the engine is mountable as a drive source in a vehicle,
the vehicle is provided with a brake pedal to be operated to stop the vehicle and a brake detecting unit to detect operation of the brake pedal,
when the control unit determines that the brake pedal is operated based on a detection result of the brake detecting unit, the control unit determines that the deceleration operation is strongly requested, issues the fully closing command to the EGR valve and causes the EGR valve to close based on the maximum valve closing speed.

13. The exhaust gas recirculation apparatus for an engine according to claim 9, wherein
the engine is mountable as a drive source in a vehicle,
the vehicle is provided with a brake pedal to be operated to stop the vehicle and a brake detecting unit to detect operation of the brake pedal,
when the control unit determines that the brake pedal is operated based on a detection result of the brake detecting unit, the control unit determines that the deceleration operation is strongly requested, issues the fully closing command to the EGR valve and causes the EGR valve to close based on the maximum valve closing speed.

14. The exhaust gas recirculation apparatus for an engine according to claim 8, wherein when the control unit causes the EGR valve to open from a fully closed position or a predetermined small opening degree toward a target opening degree, the control unit causes the EGR valve to slowly and gradually open than the valve is opened from a middle opening degree larger than the small opening degree.

15. The exhaust gas recirculation apparatus for an engine according to claim 8, wherein when the control unit issues the fully closing command to the EGR valve, the control unit delays start of fully closing the EGR valve y a delay time and sets the delay time according to a negative change amount per unit of time of the detected output request amount.

16. The exhaust gas recirculation apparatus for an engine according to claim 9, wherein when the control unit issues the fully closing command to the EGR valve, the control unit delays start of fully closing the EGR valve by a delay time and sets the delay time according to a negative change amount per unit of time of the detected output request amount.

17. The exhaust gas recirculation apparatus for an engine according to claim 1, wherein the control unit compares a positive change amount per unit of time of the detected output request amount to a predetermined first determination value and, based on a result of comparison, the control unit issues the fully closing command to the EGR valve when it is determined that a request for acceleration operation is being made to the engine, the control unit continues to issue the fully closing command when the request for acceleration operation is continued, and the control unit releases the fully closing command when the acceleration operation request is removed and the output request amount is smaller than a predetermined second determination value.

18. The exhaust gas recirculation apparatus for an engine according to claim 17, wherein the operating condition detecting unit further includes a rotation speed detecting unit to detect a rotation speed of the engine and a load detection unit to detect a load of the engine, and
the control unit sets the first determination value according to the detected rotation speed and the load.

19. The exhaust gas recirculation apparatus for an engine according to claim 17, wherein the operating condition detecting unit further includes a rotation speed detecting unit to detect a rotation speed of the engine, and
the control unit sets the second determination value according to the detected rotation speed.

20. The exhaust gas recirculation apparatus for an engine according to claim 18, wherein the control unit sets the second determination value according to the detected rotation speed.
